(19) United States
(12) Patent Application Publication
(10) Pub. No.: US 2015/0016088 A1
(43) Pub. Date: Jan. 15, 2015

(54) LIGHTING DEVICE

(71) Applicant: Sharp Kabushiki Kaisha, Osaka-shi, Osaka (JP)

(72) Inventors: Yukishige Shiraichi, Osaka-shi (JP); Masaki Ohtsuka, Osaka-shi (JP); Akihiko Kuriyama, Osaka-shi (JP); Toshihiro Senoo, Osaka-shi (JP); Ikuo Tsuzuki, Osaka-shi (JP); Kazuya Oyama, Osaka-shi (JP)

(21) Appl. No.: 14/379,865

(22) PCT Filed: Feb. 19, 2013
(86) PCT No.: PCT/JP2013/053992

§ 371 Date: Aug. 20, 2014

(30) Foreign Application Priority Data
Feb. 20, 2012 (JP) 2012-034443
Feb. 20, 2012 (JP) 2012-034451
Feb. 20, 2012 (JP) 2012-034452
Feb. 20, 2012 (JP) 2012-034455
Feb. 20, 2012 (JP) 2012-034457
Mar. 14, 2012 (JP) 2012-057098

(51) Int. Cl. F21K 99/00

(52) U.S. Cl. CPC F21K 9/58; F21K 9/56
USPC 362/84; 362/382

(57) ABSTRACT

A lighting device (100) for lighting by emitting lighting light by light emission of an LED element (6), wherein the area of a spectrum of the lighting light having a wavelength of 600 nm to 700 nm is 30% to 70%, and the area having a wavelength of 400 nm to 500 nm is 20% or less with respect to the area having a wavelength of 400 nm to 800 nm, the spectrum of the lighting light has a maximum value between 600 nm and 700 nm, and the value of the spectrum at 550 nm is 50% or less of the maximum value.

### TECHNICAL FIELD

The present invention relates to a lighting device used for lighting inside a living room.

### BACKGROUND ART

Patent Literature 1 and 2 disclose conventional lighting devices. The lighting device of Patent Literature 1 changes a light color according to a pre-set variation pattern and lights water in a bathtub. A feeling of relaxation during bathing can thereby be increased.

The lighting device of Patent Literature 2 changes the illuminance in accordance with the quantity of sunlight. Biological rhythms can thereby be adjusted, and wakefulness can easily be maintained.

### LIST OF CITATIONS

### Patent Literature

Patent Literature 1: Japanese Laid-open Patent Publication No. 2008-53183
Patent Literature 2: Japanese Laid-open Patent Publication No. 09-306672

### SUMMARY OF INVENTION

### Technical Problem

There has been a desire in recent years to investigate the effects of lighting on a human body that is present in a lighting environment. In particular, for many people carrying various kinds of stress, an important concern is what sort of lighting environment can be provided to overcome stress and improve feelings of relaxation or comfort. In contrast, the abovementioned conventional lighting devices do not contribute to creating an environment capable of overcoming stress, and have drawbacks in not being capable of overcoming the stress of a user. The abovementioned conventional lighting devices also have drawbacks in that the degree of fatigue of a user who has performed a predetermined work cannot be reduced, and the user has a high degree of fatigue.

The abovementioned conventional lighting devices also do not contribute to creating an environment for good-quality sleep, and a user cannot obtain good-quality sleep under the lighting of any of the conventional lighting devices.

The abovementioned conventional lighting devices also do not contribute to creating an environment capable of reducing tiredness in a person, and have drawbacks in that the capacity for work by a user cannot be increased under the lighting of any of the conventional lighting devices, and the working capacity of the user is low.

The present invention was developed in view of the foregoing drawbacks, and an object of the present invention is to provide a lighting device whereby stress in a person can be alleviated, comfort can be improved, and degree of fatigue during work can be reduced. An object of the present invention is also to provide a lighting device capable of improving sleep efficiency and working capacity.

### Solution to Problem

The present invention for achieving the abovementioned objects is a lighting device for lighting by emitting lighting light by light emission of an LED element, and is characterized in that: the area of a spectrum of the lighting light having a wavelength of 600 nm to 700 nm is 30% to 70%, and the area having a wavelength of 400 nm to 500 nm is 20% or less with respect to the area having a wavelength of 400 nm to 800 nm; the spectrum of the lighting light has a maximum value between 600 nm and 700 nm; and the value of the spectrum at 550 nm is 50% or less of the maximum value.

According to this configuration, lighting is performed by emission of lighting light having the abovementioned spectrum by light emission of an LED element. The comfort or feeling of relaxation of a user during business, housework, study, or other work is thereby improved, and working capacity is improved.

The invention for achieving the abovementioned objects is also a lighting device for lighting by emitting lighting light by light emission of an LED element, and is characterized in that: the area of a spectrum of the lighting light having a wavelength of 600 nm to 700 nm is 30% to 70%, and the area having a wavelength of 400 nm to 500 nm is 20% or less with respect to the area having a wavelength of 400 nm to 800 nm; the spectrum of the lighting light has a maximum value between 600 nm and 700 nm; and the maximum value of the spectrum from 500 nm to 600 nm is 70% or less of the maximum value.

According to this configuration, lighting is performed by emission of lighting light having the abovementioned spectrum by light emission of an LED element. The comfort or feeling of relaxation of a user during recesses or small social gatherings is thereby improved, and tiredness of the user during business, housework, or other work is reduced.

The lighting device of the present invention configured as described above is characterized in that the area of the spectrum of the lighting light from 500 nm to 600 nm is 15% to 45% of the area of the spectrum of the lighting light from 400 nm to 800 nm.

The lighting device of the present invention configured as described above is characterized in that a plurality of lighting lights having different spectra can be selected and emitted.

The lighting device of the present invention for overcoming the abovementioned drawbacks is characterized in that at least one LED element emits lighting light having a lighting color within a region surrounded by an isotemperature line and an isanomal for a blackbody locus which pass through a point A1 (0.555, 0.394), and an isotemperature line and an isanomal for the blackbody locus which pass through a point B1 (0.419, 0.343) on an xy chromaticity diagram established by the International Commission on Illumination.

According to this configuration, lighting light having a yellowish-red lighting color or an orange-pink lighting color is emitted by light emission of the LED element. Parasympathetic nerves of a user in a living room can thereby be made dominant without inhibiting melatonin secretion. Consequently, sleep onset latency at bedtime is shortened, sleep efficiency is improved, relaxation and recovery are brought about during recesses and the like, and accumulated tiredness is alleviated.

The lighting device of the present invention configured as described above is characterized in that the lighting color is a color belonging to an isochromatic range represented by a 5-step MacAdam ellipse centered at a point (0.499, 0.382) on the xy chromaticity diagram.

The lighting device of the present invention configured as described above is characterized in that the lighting color is a color belonging to an isochromatic range represented by a 1-step MacAdam ellipse centered at a point (0.499, 0.382) on the xy chromaticity diagram.

The lighting device of the present invention for overcoming the abovementioned drawbacks is characterized in that at least one LED element emits lighting light having a lighting color within a region surrounded by an isotemperature line and an isanomal for the blackbody locus which pass through a point A2 (0.419, 0.343), an isanomal for the blackbody locus which pass through a point B2 (0.418, 0.390), an isotemperature line passing through a point C2 (0.397, 0.370), and a straight line connecting point B2 and point C2 on the xy chromaticity diagram established by the International Commission on Illumination.

According to this configuration, lighting light having a lighting color between yellowish red and yellowish white, or between orange-pink and pale pink is emitted by light emission of the LED element. Arousal of the sympathetic nervous system due to business, housework, or other work load is thereby suppressed, tiredness during work is reduced, and working capacity is improved.

The lighting device of the present invention configured as described above is characterized in that the lighting color is a color belonging to an isochromatic range represented by a 5-step MacAdam ellipse centered at a point (0.416, 0.377) on the xy chromaticity diagram.

The lighting device of the present invention configured as described above is characterized in that the lighting color is a color belonging to an isochromatic range represented by a 1-step MacAdam ellipse centered at a point (0.416, 0.377) on the xy chromaticity diagram.

The lighting device of the present invention for overcoming the abovementioned drawbacks is characterized in that at least one LED element emits lighting light having a lighting color within a region surrounded by an isotemperature line and an isanomal for the blackbody locus which pass through a point A3 (0.350, 0.311), an isotemperature line passing through a point B3 (0.397, 0.370), an isanomal for the blackbody locus passing through a point C3 (0.388, 0.378), and a straight line connecting point B3 and point C3 on the xy chromaticity diagram established by the International Commission on Illumination.

According to this configuration, lighting light having a yellowish white lighting color or a pale pink lighting color is emitted by light emission of the LED element. Excitation of the sympathetic nervous system due to stress can thereby be suppressed. Consequently, when a person feeling stressed spends time in a room lit by this lighting color of the lighting device, stress is alleviated.

The lighting device of the present invention configured as described above is characterized in that the lighting color is a color belonging to an isochromatic range represented by a 5-step MacAdam ellipse centered at a point (0.377, 0.362) on the xy chromaticity diagram.

The lighting device of the present invention configured as described above is characterized in that the lighting color is a color belonging to an isochromatic range represented by a 1-step MacAdam ellipse centered at a point (0.377, 0.362) on the xy chromaticity diagram.

The present invention for achieving the abovementioned objects is characterized in comprising: a first lighting mode for emitting, by light emission of an LED element, lighting light having a lighting color within a first region surrounded by an isotemperature line and an isanomal for a blackbody locus which pass through a point A4 (0.555, 0.394), and an isotemperature line and an isanomal for the blackbody locus which pass through a point B4 (0.419, 0.343) on an xy chromaticity diagram established by the International Commission on Illumination; and a second lighting mode for emitting lighting light having a lighting color within a second region surrounded by the isotemperature line and the isanomal for the blackbody locus which pass through the point B4, an isanomal for the blackbody locus passing through a point C4 (0.418, 0.390), an isotemperature line passing through a point D4 (0.397, 0.370), and a straight line connecting point C4 and point D4; an operating unit being provided which is capable of selecting the first lighting mode and the second lighting mode.

According to this configuration, lighting by the first lighting mode or the second lighting mode is performed by light emission of the LED element. Lighting light having a yellowish-red lighting color or an orange-pink lighting color is emitted by the first lighting mode. Parasympathetic nerves of a user in a living room can thereby be made dominant without inhibiting melatonin secretion. Consequently, sleep onset latency at bedtime is shortened, sleep efficiency is improved, relaxation and recovery are brought about during recesses and the like, and accumulated tiredness is alleviated.

Lighting light having a lighting color between yellowish red and yellowish white, or between orange-pink and pale pink is emitted by the second lighting mode. Arousal of the sympathetic nervous system due to business, housework, or other work load is thereby suppressed, tiredness during work is reduced, and working capacity is improved.

The lighting device of the present invention configured as described above is characterized in that the lighting color of the first lighting mode is a color belonging to an isochromatic range represented by a 5-step MacAdam ellipse centered at a point (0.499, 0.382) on the xy chromaticity diagram.

The lighting device of the present invention configured as described above is characterized in that the lighting color of the first lighting mode is a color belonging to an isochromatic range represented by a 1-step MacAdam ellipse centered at a point (0.499, 0.382) on the xy chromaticity diagram.

The lighting device of the present invention configured as described above is characterized in that the lighting color of the second lighting mode is a color belonging to an isochromatic range represented by a 5-step MacAdam ellipse centered at a point (0.416, 0.377) on the xy chromaticity diagram.

The lighting device of the present invention configured as described above is characterized in that the lighting color of the second lighting mode is a color belonging to an isochromatic range represented by a 1-step Mac Adam ellipse centered at a point (0.416, 0.377) on the xy chromaticity diagram.

The lighting device of the present invention configured as described above is characterized in comprising a cool-color lighting mode for emitting daylight, neutral white, or white lighting light. According to this configuration, the cool-color lighting mode is performed by a predetermined operation, and daylight, neutral white, or white lighting light is emitted.

The lighting device of the present invention configured as described above is characterized in comprising a warm-color lighting mode for emitting incandescent-bulb-color or warm white lighting light. According to this configuration, the warm-color lighting mode is performed by a predetermined operation, and incandescent-bulb-color or warm white lighting light is emitted.

The lighting device of the present invention configured as described above is characterized in that the lighting color is made variable to a color between the cool-color lighting mode and the warm-color lighting mode, and the operating unit has a first operating switch for selecting the first lighting mode, a second operating switch for selecting the second lighting mode, and a variable switch for making the lighting color variable in stages to a color between the cool-color lighting mode and the warm-color lighting mode.

According to this configuration, lighting according to the first lighting mode is performed when the first operating switch of the operating unit is operated, and lighting according to the second lighting mode is performed when the second lighting operating switch is operated. When the variable switch is operated, lighting is performed so that the lighting color is made variable in stages from the lighting color of the cool-color lighting mode to the lighting color of the warm-color lighting mode.

The lighting device of the present invention configured as described above is characterized in that the lighting color is made variable to a color between the cool-color lighting mode and the warm-color lighting mode, the lighting color is made variable within a first region and a second region, and the operating unit has a first variable switch for making the lighting color variable to a color within the first region and the second region, and a second variable switch for making the lighting color variable to a color between the cool-color lighting mode and the warm-color lighting mode.

According to this configuration, the first region and the second region are continuous on the xy chromaticity diagram. By operation of the first variable switch, the lighting color is made variable in stages from the lighting color of the first region to the lighting color of the second region, and the first lighting mode and the second lighting mode are performed. When the second variable switch is operated, lighting is performed so that the lighting color is made variable in stages from the lighting color of the cool-color lighting mode to the lighting color of the warm-color lighting mode.

The lighting device of the present invention configured as described above is characterized in comprising a warm-color lighting mode for emitting incandescent-bulb-color or warm white lighting light.

The lighting device of the present invention configured as described above is characterized in comprising only a first lighting mode and a second lighting mode having different lighting colors, the operating unit having a first operating switch for selecting a first lighting mode, and a second operating switch for selecting a second lighting mode. According to this configuration, lighting according to the first lighting mode is performed when the first operating switch of the operating unit is operated, and lighting according to the second lighting mode is performed when the second lighting operating switch is operated.

The lighting device of the present invention configured as described above is characterized in comprising only a first lighting mode and a second lighting mode having different lighting colors, the lighting color being made variable within a first region and a second region, and the operating unit having a variable switch for making the lighting color variable in stages. According to this configuration, the first region and the second region are continuous on the xy chromaticity diagram. By operation of the variable switch, the lighting color is made variable in stages from the lighting color of the first region to the lighting color of the second region, and the first lighting mode and the second lighting mode are performed.

The lighting device of the present invention configured as described above is characterized in having a plurality of the LED element, each LED element emitting a different color of light. According to this configuration, a plurality of LED elements emit different colors of light which are blended, and lighting light having a predetermined spectrum or a lighting color within the aforementioned regions is emitted.

The lighting device of the present invention configured as described above is characterized in comprising the LED element for emitting light having an incandescent-bulb color, the LED element for emitting red light, and the LED element for emitting white light. According to this configuration, incandescent-bulb color, red, and white emitted from a plurality of LED elements are blended, and lighting light having a predetermined spectrum or a lighting color within the aforementioned regions is emitted.

The lighting device of the present invention configured as described above is characterized in that the LED element for emitting light having an incandescent-bulb color is of a color belonging to an isochromatic range represented by a 5-step MacAdam ellipse centered at a point (0.445, 0.408) on the xy chromaticity diagram, and the maximum value of the wavelength of the LED element for emitting red light is 575 nm to 780 nm.

The lighting device of the present invention configured as described above is characterized in that the color of the lighting light is made variable between white and a color within the regions. According to this configuration, the lighting device emits lighting light having a lighting color within the regions, and also emits lighting light obtained by blending the lighting color with a color between white and a color within the regions.

The lighting device of the present invention configured as described above is characterized in comprising a phosphor for converting emitted light of the LED elements to a different wavelength. According to this configuration, the emitted light of the LED elements and the fluorescence by the phosphor are blended, and lighting light having a predetermined spectrum or a lighting color within the aforementioned regions is emitted.

The lighting device of the present invention configured as described above is characterized in comprising the LED elements for emitting blue light, the phosphor for converting blue light to incandescent-bulb-color light, the phosphor for converting blue light to red light, and the phosphor for converting blue light to yellow light.

According to this configuration, the emitted light of the LED elements and the yellow fluorescence by the phosphor are blended and form white light. This white light, the red fluorescence by the phosphor, and the incandescent-bulb-color fluorescence by the phosphor are blended, and lighting light having a predetermined spectrum or a lighting color within the aforementioned regions is emitted.

### Advantageous Effects of the Invention

According to the present invention, light emission of the LED elements provides lighting that emits lighting light in which the area of the spectrum thereof having a wavelength of 600 nm to 700 nm is 30% to 70%, and the area having a wavelength of 400 nm to 500 nm is 20% or less with respect to the area having a wavelength of 400 nm to 800 nm, the spectrum of the lighting light has the maximum value thereof between 600 nm and 700 nm, and the value of the spectrum at a wavelength of 550 nm is 50% or less of the maximum value of the spectrum.

The comfort or feeling of relaxation of a user during business, housework, study, or other work can therefore be improved, and number of trials, correct answer rate, and other aspects of working efficiency can also be improved. Since lighting light is emitted by light emission of the LED elements, lighting can be performed without including ultraviolet rays, which have adverse chemical effects on the human body, or infrared rays, which have adverse thermal effects on the human body.

According to the present invention, light emission of the LED elements provides lighting that emits lighting light in which the area of the spectrum thereof having a wavelength of 600 nm to 700 nm is 30% to 70%, and the area having a wavelength of 400 nm to 500 nm is 20% or less with respect to the area having a wavelength of 400 nm to 800 nm, the spectrum of the lighting light has the maximum value thereof between 600 nm and 700 nm, and the maximum value of the spectrum at a wavelength of 500 nm to 600 nm is 70% or less of the maximum value of the spectrum.

The comfort or feeling of relaxation of a user during recesses or small social gatherings can therefore be improved. Tiredness in a user during work can also be reduced. Moreover, since lighting light is emitted by light emission of the LED elements, lighting can be performed without including ultraviolet rays, which have adverse chemical effects on the human body, or infrared rays, which have adverse thermal effects on the human body.

According to the configuration of the present invention, by light emission of the LED elements, lighting is performed having a lighting color within a region surrounded by the isotemperature line and the isanomal for the blackbody locus which pass through the point A1 (0.555, 0.394), and the isotemperature line and the isanomal for the blackbody locus which pass through the point B1 (0.419, 0.343) on the xy chromaticity diagram.

Therefore, reduced sleep onset latency, improved sleep efficiency, and other characteristics of good-quality sleep can be obtained, and accumulated tiredness can be alleviated. Moreover, since lighting light having a lighting color within the aforementioned region is emitted by light emission of the LED elements, lighting can be performed without including ultraviolet rays, which have adverse chemical effects on the human body, or infrared rays, which have adverse thermal effects on the human body.

According to the configuration of the present invention, by light emission of the LED elements, lighting is performed having a lighting color within a region surrounded by an isotemperature line and an isanomal for the blackbody locus which pass through a point A2 (0.419, 0.343), an isanomal for the blackbody locus passing through a point B2 (0.418, 0.390), an isotemperature line passing through a point C2 (0.397, 0.370), and a straight line connecting point B2 and point C2 on the xy chromaticity diagram.

The capacity for work by a user can therefore be improved. Moreover, since lighting light having a lighting color within the aforementioned region is emitted by light emission of the LED elements, lighting can be performed without including ultraviolet rays, which have adverse chemical effects on the human body, or infrared rays, which have adverse thermal effects on the human body.

According to the configuration of the present invention, by light emission of the LED elements, lighting is performed having a lighting color within a region surrounded by the isotemperature line and the isanomal for the blackbody locus which pass through the point A3 (0.350, 0.311), the isotemperature line passing through the point B3 (0.397, 0.370), the isanomal for the blackbody locus passing through the point C3 (0.388, 0.378), and a straight line connecting point B3 and point C3 on the xy chromaticity diagram.

User stress can therefore be alleviated. Moreover, since lighting light having a lighting color within the aforementioned region is emitted by light emission of the LED elements, lighting can be performed without including ultraviolet rays, which have adverse chemical effects on the human body, or infrared rays, which have adverse thermal effects on the human body.

According to the present invention, by light emission of the LED elements, the first lighting mode is performed for emitting lighting light having a lighting color within a first region surrounded by an isotemperature line and an isanomal for a blackbody locus which pass through a point A4 (0.555, 0.394), and an isotemperature line and an isanomal for the blackbody locus which pass through a point B4 (0.419, 0.343) on an xy chromaticity diagram, and the second lighting mode is performed for emitting lighting light having a lighting color within a second region surrounded by the isotemperature line and the isanomal for the blackbody locus which pass through the point B4, an isanomal for the blackbody locus passing through a point C4 (0.418, 0.390), an isotemperature line passing through a point D4 (0.397, 0.370), and a straight line connecting point C4 and point D4.

Therefore, reduced sleep onset latency, improved sleep efficiency, and other characteristics of good-quality sleep can be obtained, and accumulated tiredness can be alleviated by the first lighting mode. The capacity for work by a user can be improved by the second lighting mode. Moreover, since lighting light having lighting colors in the first region and the second region is emitted by light emission of the LED elements, lighting can be performed without including ultraviolet rays, which have adverse chemical effects on the human body, or infrared rays, which have adverse thermal effects on the human body.

### BRIEF DESCRIPTION OF DRAWINGS

FIG. 1 is a sectional side view showing the lighting device according to a first embodiment of the present invention;

FIG. 2 is an exploded perspective view showing the lighting device according to the first embodiment of the present invention;

FIG. 3 is a perspective view showing the lighting device according to a second embodiment of the present invention;

FIG. 4 is a plan view showing the light source substrate of the lighting device according to the second embodiment of the present invention;

FIG. 5 is a block diagram showing the configuration of the lighting device according to the second embodiment of the present invention;

FIG. 6 is an explanatory view showing the configuration of the LED element light emission mechanism of the lighting device according to the second embodiment of the present invention;

FIG. 7 is an xy chromaticity diagram showing the lighting color of the lighting device according to a fourth embodiment of the present invention;

FIG. 8 is an xy chromaticity diagram showing the lighting color of the lighting device according to a fifth embodiment of the present invention;

FIG. 9 is an xy chromaticity diagram showing the lighting color of the lighting device according to a sixth embodiment of the present invention;

FIG. 10 is an xy chromaticity diagram showing the lighting color of the lighting device according to a seventh embodiment of the present invention;

FIG. 11 is a front view showing the remote controller of the lighting device according to the seventh embodiment of the present invention;

FIG. 12 is a front view showing the remote controller of the lighting device according to the eighth embodiment of the present invention;

FIG. 13 is a front view showing the remote controller of the lighting device according to the ninth embodiment of the present invention;

FIG. 14 is a view showing the spectrum of the lighting light of the lighting device according to Example 1 of the first embodiment of the present invention;

FIG. 15 is a view showing the spectrum of the lighting light of the lighting device according to Example 2 of the first embodiment of the present invention;

FIG. 16 is a view showing the spectrum of the lighting light of the lighting device according to Example 3 of the first embodiment of the present invention;

FIG. 17 is a view showing the spectrum of the lighting light of the lighting device according to Example 4 of the first embodiment of the present invention;

FIG. 18 is a view showing the spectrum of the lighting light of the lighting device according to Example 5 of the third embodiment of the present invention;

FIG. 19 is a view showing the spectrum of the lighting light of the lighting device according to Example 6 of the third embodiment of the present invention;

FIG. 20 is a view showing the spectrum of the lighting light of the lighting device according to Example 7 of the third embodiment of the present invention;

FIG. 21 is a view showing the spectrum of the lighting light of the lighting device according to Example 8 of the third embodiment of the present invention;

FIG. 22 is an xy chromaticity diagram showing the lighting colors of the lighting devices according to the examples and comparative examples of the fourth embodiment of the present invention;

FIG. 23 is an xy chromaticity diagram showing the lighting colors of the lighting devices according to the examples and comparative examples of the fifth embodiment of the present invention;

FIG. 24 is an xy chromaticity diagram showing the lighting colors of the lighting devices according to the examples and comparative examples of the sixth embodiment of the present invention; and

FIG. 25 is an xy chromaticity diagram showing the lighting colors of the lighting devices according to the examples and comparative examples of the seventh through ninth embodiments of the present invention.

### DESCRIPTION OF EMBODIMENTS

Embodiments of the present invention are described below with reference to the accompanying drawings.

### First Embodiment

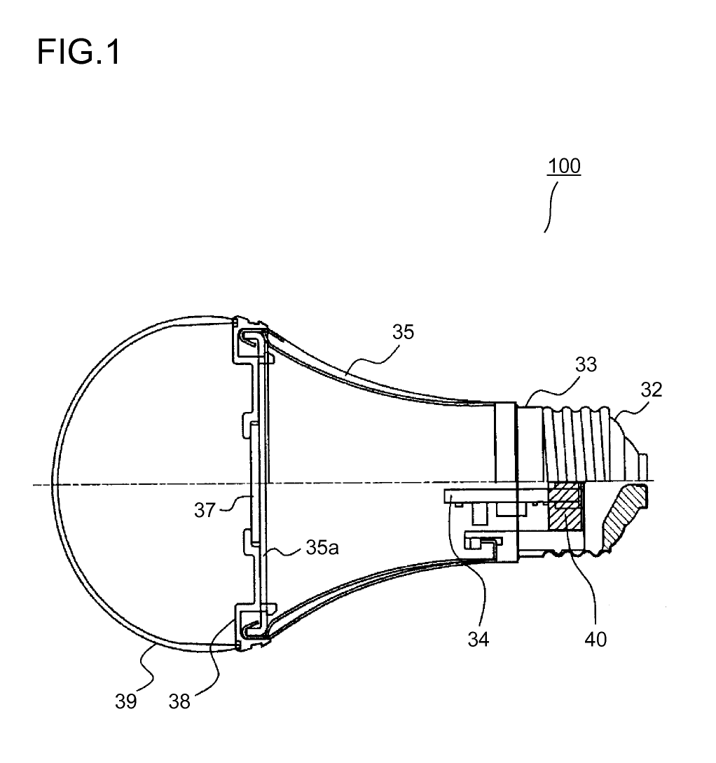

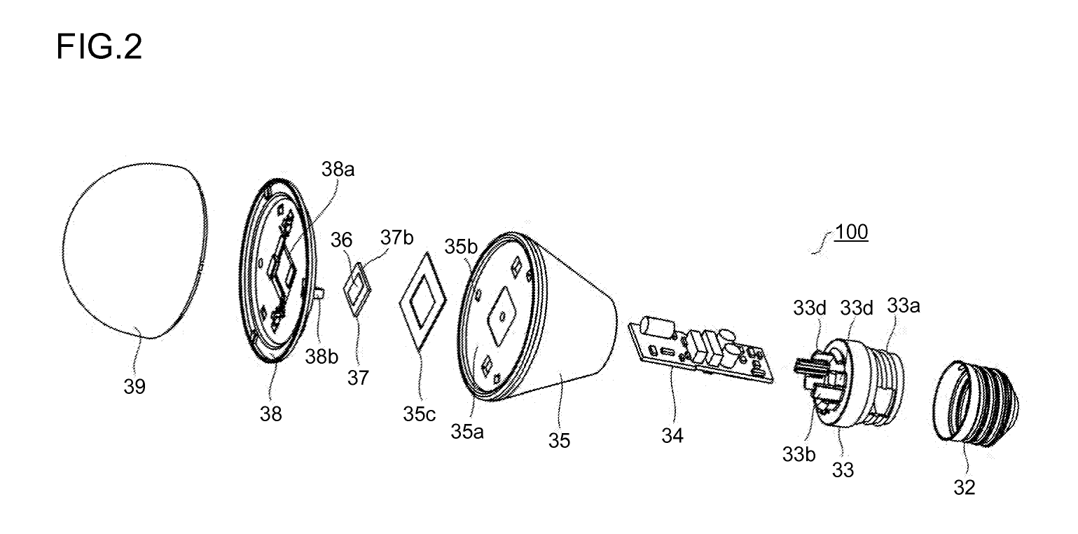

A lighting device according to a first embodiment of the present invention will first be described. FIG. 1 and FIG. 2 are a cross-sectional side view and an exploded perspective view, respectively, of the lighting device according to the first embodiment. The lighting device 100 has a base 32 at one end thereof and is configured as a bulb-type device attached to a lighting fixture. An LED module 37 having an LED element 36 is disposed inside the lighting device 100. The LED module 37 is formed by packaging the LED element 36 on a light source substrate 37b.

The outer shape of the lighting device 100 is formed by the base 32, a support member 33, a heat sink 35, and a transmitting cover 39. The base 32 is formed as an E26-type base and is screwed into a socket supplied with electric power from a commercial power source, for example. The support member 33 is formed having a cylindrical shape from a resin molded article or other insulator, and a screw part 33a is screwed on an inner surface of the base 32 and attached to the base 32. A plurality of engaging pawls 33d are provided to one end of the support member 33.

The heat sink 35 is formed from aluminum or other metal in a cylindrical shape in which a peripheral surface thereof comprises a substantially conical surface, and one end thereof is engaged with and attached to the engaging pawls 33d of the support member 33. The other end of the heat sink 35 is covered by a mounting surface 35a, and the LED module 37 is mounted on the mounting surface 35a via a heat-radiating sheet 35c comprising a flexible high thermal conductor. Heat generated by the LED element 36 is thereby radiated via the heat-radiating sheet 35c and the heat sink 35.

A resin-made module fixing part 38 is also disposed on the mounting surface 35a. The module fixing part 38 has a through-hole 38a in a center part thereof, and engaging pawls 38b are engaged and attached in a plurality of engaging holes 35b provided in the mounting surface 35a. The LED module 37 and the heat-radiating sheet 35c are thereby held by the mounting surface 35a and the module fixing part 38 in a state in which the LED element 36 is exposed from the through-hole 38a.

The transmitting cover 39 is formed having a dome shape, and is screwed onto and attached to a peripheral part of the module fixing part 38. The transmitting cover 39 is formed from a resin for diffusely transmitting the emitted light of the LED element 36.

A control substrate 34 inserted in the support member 33 and the heat sink 35 is disposed between the base 32 and the LED module 37. The control substrate 34 has a power source circuit (not shown) and other components, and converts alternating-current electric power supplied to the base 32 into direct-current electric power and supplies the direct-current electric power to the LED element 36.

One end part of the control substrate 34 is buried in a filler 40 such as UV-curable resin or epoxy resin filled into the base 32. The one-end part of the control substrate 34 is thereby bonded in such a manner that a gap between the one-end part and the base 32 is filled by the filler 40.

Columnar parts 33b facing each other are uprightly provided at two locations on an end surface of the LED element 36 side of the support member 33. Groove parts (not shown) into which the control substrate 34 is fitted are provided in internal peripheral surfaces of the columnar parts 33b so as to extend in the axial direction. A UV-curable resin, epoxy resin, or other adhesive is filled into gaps between the control substrate 34 and the groove parts, and the control substrate 34 is thereby bonded.

In the lighting device 100 configured as described above, when the base 32 is connected to a commercial power source via a socket, direct-current electric power is supplied to the LED element 36 from the control substrate 34. The LED element 36 thereby emits light. The light from the LED element 36 is diffusely transmitted through the transmitting cover 39, lighting light is emitted, and a room interior or the like is lit.

In the spectrum of the lighting light of the lighting device 100, the area having a wavelength of 600 nm to 700 nm is 30% to 70%, and the area having a wavelength of 400 nm to 500 nm is 20% or less with respect to the area having a wavelength of 400 nm to 800 nm. The maximum value of the spectrum of the lighting light is included in the wavelength range of 600 nm to 700 nm. Moreover, the value of the spectrum of the lighting light at a wavelength of 550 nm is 50% or less of the maximum value of the spectrum in the wavelength range of 600 nm to 700 nm.

By emitting lighting light having the abovementioned spectrum for lighting in a living room during business, housework, study, or other work, the comfort or feeling of relaxation of a user can be improved, and number of trials, correct answer rate, and other aspects of working efficiency can also be improved.

Through the present embodiment, light emission of the LED element 36 provides lighting that emits lighting light in which the area having a wavelength of 600 nm to 700 nm is 30% to 70%, and the area having a wavelength of 400 nm to 500 nm is 20% or less with respect to the area having a wavelength of 400 nm to 800 nm, the spectrum of the lighting light has the maximum value thereof between 600 nm and 700 nm, and the value of the spectrum at a wavelength of 550 nm is 50% or less of the maximum value thereof.

The comfort or feeling of relaxation of a user during business, housework, study, or other work can therefore be improved, and number of trials, correct answer rate, and other aspects of working efficiency can be improved. It is also generally recognized that fluorescent lamps have a risk of leakage of ultraviolet rays, and that incandescent bulbs release large quantities of infrared rays. Ultraviolet rays have adverse chemical effects on organisms, indoor equipment, and the like, and infrared rays can have adverse thermal effects. However, since lighting is performed by light emission from the LED element 36 including almost no ultraviolet rays or infrared rays, a lighting device 100 having minimal adverse effects on the human body can be provided.

In the present embodiment, the lighting device 100 is configured as a bulb-type lighting device attached to a lighting fixture, but the lighting device may also be a straight-tube-type or circular-tube-type lighting device attached to a lighting fixture. A plurality of LED elements and a control circuit for controlling the LED elements may also be provided, and dimming may be made possible by operation of an external switch.

### Second Embodiment

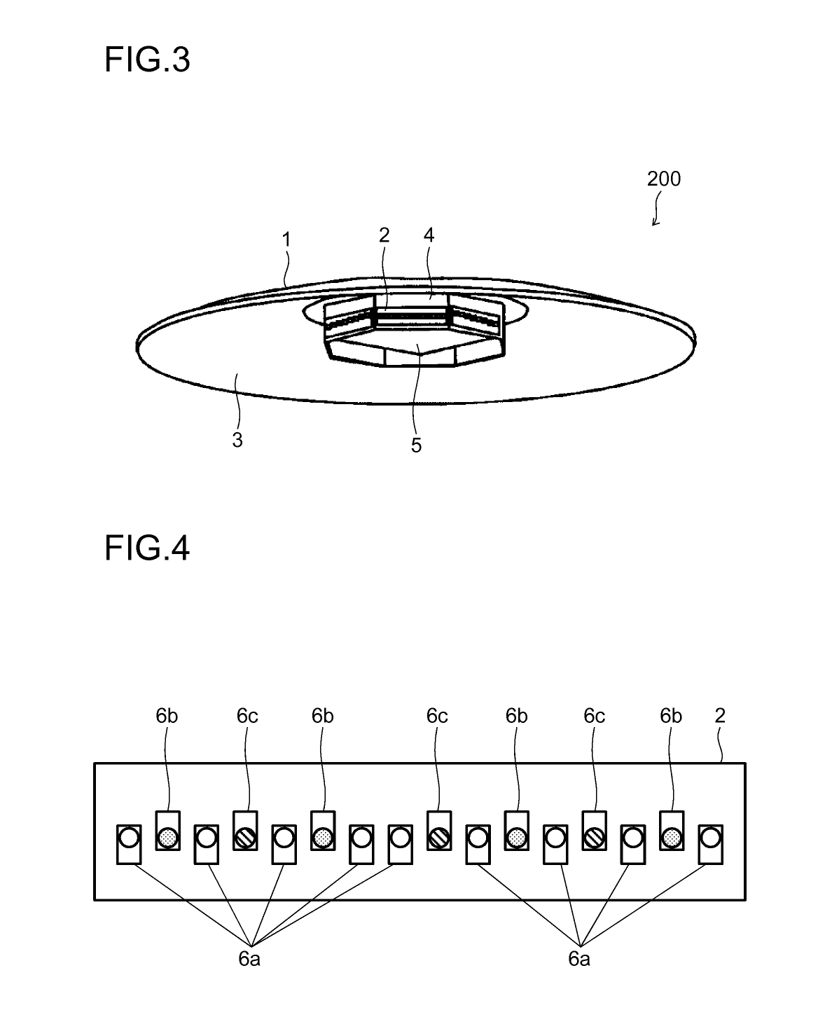

A lighting device according to a second embodiment of the present invention will next be described. FIG. 3 is a perspective view showing the entire lighting device from below. The lighting device 200 constitutes a ceiling light as a lighting fixture, and is attached to an indoor ceiling surface. The lighting device 200 may be a lighting fixture attached to an indoor side wall.

The lighting device 200 is provided with a substantially plate-shaped body 1 having a round shape which is fixed to an indoor ceiling surface positioned above the lighting device 200, and a remote controller (not shown), and the lighting device 200 lights an indoor floor surface below. The body 1 is provided with a light source substrate 2, a reflecting plate 3, a frame 4, and a lighting control unit 5.

The light source substrate 2 is formed having a rectangular shape in plan view, and is attached to a bottom surface of the body 1 via the frame 4 in a state in which the light source substrate 2 stands perpendicular or substantially perpendicular to the body 1. A plurality of light emitting diode (LED) elements (6a, 6b, 6c; see FIG. 4) are provided to a surface of the light source substrate 2. In the description below, white LED elements 6a, incandescent-bulb-color LED elements 6b, and red LED elements 6c are sometimes referred to generically as LED elements 6.

As shown in FIG. 3, the reflecting plate 3 is a bottom surface of the body 1 and is provided to a portion on the outside in the radial direction from the light source substrate 2. The reflecting plate 3 reflects the light emitted by the LED elements 6 toward a floor surface, and the reflected light lights the floor surface. An overall illuminance is thereby obtained on the floor surface.

The frame 4 forms a regular polygon (e.g., a regular octagon in FIG. 3) or a substantially regular polygon centered around a central axis line extending vertically through the body 1. A light source substrate 2 is attached to each side of the regular octagon of the frame 4 so that the emission direction of light of the LED elements 6 is radially outward. The LED elements 6 emit light radially outward in a radial pattern relative to the body 1, and the light thereof is reflected by the reflecting plate 3.

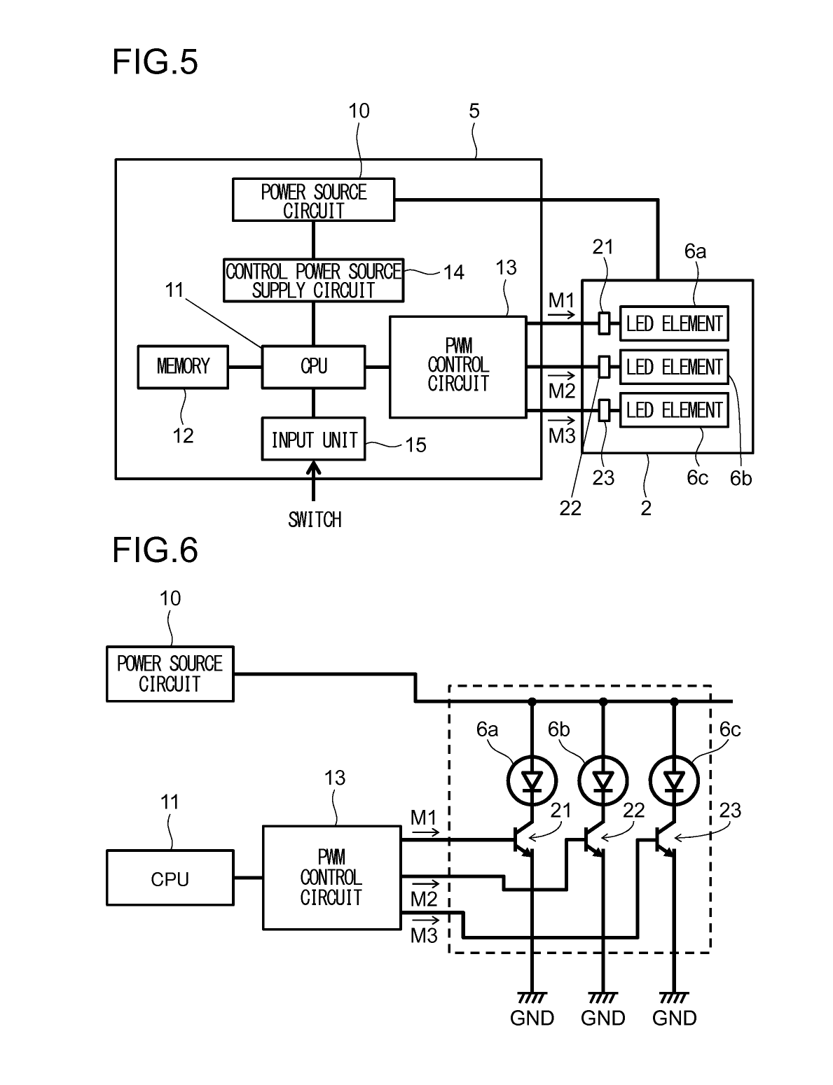

The lighting control unit 5 has a control substrate (not shown) including a light source circuit (see FIG. 5), and is disposed on a radial inside of the frame 4. The lighting control unit 5 is connected to a power source connector not shown in the drawings that is provided at a radial center part of the body 1, and receives a supply of electric power from an external power source via the power source connector. The lighting control unit 5 supplies the electric power to the LED elements 6 and causes the LED elements 6 to emit light.

Although not shown in the drawings for the sake of convenience, a diffusing lens or cover may also be provided. The diffusing lens is attached to a front surface of a light-emitting surface of the light source substrate 2, and uniformly diffuses the light emitted by the LED elements 6. The cover is circular and has substantially the same diameter as the outside diameter of the body 1, is fitted and retained on a peripheral edge part of the body 1, and covers the entire area of the bottom surface of the body 1. The cover further diffuses the light emitted by the LED elements 6 and prevents a person from directly viewing the light.

Since the LED elements 6 in the lighting device 200 thus do not directly irradiate the floor surface, the light of the LED elements 6 is not prone to shine directly into the eyes of a person even when the person is looking toward the ceiling directly at the lighting, and burden on the eyes can be reduced.

FIG. 4 is a plan view showing the light source substrate 2. The plurality of white LED elements 6a, incandescent-bulb-color LED elements 6b, and red LED elements 6c are each arranged substantially in a row, for example, on the light source substrate 2. In the present embodiment, nine white LED elements 6a, four incandescent-bulb-color LED elements 6b, and three red LED elements 6c are packaged on the light source substrate 2.

The arrangement, spacing, and other aspects of the LED elements 6 affect the uniformity of light emission to the reflecting plate 3. When light emission to the reflecting plate 3 is non-uniform, unevenness of illuminance and other problems arise, and the lighting quality of the lighting device 200 decreases. In particular, when each of the LED elements 6 emits light having a different color, and toning is performed by combination of different colors, non-uniformity of illuminance causes uneven color and significantly affects the lighting quality of the lighting device 200. Therefore, when a plurality of LED elements 6 for emitting light having different colors are used, the arrangement or spacing thereof is particularly important.

The white LED elements 6a emit white light. The incandescent-bulb-color LED elements 6b emit an incandescent-bulb color. More specifically, the incandescent-bulb-color LED elements 6b emit light having a color belonging to an isochromatic range represented by a 5-step MacAdam ellipse centered at a point (0.445, 0.408) on an xy chromaticity diagram established by the International Commission on Illumination. The red LED elements 6c emit red light. More specifically, the red LED elements 6c emit light having a maximum wavelength value of 575 nm to 780 nm.

Here, the color of the incandescent-bulb-color LED elements 6b is a color belonging to an isochromatic range represented by a 5-step MacAdam ellipse centered at a point (0.445, 0.408) on an xy chromaticity diagram as described above, and this color may have some fluctuation. The color of the red LED elements 6c herein has a maximum wavelength value of 575 nm to 780 nm as described above, but may also vary within a certain range.

The plurality of white LED elements 6a, the plurality of incandescent-bulb-color LED elements 6b, and the plurality of red LED elements 6c are therefore packaged on the light source substrate 2 as shown in FIG. 4, and fluctuation of the light emission thereof can be suppressed. A single LED element may also be configured from a plurality of different colors of LED elements.

The detailed configuration of control of the lighting device 200 will next be described using FIGS. 5 and 6 in addition to FIG. 4. FIG. 5 is a block diagram showing the configuration of the lighting device 200, and FIG. 6 is a view showing the configuration of an LED element light emission mechanism of the lighting device 200.

As shown in FIG. 5, the lighting control unit 5 is provided with a power source circuit 10. The power source circuit 10 receives a supply of electric power from an alternating-current power source (AC input, 100 V), converts the electric power to a direct-current voltage, and supplies electric power to each unit of the lighting device 200. In the present embodiment, an example is described in which the power source circuit 10 supplies electric power to a control power source supply circuit 14 and the light source substrate 2, but the power source circuit 10 is not particularly limited by this example, and may be configured to supply necessary electric power to other locations as well.

The lighting control unit 5 is provided with a central processing unit (CPU) 11, a memory 12, a pulse width modulation (PWM) control circuit 13, the control power source supply circuit 14, and an input unit 15, in addition to the power source circuit 10. As an example, the CPU 11, the memory 12, and the PWM control circuit 13 are configured from a microcomputer.

The CPU 11 is connected to each unit, and instructs necessary actions for controlling the lighting device 200 as a whole. The CPU 11 is connected wirelessly or in wired fashion to a switch not shown in the drawings, and receives instruction inputs corresponding to operations of the switch via the input unit 15.

The memory 12 stores various types of programs, initial values, and the like for controlling the lighting device 200, and is also used as a working memory for the CPU 11. The PWM control circuit 13 generates PWM pulses necessary for driving the LED elements 6 in accordance with instructions from the CPU 11. The control power source supply circuit 14 adjusts the voltage of the electric power supplied from the power source circuit 10 in order to supply electric power to the CPU 11.

As previously mentioned, three types of LED elements 6 including white LED elements 6a, incandescent-bulb-color LED elements 6b, and red LED elements 6c are disposed on the light source substrate 2, and field effect transistor (FET) switches 21, 22, 23 for driving each of the LED elements 6 are also disposed on the light source substrate 2.

One each of the white LED elements 6a, incandescent-bulb-color LED elements 6b, and red LED elements 6c is shown in FIG. 5 for the sake of convenience, but a plurality of white LED elements 6a, of incandescent-bulb-color LED elements 6b, and of red LED elements 6c are provided as shown in FIG. 4. The FET switches 21, 22, 23 may also be in the PWM control circuit 13.

The details of the mechanism of light emission by the LED elements 6 will next be described. The CPU 11 issues instructions to the PWM control circuit 13, and PWM pulses M1, M2, M3 for causing at least one type of LED element among the white LED elements 6a, the incandescent-bulb-color LED elements 6b, and the red LED elements 6c to emit light are generated and outputted.

The white LED elements 6a, the incandescent-bulb-color LED elements 6b, and the red LED elements 6c receive a supply of necessary electric power from the power source circuit 10. The FET switches 21, 22, 23 are provided between the white LED elements 6a, the incandescent-bulb-color LED elements 6b, and the red LED elements 6c, respectively, and a ground voltage GND.

The FET switches 21, 22, 23 are placed in a conducting or a non-conducting state in response to the PWM pulses M1, M2, M3, thereby supplying or interrupting an electric current to the white LED elements 6a, the incandescent-bulb-color LED elements 6b, and the red LED elements 6c. When the electric current is supplied to the white LED elements 6a, incandescent-bulb-color LED elements 6b, and red LED elements 6c, each of the LED elements 6 emits light. A configuration for causing white LED elements 6a, incandescent-bulb-color LED elements 6b, and red LED elements 6c to emit light is described above, but the configuration is the same when a plurality of other LED elements are provided.

The CPU 11 determines the timing of performing lighting by executing a program in accordance with an operating signal inputted by the input unit 15. For example, a timing may be determined for performing lighting by pressing of a switch not shown in the drawings. A timing may also be determined for performing lighting when it is detected that a time set in advance through use of a timer or the like not shown in the drawings has arrived, or that an amount of time set in advance has elapsed.

When an instruction to perform lighting is issued, the CPU 11 instructs the PWM control circuit 13 so that the white LED elements 6a, incandescent-bulb-color LED elements 6b, and red LED elements 6c emit light at an intensity specified in advance. The PWM control circuit 13 causes the PWM pulses M1, M2, M3 to be outputted in accordance with instructions of the CPU 11, and tones the lighting to a predetermined lighting color.

In the spectrum of the lighting light of the lighting device 200, the area having a wavelength of 600 nm to 700 nm is 30% to 70%, and the area having a wavelength of 400 nm to 500 nm is 20% or less with respect to the area having a wavelength of 400 nm to 800 nm, the same as in the first embodiment. The maximum value of the spectrum of the lighting light is included in the wavelength range of 600 nm to 700 nm. Moreover, the value of the spectrum of the lighting light at a wavelength of 550 nm is 50% or less of the maximum value of the spectrum in the wavelength range of 600 nm to 700 nm.

By emitting lighting light having the abovementioned spectrum for lighting in a living room during business, housework, study, or other work, the comfort or feeling of relaxation of a user can be improved, and number of trials, correct answer rate, and other aspects of working efficiency can also be improved.

Through the present embodiment, light emission of the LED elements 6 provides lighting that emits lighting light in which the area having a wavelength of 600 nm to 700 nm is 30% to 70%, and the area having a wavelength of 400 nm to 500 nm is 20% or less with respect to the area having a wavelength of 400 nm to 800 nm, the spectrum of the lighting light has the maximum value thereof between 600 nm and 700 nm, and the value of the spectrum at a wavelength of 550 nm is 50% or less of the maximum value thereof.

Consequently, by emitting lighting light having the abovementioned spectrum for lighting in a living room during business, housework, study, or other work, the comfort or feeling of relaxation of a user can be improved, and number of trials, correct answer rate, and other aspects of working efficiency can also be improved. Since lighting is performed by light emission from the LED elements 6 including almost no ultraviolet rays or infrared rays, a lighting device 200 having minimal adverse effects on the human body can be provided.

A configuration may also be adopted in which a plurality of lighting lights having different spectrums included in the abovementioned range can be selected and emitted. Working capacity and the like can therefore be improved according to the state of a user.

Since the present embodiment has white LED elements 6a, incandescent-bulb-color LED elements 6b, and red LED elements 6c for emitting light in different colors, lighting light having a spectrum in the abovementioned range can easily be emitted.

In the present embodiment, the lighting color may be toned by LED elements 6 having other light emission colors. For example, a plurality of LED elements for emitting each of blue light, green light, and red light may be provided.

LED elements and phosphors for converting the emitted light of an LED element to a different wavelength may also be provided. For example, a plurality of LED elements for emitting blue light may be provided, and phosphors for converting blue to incandescent-bulb-color, red, and yellow may be provided corresponding to each LED element. White light may be formed by blue light and yellow light, and the lighting color may be toned by white, incandescent-bulb-color, and red light in the same manner as described above.

### Third Embodiment

A lighting device according to a third embodiment of the present invention will next be described. Since the basic configuration of this embodiment is the same as that of the second embodiment previously described, constituent elements thereof that are common to the second embodiment are referred to by the same reference numerals as previously used, and drawings and descriptions thereof are omitted.

In the lighting device 200 according to the third embodiment, the CPU 11 shown in FIG. 5 determines the timing of performing lighting by executing a program in accordance with an operating signal inputted by the input unit 15. For example, a timing may be determined for performing lighting by pressing of a switch not shown in the drawings. A timing may also be determined for performing lighting when it is detected that a time set in advance through use of a timer or the like not shown in the drawings has arrived, or that an amount of time set in advance has elapsed.

When an instruction to perform lighting is issued, the CPU 11 instructs the PWM control circuit 13 so that the white LED elements 6a, incandescent-bulb-color LED elements 6b, and red LED elements 6c emit light at an intensity specified in advance. The PWM control circuit 13 causes the PWM pulses M1, M2, M3 to be outputted in accordance with instructions of the CPU 11, and tones the lighting to a predetermined lighting color.

In the spectrum of the lighting light of the lighting device 200, the area having a wavelength of 600 nm to 700 nm is 30% to 70%, and the area having a wavelength of 400 nm to 500 nm is 20% or less with respect to the area having a wavelength of 400 nm to 800 nm. The maximum value of the spectrum of the lighting light is included in the wavelength range of 600 nm to 700 nm. Moreover, the maximum value of the spectrum of the lighting light in a wavelength range of 500 nm to 600 nm is 70% or less of the maximum value of the spectrum in the wavelength range of 600 nm to 700 nm.

By emitting lighting light having the abovementioned spectrum for lighting in a living room during recesses or small social gatherings, the comfort or feeling of relaxation of a user can be improved. Tiredness in a user due to work load from business, housework, or other work can also be reduced.

Through the present embodiment, light emission of the LED elements provides lighting that emits lighting light in which the area of the spectrum thereof having a wavelength of 600 nm to 700 nm is 30% to 70%, and the area having a wavelength of 400 nm to 500 nm is 20% or less with respect to the area having a wavelength of 400 nm to 800 nm, the spectrum of the lighting light has the maximum value thereof between 600 nm and 700 nm, and the maximum value of the spectrum at a wavelength of 500 nm to 600 nm is 70% or less of the maximum value of the spectrum.

Comfort or feeling of relaxation of a user during recesses or small social gatherings can therefore be improved. Tiredness in a user during business, housework, or other work can also be reduced. It is also generally recognized that fluorescent lamps have a risk of leakage of ultraviolet rays, and that incandescent bulbs release large quantities of infrared rays. Ultraviolet rays have adverse chemical effects on organisms, indoor equipment, and the like, and infrared rays can have adverse thermal effects. However, since lighting is performed by light emission from the LED elements 6 including almost no ultraviolet rays or infrared rays, a lighting device 200 having minimal adverse effects on the human body can be provided.

A configuration may also be adopted in which a plurality of lighting lights having different spectrums included in the abovementioned range can be selected and emitted. Working capacity or sleep efficiency can thereby be improved according to the state of a user.

Since the present embodiment has white LED elements 6a, incandescent-bulb-color LED elements 6b, and red LED elements 6c for emitting light in different colors, lighting light having a spectrum in the abovementioned range can easily be emitted.

In the present embodiment, the lighting color may be toned by LED elements 6 having other light emission colors. For example, a plurality of LED elements for emitting each of blue light, green light, and red light may be provided.

LED elements and phosphors for converting the emitted light of an LED element to a different wavelength may also be provided. For example, a plurality of LED elements for emitting blue light may be provided, and phosphors for converting blue to incandescent-bulb-color, red, and yellow may be provided corresponding to each LED element. White light may be formed by blue light and yellow light, and the lighting color may be toned by white, incandescent-bulb-color, and red light in the same manner as described above.

A lighting fixture attached in a living room is configured from the lighting device 200, but the lighting device may also constitute a light bulb or the like attached to a lighting fixture.

### Fourth Embodiment

A lighting device according to a fourth embodiment of the present invention will next be described. Since the basic configuration of this embodiment is the same as that of the second embodiment previously described, constituent elements thereof that are common to the second embodiment are referred to by the same reference numerals as previously used, and drawings and descriptions thereof are omitted.

In the lighting device 200 according to the fourth embodiment, the LED elements 6 emit a quantity of light corresponding to operation of a remote controller (not shown) through use of the light emission mechanism shown in FIG. 6, and lighting light having a plurality of lighting colors described hereinafter is emitted.

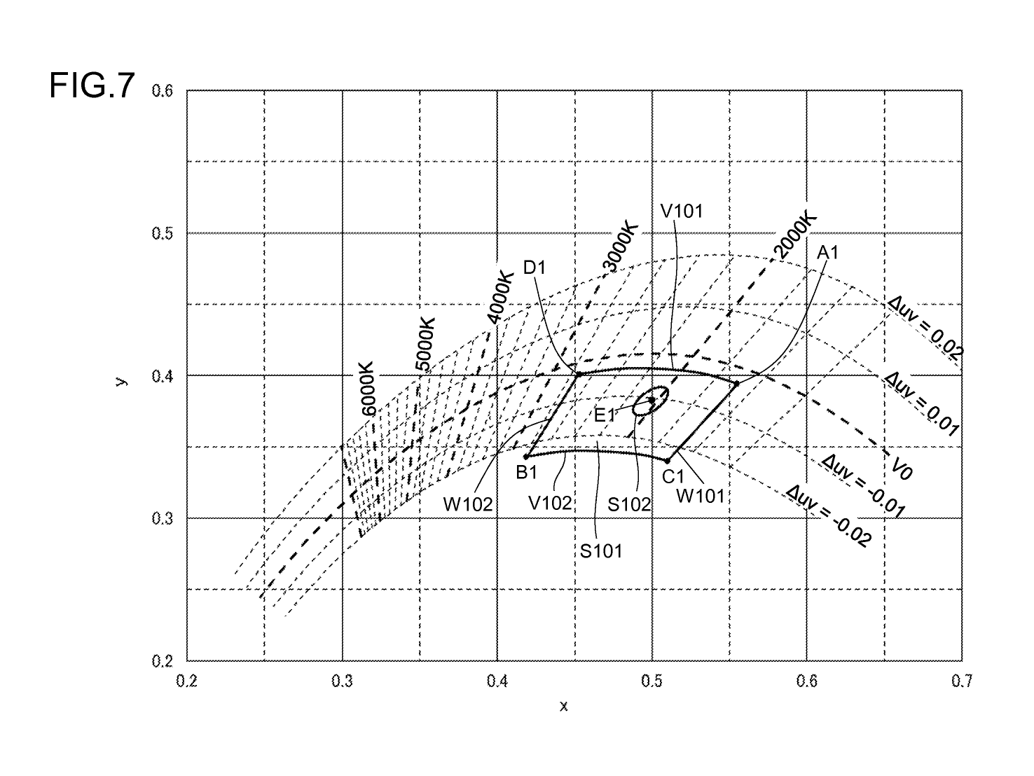

FIG. 7 is a detail view of the vicinity of a blackbody locus V0 on an xy chromaticity diagram established by the International Commission on Illumination. In FIG. 7, isotemperature line groups and isanomal groups for the blackbody locus V0 are shown superposed on each other. The lighting device 200 according to the fourth embodiment emits lighting light having a lighting color within a region S101 surrounded by the isotemperature line W101 and the isanomal V101 for the blackbody locus V0 which pass through the point A1 (0.555, 0.394), and the isotemperature line W102 and the isanomal V102 for the blackbody locus V0 which pass through the point B1 (0.419, 0.343) on the xy chromaticity diagram.

The point A1 represents a point having a correlated color temperature of 1680 K and a deviation Δuv with respect to the blackbody locus V0 equal to −0.003. The point B1 represents a point having a correlated color temperature of 2750 K and a deviation Δuv with respect to the blackbody locus V0 equal to −0.025. The chromaticity coordinates of the intersection point C1 of the isotemperature line W101 and the isanomal V102 are (0.510, 0.340), and the chromaticity coordinates of the intersection point D1 of the isotemperature line W102 and the isanomal V101 are (0.453, 0.401). Consequently, the region S101 is surrounded clockwise by the points A1, C1, B1, and D1 in FIG. 7.

The region S101 has a yellowish red or orange-pink color. The lighting device 200 therefore emits lighting light having a yellowish-red lighting color or an orange-pink lighting color. Parasympathetic nerves of a user in a living room can thereby be made dominant without inhibiting melatonin secretion. As a result, the lighting device 200 can shorten sleep onset latency at bedtime, thus increasing total sleep time, and can improve sleep efficiency. The lighting device 200 can also bring about relaxation and recovery during recesses or small social gatherings and alleviate accumulated tiredness.

The colors “yellowish red” and “orange-pink” correspond to light source colors specified by the JIS standard (JIS Z 8110).

The lighting device 200 configured as described above is provided with a plurality of lighting modes. In the lighting device 200, the desired lighting mode is selected by a remote controller. The CPU 11 thereby instructs the PWM control circuit 13 so that the white LED elements 6a, incandescent-bulb-color LED elements 6b, and red LED elements 6c emit light at an intensity specified in advance. The PWM control circuit 13 causes the PWM pulses M1, M2, M3 to be outputted in accordance with instructions of the CPU 11, and tones the lighting to the lighting color corresponding to each lighting mode.

Through the present embodiment, by light emission of the LED elements 6, the lighting device 200 emits lighting light having a lighting color within the region S101 surrounded by the isotemperature line W101 and the isanomal V101 for the blackbody locus V0 which pass through the point A1 (0.555, 0.394), and the isotemperature line W102 and the isanomal V102 for the blackbody locus V0 which pass through the point B1 (0.419, 0.343) on the xy chromaticity diagram established by the International Commission on Illumination.

Good quality sleep can therefore be obtained, and accumulated tiredness can be alleviated.

It is also generally recognized that fluorescent lamps have a risk of leakage of ultraviolet rays, and that incandescent bulbs release large quantities of infrared rays. Ultraviolet rays have adverse chemical effects on organisms, indoor equipment, and the like, and infrared rays can have adverse thermal effects. However, since lighting is performed by light emission from the LED elements 6 including almost no ultraviolet rays or infrared rays, a lighting device 200 having minimal adverse effects on the human body can be provided.

Since the present embodiment has white LED elements 6a, incandescent-bulb-color LED elements 6b, and red LED elements 6c for emitting light having different colors, lighting light having a lighting color within the abovementioned region S101 can easily be emitted.

In the embodiment described above, a lighting color within the abovementioned region S101 may be toned by LED elements 6 having other light emission colors. For example, LED elements for emitting each of blue light, green light, and red light may be provided.

The color of the lighting light may also be made variable between white and a color within the abovementioned region S101. By this configuration, the lighting device 200 can emit lighting light having a lighting color within the abovementioned region S101, and can also emit lighting light in which the lighting color thereof is mixed with a color that is between white and a color within the aforementioned region S101.

An LED element and a phosphor for converting the emitted light of the LED element to a different wavelength may also be provided. For example, an LED element for emitting blue light may be provided, and phosphors for converting blue to each of incandescent-bulb-color, red, and yellow may be provided. White light may be formed by blue light and yellow light, and the lighting color within the abovementioned region S101 may be toned by white, incandescent-bulb-color, and red light in the same manner as described above.

A lighting fixture attached in a living room is configured from the lighting device 200, but the lighting device may also constitute a light bulb or the like attached to a lighting fixture.

### Fifth Embodiment

A lighting device according to a fifth embodiment of the present invention will next be described. Since the basic configuration of this embodiment is the same as that of the second embodiment previously described, constituent elements thereof that are common to the second embodiment are referred to by the same reference numerals as previously used, and drawings and descriptions thereof are omitted.

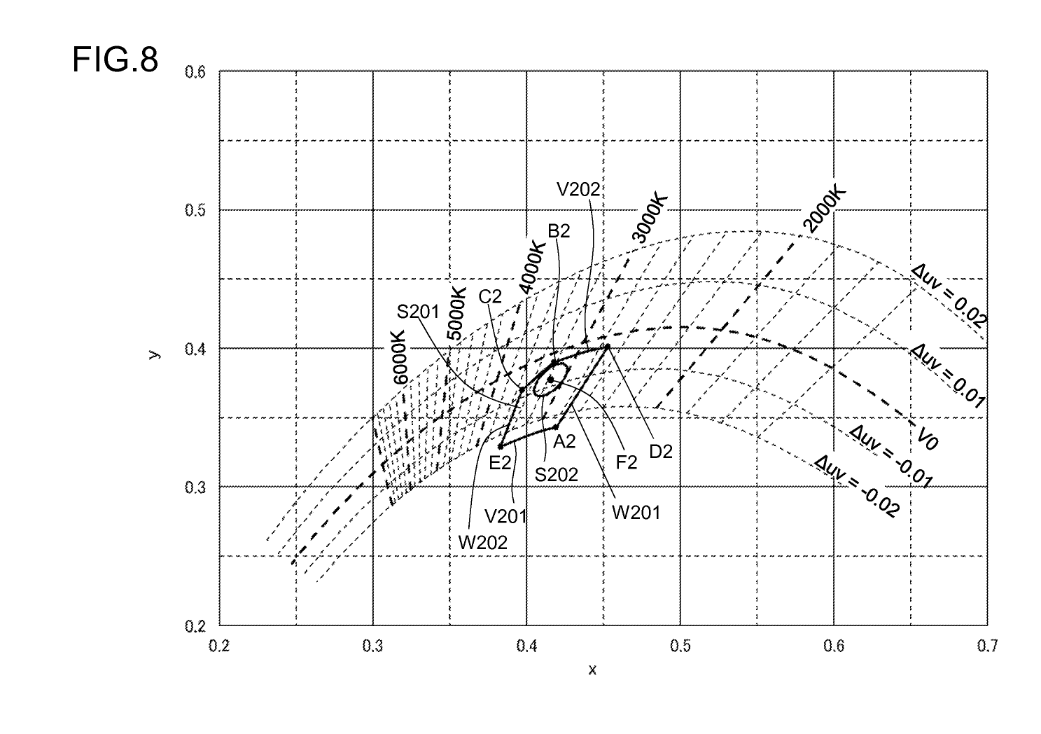

FIG. 8 is a detail view of the vicinity of a blackbody locus V0 on an xy chromaticity diagram established by the International Commission on Illumination. In FIG. 8, isotemperature line groups and isanomal groups for the blackbody locus V0 are shown superposed on each other. The lighting device 200 according to the fifth embodiment emits lighting light within a region S201 surrounded by the isotemperature line W201 and the isanomal V201 for the blackbody locus V0 which pass through the point A2 (0.419, 0.343), the isanomal V202 for the blackbody locus V0 which pass through the point B2 (0.418, 0.390), the isotemperature line W202 passing through the point C2 (0.397, 0.370), and a straight line connecting point B2 and point C2 on the xy chromaticity diagram.

The point A2 represents a point having a correlated color temperature of 2750 K and a deviation Δuv with respect to the blackbody locus V0 equal to −0.025. The point B2 represents a point having a correlated color temperature of 3250 K and a deviation Δuv with respect to the blackbody locus V0 equal to −0.003. The point C2 represents a point having a correlated color temperature of 3500 K and a deviation Δuv with respect to the blackbody locus V0 equal to −0.008. The chromaticity coordinates of the intersection point D2 of the isotemperature line W201 and the isanomal V202 are (0.453, 0.401), and the chromaticity coordinates of the intersection point E2 of the isotemperature line W202 and the isanomal V201 are (0.383, 0.329). Consequently, the region S201 is surrounded clockwise by the points A2, E2, C2, B2, and D2 in FIG. 8.

The region S201 has a color between yellowish red and yellowish white, or between orange-pink and pale pink. The lighting device 200 therefore emits lighting light having a lighting color between yellowish red and yellowish white, or between orange-pink and pale pink. Arousal of the sympathetic nervous system due to business, housework, or other work load is thereby suppressed, and tiredness is reduced. As a result, the lighting device 200 can suppress a reduction in working capacity during prolonged work and improve working capacity.

The colors “yellowish red,” “yellowish white,” “orange-pink,” “and “pale pink” correspond to light source colors specified by the JIS standard (JIS Z 8110).

The lighting device 200 configured as described above is provided with a plurality of lighting modes. In the lighting device 200, the desired lighting mode is selected by a remote controller. The CPU 11 thereby instructs the PWM control circuit 13 so that the white LED elements 6a, incandescent-bulb-color LED elements 6b, and red LED elements 6c emit light at an intensity specified in advance. The PWM control circuit 13 causes the PWM pulses M1, M2, M3 to be outputted in accordance with instructions of the CPU 11, and tones the lighting to the lighting color corresponding to each lighting mode.

Through the present embodiment, by light emission of the LED elements 6, the lighting device 200 emits lighting light having a lighting color within the region S201 surrounded by the isotemperature line W201 and the isanomal V201 for the blackbody locus V0 which pass through the point A2 (0.419, 0.343), the isanomal V202 for the blackbody locus V0 passing through the point B2 (0.418, 0.390), the isotemperature line W202 passing through the point C2 (0.397, 0.370), and a straight line connecting point B2 and point C2 on the xy chromaticity diagram established by the International Commission on Illumination.

The capacity for work by the user can therefore be improved.

It is also generally recognized that fluorescent lamps have a risk of leakage of ultraviolet rays, and that incandescent bulbs release large quantities of infrared rays. Ultraviolet rays have adverse chemical effects on organisms, indoor equipment, and the like, and infrared rays can have adverse thermal effects. However, since lighting is performed by light emission from the LED elements 6 including almost no ultraviolet rays or infrared rays, a lighting device 200 having minimal adverse effects on the human body can be provided.

Since the present embodiment has white LED elements 6a, incandescent-bulb-color LED elements 6b, and red LED elements 6c for emitting light having different colors, lighting light having a lighting color within the abovementioned region S201 can easily be emitted.

In the embodiment described above, a lighting color within the abovementioned region S201 may be toned by LED elements 6 having other light emission colors. For example, LED elements for emitting each of blue light, green light, and red light may be provided.

The color of the lighting light may also be made variable between white and a color within the abovementioned region S201. By this configuration, the lighting device 200 can emit lighting light having a lighting color within the abovementioned region S201, and can also emit lighting light in which the lighting color thereof is mixed with a color that is between white and a color within the aforementioned region S201.

An LED element and a phosphor for converting the emitted light of the LED element to a different wavelength may also be provided. For example, an LED element for emitting blue light may be provided, and phosphors for converting blue to each of incandescent-bulb-color, red, and yellow may be provided. White light may be formed by blue light and yellow light, and the lighting color within the abovementioned region S201 may be toned by white, incandescent-bulb-color, and red light in the same manner as described above.

A lighting fixture attached in a living room is configured from the lighting device 200, but the lighting device may also constitute a light bulb or the like attached to a lighting fixture.

### Sixth Embodiment

A lighting device according to a sixth embodiment of the present invention will next be described. Since the basic configuration of this embodiment is the same as that of the second embodiment previously described, constituent elements thereof that are common to the second embodiment are referred to by the same reference numerals as previously used, and drawings and descriptions thereof are omitted.

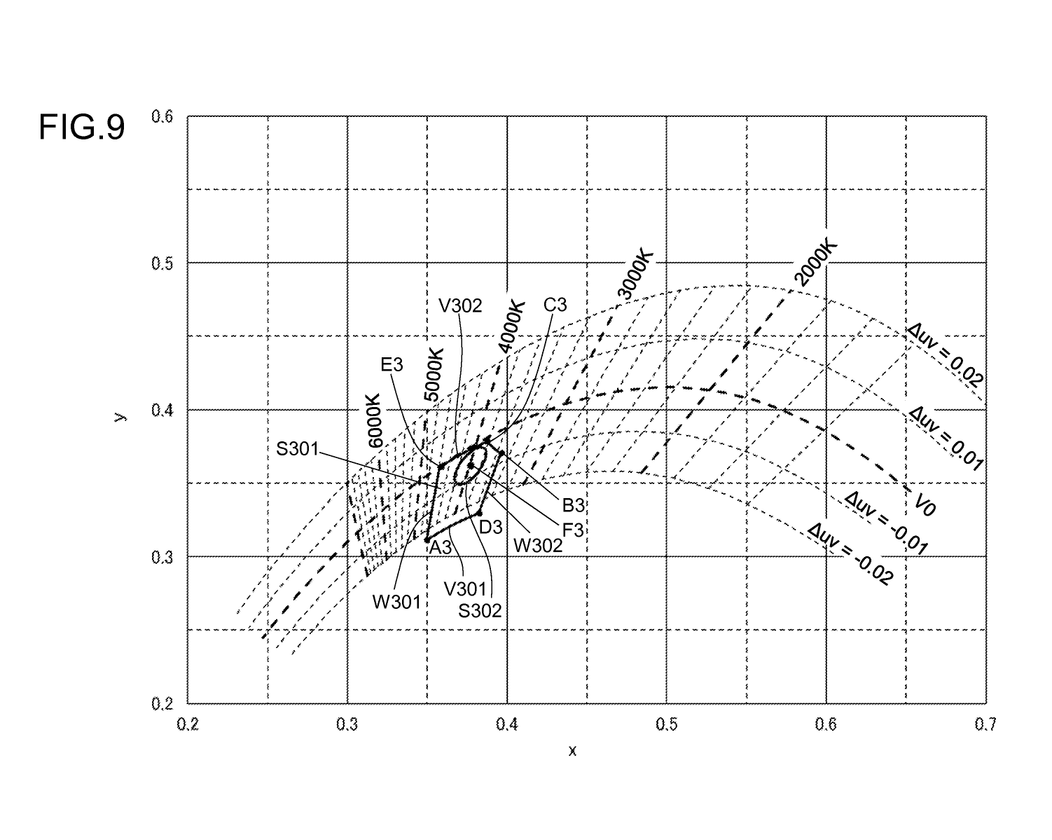

FIG. 9 is a detail view of the vicinity of a blackbody locus V0 on an xy chromaticity diagram established by the International Commission on Illumination. In FIG. 9, isotemperature line groups and isanomal groups for the blackbody locus V0 are shown superposed on each other. The lighting device 200 according to the sixth embodiment emits lighting light having a lighting color within a region S301 surrounded by the isotemperature line W301 and the isanomal V301 which pass through the point A3 (0.350, 0.311), the isotemperature line W302 passing through the point B3 (0.397, 0.370), the isanomal V302 passing through the point C3 (0.388, 0.378), and a straight line connecting point B3 and point C3 on the xy chromaticity diagram.

The point A3 represents a point having a correlated color temperature of 4500 K and a deviation Δuv with respect to the blackbody locus V0 equal to −0.025. The point B3 represents a point having a correlated color temperature of 3500 K and a deviation Δuv with respect to the blackbody locus V0 equal to −0.008. The point C3 represents a point having a correlated color temperature of 3800 K and a deviation Δuv with respect to the blackbody locus V0 equal to −0.001. The chromaticity coordinates of the intersection point D3 of the isotemperature line W302 and the isanomal V301 are (0.383, 0.329), and the chromaticity coordinates of the intersection point E3 of the isotemperature line W301 and the isanomal V302 are (0.359, 0.358). Consequently, the region S301 is surrounded clockwise by the points A3, E3, C3, B3, and D3 in FIG. 9.

The region S301 has a yellowish white or pale pink color. The lighting device 200 therefore emits lighting light having a yellowish white lighting color or a pale pink lighting color. Excitation of the sympathetic nervous system due to stress can thereby be suppressed. As a result, the lighting device 200 can alleviate user stress.

The colors “yellowish red” and “pale pink” correspond to light source colors specified by the JIS standard (JIS Z 8110).

The lighting device 200 configured as described above is provided with a plurality of lighting modes. In the lighting device 200, the desired lighting mode is selected by a remote controller. The CPU 11 thereby instructs the PWM control circuit 13 so that the white LED elements 6a, incandescent-bulb-color LED elements 6b, and red LED elements 6c emit light at an intensity specified in advance. The PWM control circuit 13 causes the PWM pulses M1, M2, M3 to be outputted in accordance with instructions of the CPU 11, and tones the lighting to the lighting color corresponding to each lighting mode.

Through the present embodiment, by light emission of the LED elements 6, the lighting device 200 emits lighting light having a lighting color within the region S301 surrounded by the isotemperature line W301 and the isanomal V301 for the blackbody locus V0 which pass through the point A3 (0.350, 0.311), the isotemperature line W302 passing through the point B3 (0.397, 0.370), the isanomal V302 for the blackbody locus V0 passing through the point C3 (0.388, 0.378), and a straight line connecting point B3 and point C3 on the xy chromaticity diagram established by the International Commission on Illumination.

User stress can therefore be alleviated.

It is also generally recognized that fluorescent lamps have a risk of leakage of ultraviolet rays, and that incandescent bulbs release large quantities of infrared rays. Ultraviolet rays have adverse chemical effects on organisms, indoor equipment, and the like, and infrared rays can have adverse thermal effects. However, since lighting is performed by light emission from the LED elements 6 including almost no ultraviolet rays or infrared rays, a lighting device 200 having minimal adverse effects on the human body can be provided.

Since the present embodiment has white LED elements 6a, incandescent-bulb-color LED elements 6b, and red LED elements 6c for emitting light having different colors, lighting light having a lighting color within the abovementioned region S301 can easily be emitted.

In the embodiment described above, a lighting color within the abovementioned region S301 may be toned by LED elements 6 having other light emission colors. For example, LED elements for emitting each of blue light, green light, and red light may be provided.

The color of the lighting light may also be made variable between white and a color within the abovementioned region S301. By this configuration, the lighting device 200 can emit lighting light having a lighting color within the abovementioned region S301, and can also emit lighting light in which the lighting color thereof is mixed with a color that is between white and a color within the aforementioned region S301.

An LED element and a phosphor for converting the emitted light of the LED element to a different wavelength may also be provided. For example, an LED element for emitting blue light may be provided, and phosphors for converting blue to each of incandescent-bulb-color, red, and yellow may be provided. White light may be formed by blue light and yellow light, and the lighting color within the abovementioned region S301 may be toned by white, incandescent-bulb-color, and red light in the same manner as described above.

A lighting fixture attached in a living room is configured from the lighting device 200, but the lighting device may also constitute a light bulb or the like attached to a lighting fixture.

### Seventh Embodiment

A lighting device according to a seventh embodiment of the present invention will next be described. Since the basic configuration of this embodiment is the same as that of the second embodiment previously described, constituent elements thereof that are common to the second embodiment are referred to by the same reference numerals as previously used, and drawings and descriptions thereof are omitted.

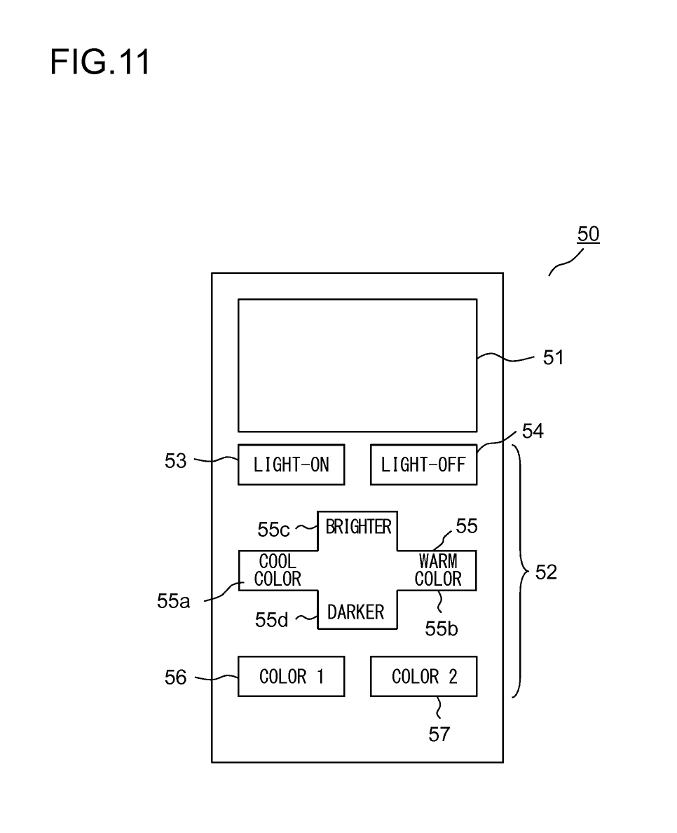

The lighting device 200 according to the seventh embodiment is provided with a substantially plate-shaped body 1 having a round shape which is fixed to an indoor ceiling surface positioned above the lighting device 200, and a remote controller 50 (see FIG. 11), and the lighting device 200 lights an indoor floor surface below. The CPU 11 shown in FIG. 5 is connected wirelessly or in wired fashion to a remote controller 50 (see FIG. 11) or other switch, and receives instruction inputs corresponding to operations of the switch via the input unit 15.

The LED elements 6 emit a quantity of light corresponding to operation of the remote controller 50 through use of the light emission mechanism described above, and lighting light having a plurality of lighting colors is emitted. The lighting device 200 is provided with a first lighting mode, a second lighting mode, a cool-color lighting mode, and a warm-color lighting mode. The lighting color can be varied to a color between the cool-color lighting mode and the warm-color lighting mode.

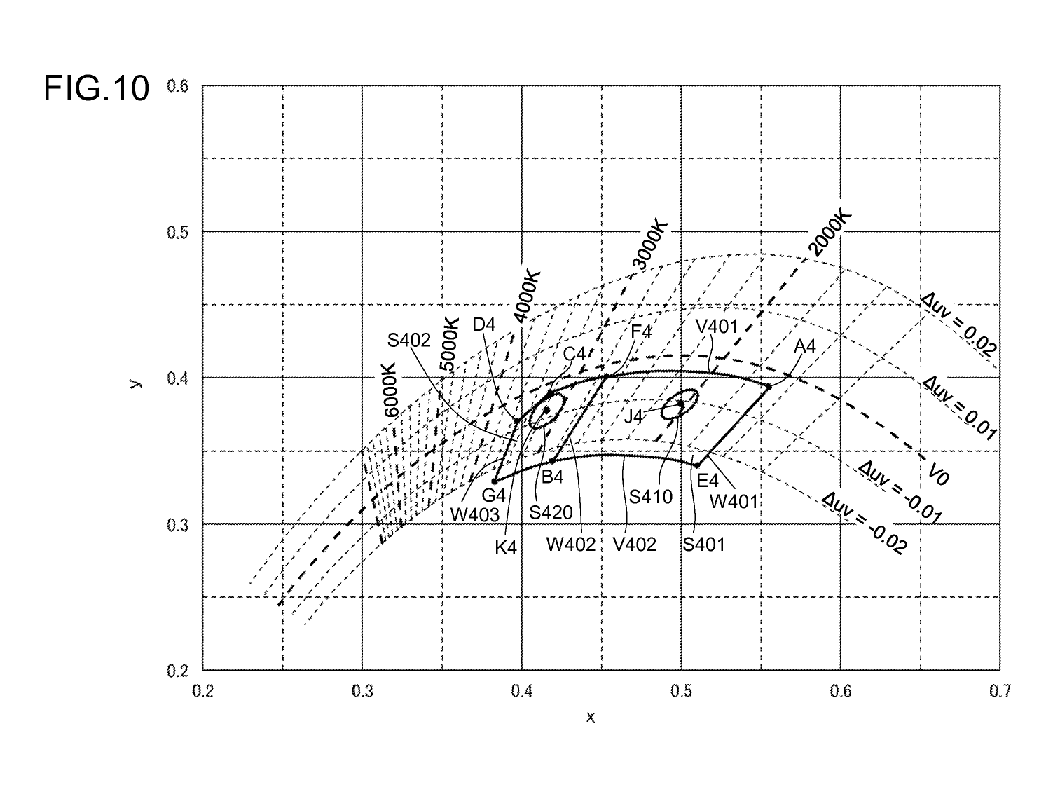

FIG. 10 is a detail view of the vicinity of a blackbody locus V0 on an xy chromaticity diagram established by the International Commission on Illumination. In FIG. 10, isotemperature line groups and isanomal groups for the blackbody locus V0 are shown superposed on each other. In the first lighting mode, lighting light is emitted having a lighting color within a first region S401 surrounded by the isotemperature line W401 and the isanomal V401 for the blackbody locus V0 which pass through the point A4 (0.555, 0.394), and the isotemperature line W402 and the isanomal V402 for the blackbody locus V0 which pass through the point B4 (0.419, 0.343) on the xy chromaticity diagram.

The point A4 represents a point having a correlated color temperature of 1680 K and a deviation Δuv with respect to the blackbody locus V0 equal to −0.003. The point B4 represents a point having a correlated color temperature of 2750 K and a deviation Δuv with respect to the blackbody locus V0 equal to −0.025. The chromaticity coordinates of the intersection point E4 of the isotemperature line W401 and the isanomal V402 are (0.510, 0.340), and the chromaticity coordinates of the intersection point F4 of the isotemperature line W402 and the isanomal V401 are (0.453, 0.401). Consequently, the first region S401 is surrounded clockwise by the points A4, E4, B4, and F4 in FIG. 10.

In the second lighting mode, lighting light is emitted having a lighting color within a second region S402 surrounded by the isotemperature line W402 and the isanomal V402 passing through the point B4, the isanomal V401 passing through the point C4 (0.418, 0.390), the isotemperature line W403 passing through the point D4 (0.397, 0.370), and a straight line connecting point C4 and point D4 on the xy chromaticity diagram.

The point C4 represents a point having a correlated color temperature of 3250 K and a deviation Δuv with respect to the blackbody locus V0 equal to −0.003. The point D4 represents a point having a correlated color temperature of 3500 K and a deviation Δuv with respect to the blackbody locus V0 equal to −0.008. The chromaticity coordinates of the intersection point G4 of the isotemperature line W403 and the isanomal V402 are (0.383, 0.329). Consequently, the second region S402 is surrounded clockwise by the points F4, B4, G4, D4, and C4, and is continuous with the first region S401 in FIG. 10.

The first region S401 has a yellowish red or orange-pink color. Lighting light having a yellowish-red lighting color or an orange-pink lighting color is therefore emitted by the first lighting mode. Parasympathetic nerves of a user in a living room can thereby be made dominant without inhibiting melatonin secretion. As a result, sleep onset latency at bedtime can be shortened, total sleep time can be lengthened, and sleep efficiency can be improved. Relaxation and recovery can also be brought about during recesses or small social gatherings, and accumulated tiredness can be alleviated.

The second region S402 has a color between yellowish red and yellowish white, or between orange-pink and pale pink. Lighting light having a lighting color between yellowish-red and yellowish white or a lighting color between orange-pink and pale pink is therefore emitted by the second lighting mode. Arousal of the sympathetic nervous system due to business, housework, or other work load is thereby suppressed, and tiredness during work is reduced. As a result, a reduction in working capacity during prolonged work can be suppressed, and working capacity can be improved.

In the cool-color lighting mode, lighting light is emitted having a conventionally used daylight, neutral white, or white (narrowly defined) lighting color. In the warm-color lighting mode, lighting light is emitted having a conventionally used incandescent-bulb-color or warm white lighting color.

The colors “yellowish red,” “orange-pink,” “yellowish white,” “pale pink,” “daylight,” “neutral white,” “narrowly defined white,” “incandescent-bulb-color,” and “warm white” correspond to light source colors specified by the JIS standard (JIS Z 8110).

FIG. 11 is a front view showing the remote controller 50. The remote controller 50 is provided with a display unit 51 and an operating unit 52. The display unit 51 is formed from a liquid crystal panel or the like, and displays the quantity of light and other characteristics of the lighting device 200. The operating unit 52 comprises a plurality of operating keys and has a light-on key 53, a light-off key 54, a cross key 55, a first lighting mode key 56, and a second lighting mode key 57.

By operation of the light-on key 53, current is conducted to the LED elements 6, and the lighting device 200 is turned on. By operation of the light-off key 54, current conduction to the LED elements 6 is cut off, and the lighting device 200 is turned off.

The cross key 55 (variable switch) has a cool-color part 55a, a warm-color part 55b, a brightening part 55c, and a dimming part 55d. By operation of the cool-color part 55a and the warm-color part 55b, the lighting color is varied in stages between the lighting color of the cool-color lighting mode and the lighting color of the warm-color lighting mode. Variation of the lighting color can easily be achieved by increasing or decreasing the quantity-of-light ratio of the white LED elements 6a and the incandescent-bulb-color LED elements 6b.

The brightening part 55c is indicated by the label “Brighter” on the cross key 55, and increases the quantity of the lighting light. The dimming part 55d is indicated by the label “Darker” on the cross key 55, and decreases the quantity of the lighting light.

The first lighting mode key 56 (first operating switch) performs lighting according to the first lighting mode. In the present embodiment, the first lighting mode is configured to produce an orange-pink lighting color and is indicated by the label “Color 1” on the first lighting mode key 56. In such cases as when the first lighting mode is configured to produce a lighting color other than orange-pink, another label may be written on the first lighting mode key 56 as appropriate.

The second lighting mode key 57 (second operating switch) performs lighting according to the second lighting mode. In the present embodiment, the second lighting mode is configured to produce a pale pink lighting color and is indicated by the label “Color 2” on the second lighting mode key 57. In such cases as when the second lighting mode is configured to produce a lighting color other than pale pink, another label may be written on the second lighting mode key 57 as appropriate.

In the lighting device 200, the desired lighting mode is selected by the remote controller 50. The CPU 11 thereby instructs the PWM control circuit 13 so that the white LED elements 6a, incandescent-bulb-color LED elements 6b, and red LED elements 6c emit light at an intensity specified in advance. The PWM control circuit 13 causes the PWM pulses M1, M2, M3 to be outputted in accordance with instructions of the CPU 11, and tones the lighting to the lighting color corresponding to each lighting mode.

According to the present embodiment, by light emission of the LED elements 6, a first lighting mode is provided for emitting lighting light having a lighting color within the first region S401 surrounded by the isotemperature line W401 and the isanomal V401 which pass through the point A4 (0.555, 0.394), and the isotemperature line W402 and the isanomal V402 which pass through the point B4 (0.419, 0.343) on the xy chromaticity diagram. A second lighting mode is also provided for emitting lighting light having a lighting color within the second region S402 surrounded by the isotemperature line W402 and the isanomal V402 passing through the point B4, the isanomal V401 passing through the point C4 (0.418, 0.390), the isotemperature line W403 passing through the point D4 (0.397, 0.370), and a straight line connecting point C4 and point D4. Operations for increasing and decreasing the quantity of the lighting light in the first lighting mode and the second lighting mode can be performed through use of the brightening part 55c and the dimming part 55d of the cross key 55.

Sleep efficiency can therefore be improved, and accumulated tiredness can be alleviated by the first lighting mode. The capacity for work by a user can also be improved by the second lighting mode.

It is also generally recognized that fluorescent lamps have a risk of leakage of ultraviolet rays, and that incandescent bulbs release large quantities of infrared rays. Ultraviolet rays have adverse chemical effects on organisms, indoor equipment, and the like, and infrared rays can have adverse thermal effects. However, since lighting is performed by light emission from the LED elements 6 including almost no ultraviolet rays or infrared rays, a lighting device 200 having minimal adverse effects on the human body can be provided.

Since a cool-color lighting mode for emitting daylight, neutral white, or white lighting light is also provided, lighting using a conventional lighting color can be performed.

Since a warm-color lighting mode for emitting incandescent-bulb-color or warm white lighting light is also provided, lighting using a conventional lighting color can be performed.

The operating unit 52 has the first lighting mode key 56 (first operating switch) for selecting the first lighting mode, the second lighting mode key 57 (second operating switch) for selecting the second lighting mode, and the cross key 55 (variable switch) for varying the lighting color in stages to a color between the cool-color lighting mode and the warm-color lighting mode. The lighting color can thereby easily be varied to a desired lighting color between cool and warm in accordance with user preference. The first lighting mode and the second lighting mode can also easily be selected and sleep efficiency or working capacity improved in accordance with the state of the user.

The switch for switching to the first lighting mode and the second lighting mode is also explicitly configured as only the first lighting mode key 56 and the second lighting mode key 57. The lighting colors that can be anticipated to have the most significant effects in each of the first region S401 and the second region S402 are also set as initial values (registered in advance as initial values in the memory 12) for the first lighting mode key 56 and the second lighting mode key 57, respectively. The user can thereby easily and quickly select the suitable first-mode or second-mode lighting color.

A brightness (quantity of lighting light) that is suitable according to each lighting color may be set as an initial value (registered in advance as an initial value in the memory 12) for the first lighting mode key 56 and the second lighting mode key 57. The user can thereby easily and quickly select the brightness as well when using the first lighting mode or the second lighting mode. Consequently, convenience to the user can be further improved, and the effect of the lighting color can be more suitably obtained.

By thus enabling key operations to be performed easily and quickly, any nuisance or stress brought about by key operation as such can be avoided as much as possible. Consequently, there is no impediment to the effects on sleep anticipated from the first lighting mode or the effects on work anticipated from the second lighting mode.

Since the present embodiment has white LED elements 6a, incandescent-bulb-color LED elements 6b, and red LED elements 6c for emitting light having different colors, lighting light having the lighting color of the first lighting mode, the second lighting mode, the cool-color lighting mode, or the warm-color lighting mode can easily be emitted.

### Eighth Embodiment

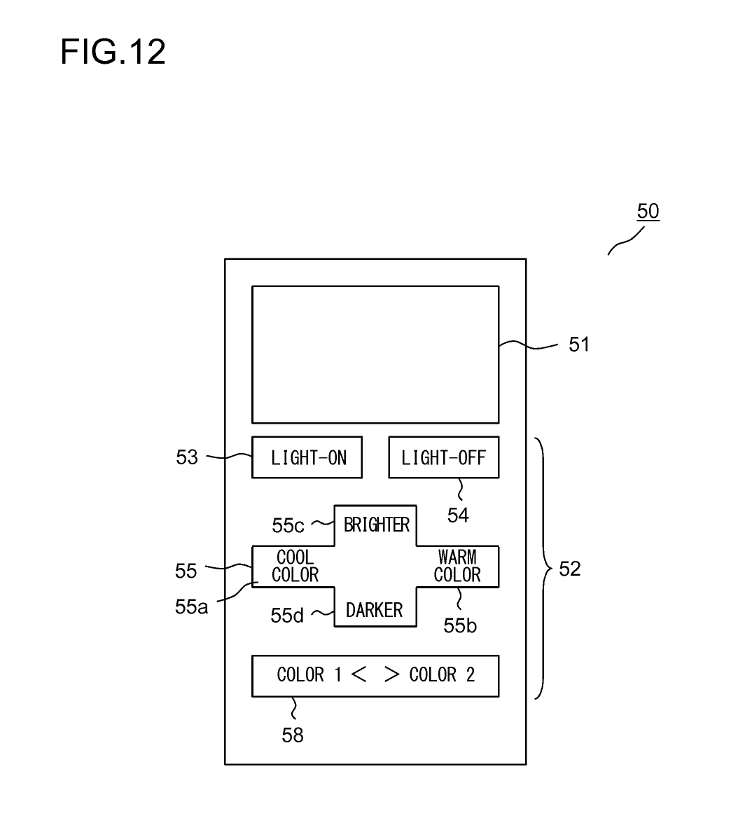

A lighting device according to an eighth embodiment of the present invention will next be described. FIG. 12 is a front view showing the remote controller 50 of the lighting device according to the eighth embodiment. Since the basic configuration of this embodiment is the same as that of the seventh embodiment previously described using FIGS. 10 and 11, constituent elements thereof that are common to the seventh embodiment are referred to by the same reference numerals as previously used, and drawings and descriptions thereof are omitted. In the lighting device 200 of the present embodiment, the lighting color can be varied within the first region S401 and second region S402 continuous on the xy chromaticity diagram. The remainder of the present embodiment is the same as the fourth embodiment.

As shown in FIG. 12, the remote controller 50 is provided with a variable key 58 (first variable switch) for varying the lighting color to a color within the first region S401 and the second region S402. By operation of the variable key 58, the lighting color is varied in stages from the lighting color of the first region S401 to the lighting color of the second region S402, and the first lighting mode and the second lighting mode are performed. Labels other than “Color 1” and “Color 2” may also be written on the variable key 58, the same as described above.

By operation of the cross key 55 (second variable switch) in the same manner as described above, the lighting color is varied in stages between the lighting color of the cool-color lighting mode and the lighting color of the warm-color lighting mode.

According to the present embodiment, since the variable key 58 (first variable switch) for varying the lighting color within the first region S401 and the second region S402 is provided, the lighting color can easily be varied between the first lighting mode and the second lighting mode in accordance with the state and preference of a user.

Here, the range of variation of the lighting color by the variable key 58 is limited to the range of the first region S401 and the second region S402. It is thereby possible to prevent selection of a lighting color that is outside the range of lighting colors included by the first region S401 or second region S402 accompanying variable operation. The effects on sleep anticipated from the first lighting mode or the effects on work anticipated from the second lighting mode can therefore be obtained. When the first region S401 and the second region S402 are not continuous, as in the present embodiment, the same effects can be obtained even when the lighting color is changed in stages so as to jump between the first region S401 and the second region S402 within a range limited thereby.

### Ninth Embodiment

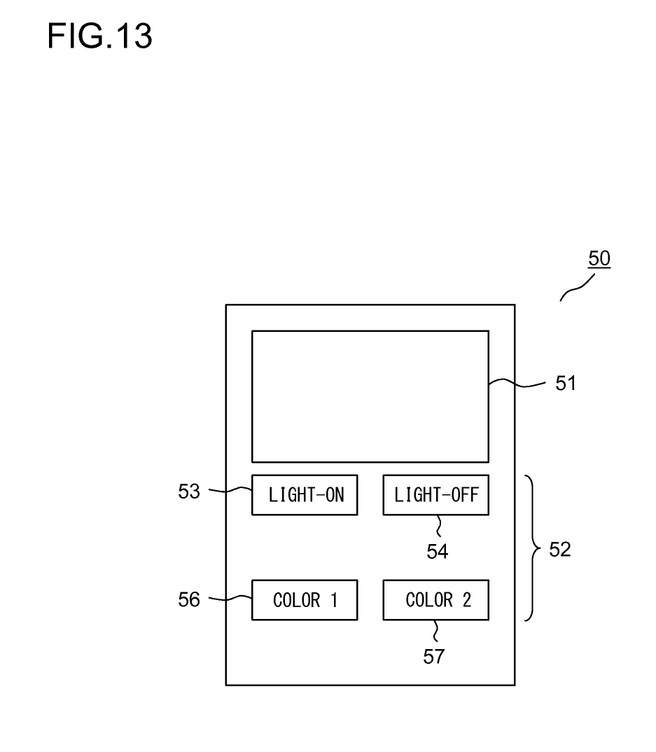

A lighting device according to a ninth embodiment of the present invention will next be described. FIG. 13 is a front view showing the remote controller 50 of the lighting device according to the ninth embodiment. Since the basic configuration of this embodiment is the same as that of the seventh embodiment previously described using FIGS. 10 and 11, constituent elements thereof that are common to the seventh embodiment are referred to by the same reference numerals as previously used, and drawings and descriptions thereof are omitted. In the lighting device 200 of the present embodiment, the cool-color lighting mode and the warm-color lighting mode of the fourth embodiment are omitted, and only the first lighting mode and the second lighting mode are provided. The remainder of the present embodiment is the same as the fourth embodiment.

As shown in FIG. 13, the cross key 55 (see FIG. 11) is omitted from the remote controller 50, and the light-on key 53, the light-off key 54, the first lighting mode key 56, and the second lighting mode key 57 are provided.

Lighting according to the first lighting mode is performed by operation of the first lighting mode key 56 (first operating switch). Lighting according to the second lighting mode is performed by operation of the second lighting mode key 57 (second operating switch). Labels other than “Color 1” on the first lighting mode key 56 and “Color 2” on the second lighting mode key 57 may also be used, the same as described above.

According to the present embodiment, since only the first lighting mode and second lighting mode having different lighting colors are provided, a user can select the lighting color of the first lighting mode or the lighting color of the second lighting mode by a simple operation.

The switch for switching to the first lighting mode and the second lighting mode is also explicitly configured as only the first lighting mode key 56 and the second lighting mode key 57. The lighting colors that can be anticipated to have the most significant effects in each of the first region S401 and the second region S402 are also set as initial values (registered in advance as initial values in the memory 12) for the first lighting mode key 56 and the second lighting mode key 57, respectively. The user can thereby easily and quickly select the suitable first-mode or second-mode lighting color.

A brightness (quantity of lighting light) that is suitable according to each lighting color may be set as an initial value (registered in advance as an initial value in the memory 12) for the first lighting mode key 56 and the second lighting mode key 57. The user can thereby easily and quickly select the brightness as well when using the first lighting mode or the second lighting mode. Consequently, convenience to the user can be further improved, and the effect of the lighting color can be more suitably obtained.

By thus enabling key operations to be performed easily and quickly, any nuisance or stress brought about by key operation as such can be avoided as much as possible. Consequently, there is no impediment to the effects on sleep anticipated from the first lighting mode or the effects on work anticipated from the second lighting mode.

The lighting color may also be made variable within the first region S401 and second region S402 continuous on the xy chromaticity diagram, and the variable key 58 (see FIG. 12) for varying the lighting color to a color within the first region S401 and the second region S402 may be provided, in the same manner as in the eight embodiment.

A variable key (not shown) for variably increasing/decreasing the quantity of the lighting light may also be provided. The quantity of the lighting light may also be changed in stages (e.g., changed cyclically as quantity 1→quantity 2→quantity 3→quantity 1) each time the first lighting mode key 56 or the second lighting mode key 57 is pressed. The quantity of the lighting light may also be variably changed in accordance with the amount of time that the first lighting mode key 56 or the second lighting mode key 57 is pressed. In this case, a function for increasing/decreasing the quantity of the lighting light can be provided to the user without providing additional keys.

In the seventh through ninth embodiments, the lighting color of the first lighting mode or the second lighting mode may be toned by LED elements 6 having other light emission colors. For example, a plurality of LED elements for emitting each of blue light, green light, and red light may be provided. LED elements for emitting light having a color in the first region S401 and LED elements for emitting light having a color in the second region S402 may also be provided.

An LED element and a phosphor for converting the emitted light of the LED element to a different wavelength may also be provided. For example, an LED element for emitting blue light may be provided, and phosphors for converting blue to each of incandescent-bulb-color, red, and yellow may be provided. White light may be formed by blue light and yellow light, and the lighting color of the first lighting mode or the second lighting mode may be toned by white, incandescent-bulb-color, and red light in the same manner as described above.

A lighting fixture attached in a living room is configured from the lighting device 200, but the lighting device may also constitute a light bulb or the like attached to a lighting fixture.

Examples and comparative examples will next be described in which the color of the lighting light is made variable in order to evaluate the lighting light of the lighting device 100 according to the first embodiment. Table 1 shows the specifications of the lighting light for each example and comparative example.

TABLE 1

| | | | | | Range | Ratio of |
|---|---|---|---|---|---|---|
| | | | | | including | spectrum |
| | | | | | maximum | at 550 nm |
| | Area of spectrum (relative to 400-800 nm area) | | | | value | to maximum |
| | 400-500 | 500-600 | 600-700 | 700-800 | of | spectrum at |
| | nm | nm | nm | nm | spectrum | 600-700 nm |
| | % | % | % | % | nm | % |
| Example 1 | 3 | 18 | 42 | 37 | 600-700 | 38 |
| Example 2 | 7 | 29 | 57 | 7 | 600-700 | 16 |
| Example 3 | 18 | 41 | 35 | 6 | 600-700 | 38 |
| Example 4 | 9 | 36 | 50 | 5 | 600-700 | 31 |
| Comparative | 18 | 40 | 25 | 17 | 600-700 | 68 |
| Example 1 | | | | | | |
| Comparative | 4 | 18 | 75 | 3 | 600-700 | 15 |
| Example 2 | | | | | | |
| Comparative | 3 | 13 | 50 | 34 | 600-700 | 10 |
| Example 3 | | | | | | |
| Comparative | 4 | 47 | 48 | 1 | 600-700 | 63 |
| Example 4 | | | | | | |
| Comparative | 22 | 20 | 56 | 2 | 600-700 | 55 |
| Example 5 | | | | | | |
| Comparative | 18 | 12 | 31 | 39 | 700-800 | 28 |
| Example 6 | | | | | | |
| Comparative | 11 | 43 | 41 | 5 | 600-700 | 65 |
| Example 7 | | | | | | |
| Comparative | 13 | 42 | 41 | 4 | 600-700 | 63 |
| Example 8 | | | | | | |
| Neutral white | 24 | 47 | 24 | 5 | 400-500 | 125 |

### Example 1

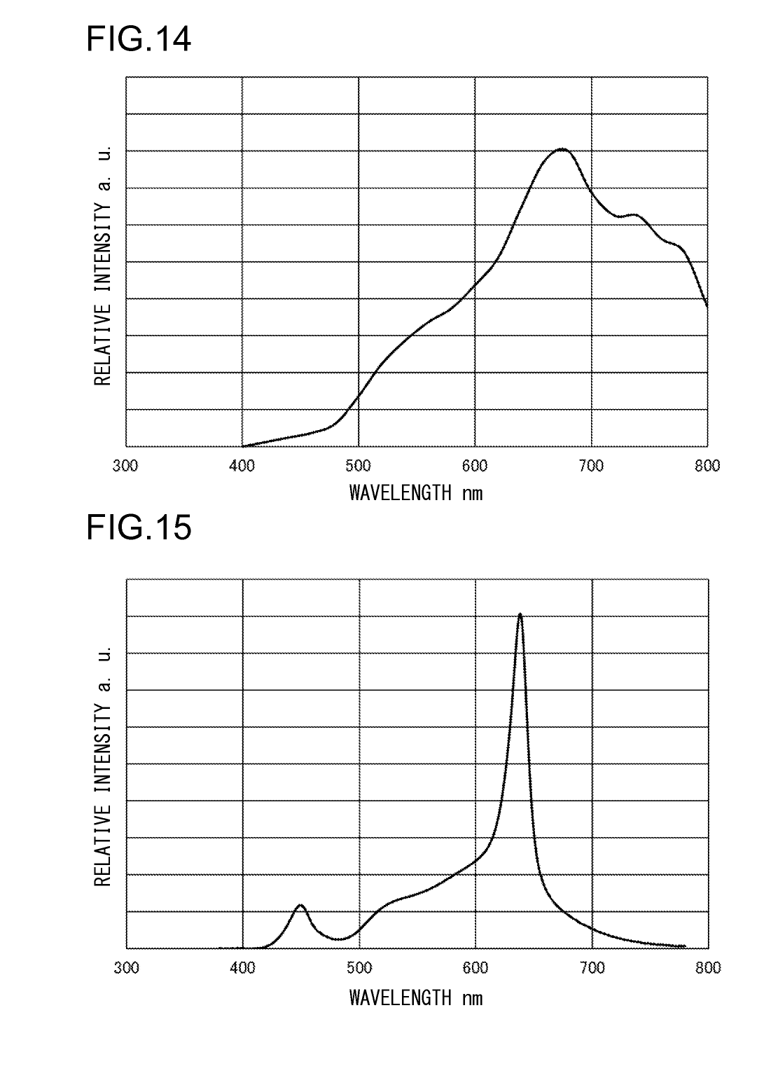

FIG. 14 shows the spectrum of the lighting light of the lighting device 100 according to Example 1. In FIG. 14, the vertical axis indicates the relative intensity, and the horizontal axis indicates the wavelength (units: nm). In the spectrum of this lighting light, the ratio of the area having a wavelength from 400 nm to 500 nm is 3%, the ratio of the area having a wavelength of 500 nm to 600 nm is 18%, the ratio of the area having a wavelength of 600 nm to 700 nm is 42%, and the ratio of the area having a wavelength of 700 nm to 800 nm is 37% with respect to the area having a wavelength of 400 nm to 800 nm.

The maximum value of the spectrum is included in the wavelength range of 600 nm to 700 nm. The value of the spectrum at a wavelength of 550 nm is 38% of the maximum value of the spectrum in the wavelength range of 600 nm to 700 nm.

### Example 2

FIG. 15 shows the spectrum of the lighting light of the lighting device 100 according to Example 2. In FIG. 15, the vertical axis indicates the relative intensity, and the horizontal axis indicates the wavelength (units: nm). In the spectrum of this lighting light, the ratio of the area having a wavelength from 400 nm to 500 nm is 7%, the ratio of the area having a wavelength of 500 nm to 600 nm is 29%, the ratio of the area having a wavelength of 600 nm to 700 nm is 57%, and the ratio of the area having a wavelength of 700 nm to 800 nm is 7% with respect to the area having a wavelength of 400 nm to 800 nm.

The maximum value of the spectrum is included in the wavelength range of 600 nm to 700 nm. The value of the spectrum at a wavelength of 550 nm is 16% of the maximum value of the spectrum in the wavelength range of 600 nm to 700 nm.

### Example 3

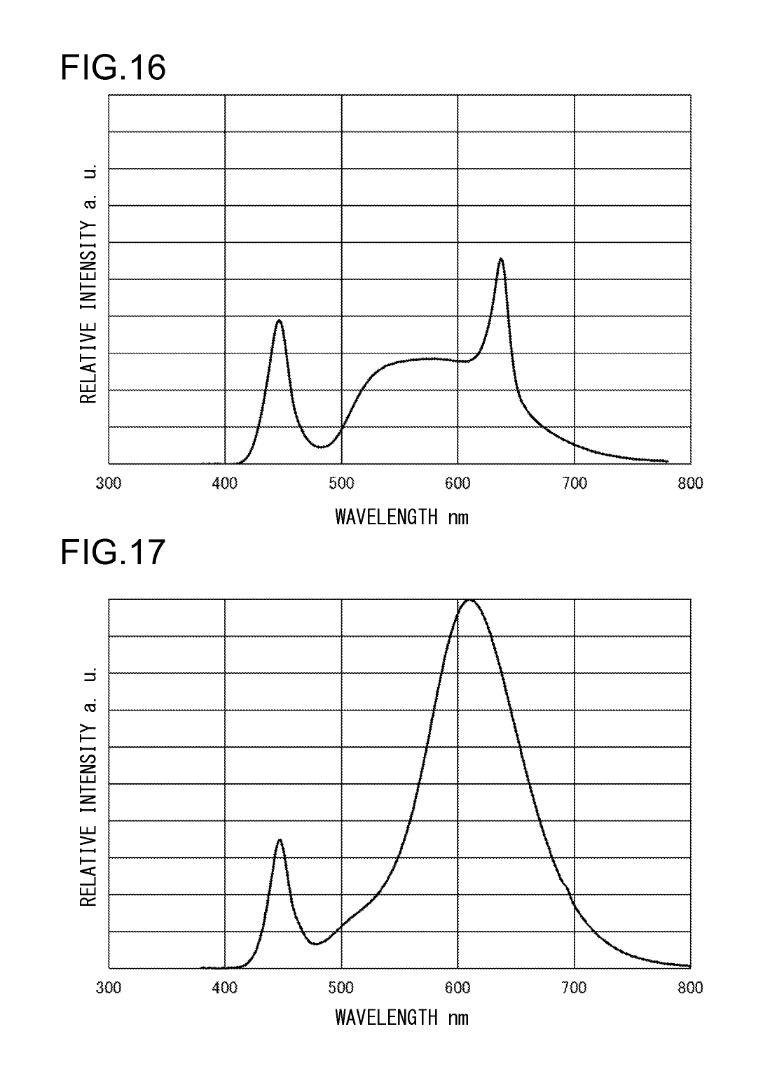

FIG. 16 shows the spectrum of the lighting light of the lighting device 100 according to Example 3. In FIG. 16, the vertical axis indicates the relative intensity, and the horizontal axis indicates the wavelength (units: nm). In the spectrum of this lighting light, the ratio of the area having a wavelength from 400 nm to 500 nm is 18%, the ratio of the area having a wavelength of 500 nm to 600 nm is 41%, the ratio of the area having a wavelength of 600 nm to 700 nm is 35%, and the ratio of the area having a wavelength of 700 nm to 800 nm is 6% with respect to the area having a wavelength of 400 nm to 800 nm.

The maximum value of the spectrum is included in the wavelength range of 600 nm to 700 nm. The value of the spectrum at a wavelength of 550 nm is 38% of the maximum value of the spectrum in the wavelength range of 600 nm to 700 nm.

### Example 4

FIG. 17 shows the spectrum of the lighting light of the lighting device 100 according to Example 4. In FIG. 17, the vertical axis indicates the relative intensity, and the horizontal axis indicates the wavelength (units: nm). In the spectrum of this lighting light, the ratio of the area having a wavelength from 400 nm to 500 nm is 9%, the ratio of the area having a wavelength of 500 nm to 600 nm is 36%, the ratio of the area having a wavelength of 600 nm to 700 nm is 50%, and the ratio of the area having a wavelength of 700 nm to 800 nm is 5% with respect to the area having a wavelength of 400 nm to 800 nm.

The maximum value of the spectrum is included in the wavelength range of 600 nm to 700 nm. The value of the spectrum at a wavelength of 550 nm is 31% of the maximum value of the spectrum in the wavelength range of 600 nm to 700 nm.

### Comparative Example 1

In the spectrum of the lighting light of the lighting device 100 according to Comparative Example 1 for comparison with Examples 1 through 4, the ratio of the area having a wavelength from 400 nm to 500 nm is 18%, the ratio of the area having a wavelength of 500 nm to 600 nm is 40%, the ratio of the area having a wavelength of 600 nm to 700 nm is 25%, and the ratio of the area having a wavelength of 700 nm to 800 nm is 17% with respect to the area having a wavelength of 400 nm to 800 nm.

The maximum value of the spectrum is included in the wavelength range of 600 nm to 700 nm. The value of the spectrum at a wavelength of 550 nm is 68% of the maximum value of the spectrum in the wavelength range of 600 nm to 700 nm.

### Comparative Example 2

In the spectrum of the lighting light of the lighting device 100 according to Comparative Example 2, the ratio of the area having a wavelength from 400 nm to 500 nm is 4%, the ratio of the area having a wavelength of 500 nm to 600 nm is 18%, the ratio of the area having a wavelength of 600 nm to 700 nm is 75%, and the ratio of the area having a wavelength of 700 nm to 800 nm is 3% with respect to the area having a wavelength of 400 nm to 800 nm.

The maximum value of the spectrum is included in the wavelength range of 600 nm to 700 nm. The value of the spectrum at a wavelength of 550 nm is 15% of the maximum value of the spectrum in the wavelength range of 600 nm to 700 nm.

### Comparative Example 3

In the spectrum of the lighting light of the lighting device 100 according to Comparative Example 3, the ratio of the area having a wavelength from 400 nm to 500 nm is 3%, the ratio of the area having a wavelength of 500 nm to 600 nm is 13%, the ratio of the area having a wavelength of 600 nm to 700 nm is 50%, and the ratio of the area having a wavelength of 700 nm to 800 nm is 34% with respect to the area having a wavelength of 400 nm to 800 nm.

The maximum value of the spectrum is included in the wavelength range of 600 nm to 700 nm. The value of the spectrum at a wavelength of 550 nm is 10% of the maximum value of the spectrum in the wavelength range of 600 nm to 700 nm.

### Comparative Example 4

In the spectrum of the lighting light of the lighting device 100 according to Comparative Example 4, the ratio of the area having a wavelength from 400 nm to 500 nm is 4%, the ratio of the area having a wavelength of 500 nm to 600 nm is 47%, the ratio of the area having a wavelength of 600 nm to 700 nm is 48%, and the ratio of the area having a wavelength of 700 nm to 800 nm is 1% with respect to the area having a wavelength of 400 nm to 800 nm.

The maximum value of the spectrum is included in the wavelength range of 600 nm to 700 nm. The value of the spectrum at a wavelength of 550 nm is 63% of the maximum value of the spectrum in the wavelength range of 600 nm to 700 nm.

### Comparative Example 5

In the spectrum of the lighting light of the lighting device 100 according to Comparative Example 5, the ratio of the area having a wavelength from 400 nm to 500 nm is 22%, the ratio of the area having a wavelength of 500 nm to 600 nm is 20%, the ratio of the area having a wavelength of 600 nm to 700 nm is 56%, and the ratio of the area having a wavelength of 700 nm to 800 nm is 2% with respect to the area having a wavelength of 400 nm to 800 nm.

The maximum value of the spectrum is included in the wavelength range of 600 nm to 700 nm. The value of the spectrum at a wavelength of 550 nm is 55% of the maximum value of the spectrum in the wavelength range of 600 nm to 700 nm.

### Comparative Example 6

In the spectrum of the lighting light of the lighting device 100 according to Comparative Example 6, the ratio of the area having a wavelength from 400 nm to 500 nm is 18%, the ratio of the area having a wavelength of 500 nm to 600 nm is 12%, the ratio of the area having a wavelength of 600 nm to 700 nm is 31%, and the ratio of the area having a wavelength of 700 nm to 800 nm is 39% with respect to the area having a wavelength of 400 nm to 800 nm.

The maximum value of the spectrum is included in the wavelength range of 700 nm to 800 nm. The value of the spectrum at a wavelength of 550 nm is 28% of the maximum value of the spectrum in the wavelength range of 600 nm to 700 nm.

### Comparative Example 7

In the spectrum of the lighting light of the lighting device 100 according to Comparative Example 7, the ratio of the area having a wavelength from 400 nm to 500 nm is 11%, the ratio of the area having a wavelength of 500 nm to 600 nm is 43%, the ratio of the area having a wavelength of 600 nm to 700 nm is 41%, and the ratio of the area having a wavelength of 700 nm to 800 nm is 5% with respect to the area having a wavelength of 400 nm to 800 nm.

The maximum value of the spectrum is included in the wavelength range of 600 nm to 700 nm. The value of the spectrum at a wavelength of 550 nm is 65% of the maximum value of the spectrum in the wavelength range of 600 nm to 700 nm.

### Comparative Example 8

The color of the lighting light of the lighting device 100 of Comparative Example 8 is incandescent-bulb color, in the spectrum of the lighting light of the lighting device 100 according to Comparative Example 8, the ratio of the area having a wavelength from 400 nm to 500 nm is 13%, the ratio of the area having a wavelength of 500 nm to 600 nm is 42%, the ratio of the area having a wavelength of 600 nm to 700 nm is 41%, and the ratio of the area having a wavelength of 700 nm to 800 nm is 4% with respect to the area having a wavelength of 400 nm to 800 nm.

The maximum value of the spectrum is included in the wavelength range of 600 nm to 700 nm. The value of the spectrum at a wavelength of 550 nm is 63% of the maximum value of the spectrum in the wavelength range of 600 nm to 700 nm.

The colors “neutral white” and “incandescent-bulb-color” correspond to light source colors specified by the JIS standard (JIS Z 8110).

The experiment described below was performed for comparing neutral white lighting light with Examples 1 through 4 and Comparative Examples 1 through 8 described above. In the neutral white spectrum, the ratio of the area having a wavelength from 400 nm to 500 nm is 24%, the ratio of the area having a wavelength of 500 nm to 600 nm is 47%, the ratio of the area having a wavelength of 600 nm to 700 nm is 24%, and the ratio of the area having a wavelength of 700 nm to 800 nm is 5% with respect to the area having a wavelength of 400 nm to 800 nm.

The maximum value of the neutral white spectrum is included in the wavelength range of 400 nm to 500 nm. The value of the spectrum at a wavelength of 550 nm is 125% of the maximum value of the spectrum in the wavelength range of 600 nm to 700 nm.

A total of 32 healthy individuals, sixteen male and sixteen female, from age 20 to age 65 were chosen as test subjects. In a first experiment, a test subject for each room was caused to stand by in the daytime, the environment state was made the same for all test subjects, and each lighting light was radiated for 30 minutes of work time. The arrangement and number of lighting devices 100 installed over a desk for performing work were adjusted so that the illuminance of the lighting light was equivalent to a 100 W ceiling light (approximately 600 lx). The results were compared with an evaluation in a case in which neutral white light was radiated in the same manner at an illuminance equivalent to 100 W.

The Kraepelin test was used as a work load. The content of the test is a computational work load in which simple one-digit additions are performed for a total of 30 minutes while changing rows every minute. The Kraepelin test in this experiment was performed using a personal computer (referred to hereinafter as a “PC”). Answers to problems displayed on a PC screen were inputted by the test subjects by operating a key on the PC. The answer content and time taken to input an answer during work were sequentially accumulated as data in the PC, and the number of trials, the correct answer rate, and the average response time (the time from displaying of the problem until inputting of an answer) were obtained as test results by analyzing the data after the testing.

TABLE 2

| Evaluation Item | Evaluation Content | Evaluation Method |
|---|---|---|
| 1 | Comfort | Subjective evaluation |
| 2 | Motivation | Subjective evaluation |
| 3 | Tiredness | Subjective evaluation |
| 4 | Drowsiness | Subjective evaluation |
| 5 | Sense of fulfillment | Subjective evaluation |
| 6 | Relaxation | Subjective evaluation |
| 7 | Feeling of irritation | Subjective evaluation |
| 8 | Feeling of warmth | Subjective evaluation |
| 9 | Autonomic nervous | Pulse wave frequency analysis |
| | system evaluation | |
| 10 | Working capacity | Counting number of trials |
| 11 | Working capacity | Correct answer rate |
| 12 | Working capacity | Average response time |

Table 2 shows the items evaluated by the first experiment. Subjective evaluation during work (evaluation items 1 through 8), autonomic nervous system evaluation (evaluation items 9), and working capacity (evaluation items 10 through 12) were provided as evaluation items.

The Visual Analogue Scale (VAS) for evaluating sensory/emotional intensity was used for the subjective evaluation during work. In this evaluation method, the test subject marks a point corresponding to a sensory/emotional strength relating to a question item at the time in question on a single straight line, one end of which represents the worst sensation and the other end represents the best sensation, and by measuring the length from the position of the mark to one end, a subjective sensation is quantified, and a score is evaluated.

The following eight question items were used: “comfort (evaluation item 1),” “motivation (evaluation item 2),” “tiredness (evaluation item 3),” “drowsiness (evaluation item 4),” “sense of fulfillment (evaluation item 5),” “feeling of relaxation (evaluation item 6),” “feeling of irritation (evaluation item 7),” and “feeling of warmth (evaluation item 8).”

The acceleration plethysmography system “Artett C (registered trademark)” manufactured by U-medica Inc. was used to evaluate the autonomic nervous system (evaluation item 9). An acceleration plethysmogram during, before, and after work was measured by the acceleration plethysmography system, and frequency analysis of the time change data thereof was performed. The autonomic nervous function indicators LF, HF, and LF/HF were thereby calculated, and the state of the autonomic nervous system was evaluated.

Working capacity was evaluated by the number of trials (evaluation item 10), correct answer rate (evaluation item 11), and average response time (evaluation item 12) for the 30-minute work load described above.

Table 3 shows the results of the first experiment for Examples 1 through 4 and Comparative Examples 1 through 8. The results were evaluated by statistically analyzing results for all test subjects and testing for significance between each lighting light and neutral white. A t-test was used as the test method, and cases in which there was a significant difference in improvement for a significance level of 5% are indicated by the symbol “◯.” A tendency toward improvement was evaluated as being present for p-values of less than 10%, and such cases are indicated by the symbol “Δ.” Cases in which there was no significant difference in improvement or tendency toward improvement are indicated by the symbol “x.”

TABLE 3

| Evaluation Item | 1 | 2 | 3 | 4 | 5 | 6 | 7 | 8 | 9 | 10 | 11 | 12 |
|---|---|---|---|---|---|---|---|---|---|---|---|---|
| Example 1 | ∘ | Δ | ∘ | x | ∘ | ∘ | x | ∘ | ∘ | Δ | Δ | Δ |
| Example 2 | ∘ | ∘ | ∘ | x | ∘ | ∘ | x | ∘ | ∘ | x | Δ | Δ |
| Example 3 | ∘ | ∘ | ∘ | x | Δ | ∘ | Δ | x | ∘ | ∘ | ∘ | ∘ |
| Example 4 | ∘ | ∘ | ∘ | x | ∘ | ∘ | x | Δ | ∘ | ∘ | ∘ | ∘ |
| Comparative | x | x | x | x | x | x | x | x | x | x | x | x |
| Example 1 | | | | | | | | | | | | |
| Comparative | x | x | x | x | x | x | x | x | x | x | x | x |
| Example 2 | | | | | | | | | | | | |
| Comparative | x | x | x | x | x | x | x | x | x | x | x | x |
| Example 3 | | | | | | | | | | | | |
| Comparative | x | x | x | x | x | x | x | x | x | x | x | x |
| Example 4 | | | | | | | | | | | | |
| Comparative | x | x | x | x | x | x | x | x | x | x | x | x |
| Example 5 | | | | | | | | | | | | |
| Comparative | x | x | x | x | x | x | x | x | x | x | x | x |
| Example 6 | | | | | | | | | | | | |
| Comparative | x | x | x | x | x | x | x | x | x | x | x | x |
| Example 7 | | | | | | | | | | | | |
| Comparative | x | x | x | x | x | x | x | ∘ | x | x | x | x |
| Example 8 | | | | | | | | | | | | |

∘: Significant difference is present;
Δ: Tendency is present;
x: No significant difference or tendency is present

According to the results of the first experiment, the lighting light of Examples 1 through 4 produced significant results relative to neutral white in the subjective evaluation during work and the autonomic nervous system evaluation. Specifically, comfort or feeling of relaxation of the user during work can be improved.

Regarding working capacity, there was a tendency toward improvement in Examples 1, 3, and 4 for number of trials. There was improvement or a tendency toward improvement in Examples 1 through 4 for correct answer rate. There was improvement or a tendency toward improvement in Examples 1 through 4 for average response time.

In contrast, Comparative Example 1 had a spectrum in which the ratio of the area having a wavelength from 600 nm to 700 nm was less than 30% with respect to the area having a wavelength of 400 nm to 800 nm, and no significant difference or tendency relative to neutral white was observed. Comparative Example 2 had a spectrum in which the ratio of the area having a wavelength from 600 nm to 700 nm was greater than 70% with respect to the area having a wavelength of 400 nm to 800 nm, and no significant difference or tendency relative to neutral white was observed.

Comparative Example 3 had a spectrum in which the ratio of the area having a wavelength from 500 nm to 600 nm was less than 15% with respect to the area having a wavelength of 400 nm to 800 nm, and no significant difference or tendency relative to neutral white was observed. Comparative Example 4 had a spectrum in which the ratio of the area having a wavelength from 500 nm to 600 nm was greater than 45% with respect to the area having a wavelength of 400 nm to 800 nm, and no significant difference or tendency relative to neutral white was observed.

Comparative Example 5 had a spectrum in which the ratio of the area having a wavelength from 400 nm to 500 nm was greater than 10% with respect to the area having a wavelength of 400 nm to 800 nm, and no significant difference or tendency relative to neutral white was observed. In Comparative Example 6, the maximum value of the spectrum was included in the range from 700 nm to 800 nm, and no significant difference or tendency relative to neutral white was observed.

In Comparative Examples 7 and 8, the ratio of the value of the spectrum at a wavelength of 550 nm with respect to the maximum value of the spectrum in the range from 600 nm to 700 nm was greater than 50%. No significant difference or tendency relative to neutral white was observed in Comparative Example 7. In Comparative Example 8 using incandescent-bulb color, a significant difference was observed in a subjective evaluation (feeling of warmth) relative to neutral white, but no significant difference or tendency was observed in other evaluation items.

The evaluation results described above are for the lighting device 100 according to the first embodiment, but it is apparent that the same evaluation results are obtained also for the lighting device 200 according to the second embodiment.

Examples and comparative examples will next be described in which the color of the lighting light is made variable in order to evaluate the lighting light of the lighting device 200 according to the third embodiment. Table 4 shows the specifications of the lighting light for each example and comparative example.

TABLE 4

| | | | | | Range | Ratio of |
|---|---|---|---|---|---|---|
| | | | | | including | maximum |
| | | | | | maximum | value of |
| | Area of spectrum (relative to 400-800 nm area) | | | | value | spectrum at |
| | 400-500 | 500-600 | 600-700 | 700-800 | of | 550-600 nm to |
| | nm | nm | nm | nm | spectrum | 600-700 nm |
| | % | % | % | % | nm | % |
| Example 5 | 3 | 18 | 42 | 37 | 600-700 | 50 |
| Example 6 | 7 | 29 | 57 | 7 | 600-700 | 28 |
| Example 7 | 18 | 41 | 35 | 6 | 600-700 | 42 |
| Example 8 | 19 | 44 | 31 | 6 | 600-700 | 66 |
| Comparative | 18 | 40 | 25 | 17 | 600-700 | 68 |
| Example 9 | | | | | | |
| Comparative | 4 | 18 | 75 | 3 | 600-700 | 24 |
| Example 10 | | | | | | |
| Comparative | 3 | 13 | 50 | 34 | 600-700 | 16 |
| Example 11 | | | | | | |
| Comparative | 4 | 47 | 48 | 1 | 600-700 | 65 |
| Example 12 | | | | | | |
| Comparative | 22 | 20 | 56 | 2 | 600-700 | 60 |
| Example 13 | | | | | | |
| Comparative | 18 | 12 | 31 | 39 | 700-800 | 45 |
| Example 14 | | | | | | |
| Comparative | 17 | 40 | 34 | 9 | 600-700 | 75 |
| Example 15 | | | | | | |
| Comparative | 13 | 42 | 41 | 4 | 600-700 | 98 |
| Example 16 | | | | | | |
| Neutral white | 24 | 47 | 24 | 5 | 400-500 | 125 |

### Example 5

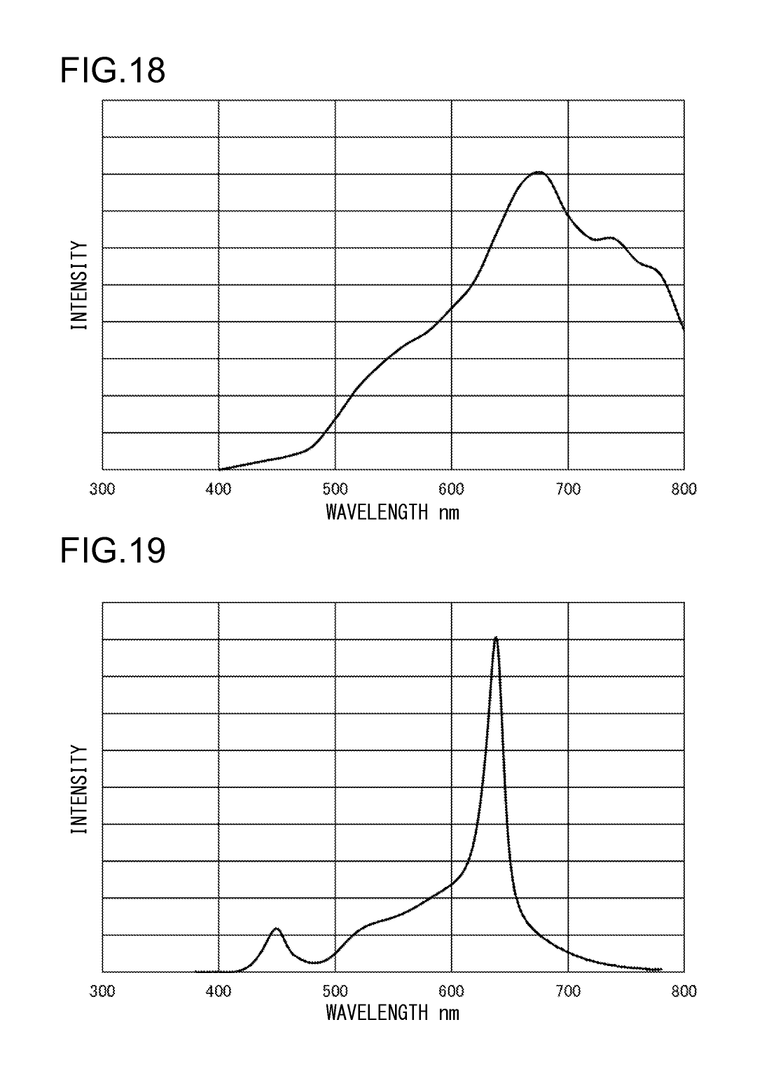

FIG. 18 shows the spectrum of the lighting light of the lighting device 200 according to Example 5. In FIG. 18, the vertical axis indicates the intensity, and the horizontal axis indicates the wavelength (units: nm). In the spectrum of this lighting light, the ratio of the area having a wavelength from 400 nm to 500 nm is 3%, the ratio of the area having a wavelength of 500 nm to 600 nm is 18%, the ratio of the area having a wavelength of 600 nm to 700 nm is 42%, and the ratio of the area having a wavelength of 700 nm to 800 nm is 37% with respect to the area having a wavelength of 400 nm to 800 nm.

The maximum value of the spectrum is included in the wavelength range of 600 nm to 700 nm. The maximum value of the spectrum in the wavelength range of 500 nm to 600 nm is 50% of the maximum value of the spectrum in the wavelength range of 600 nm to 700 nm.

### Example 6

FIG. 19 shows the spectrum of the lighting light of the lighting device 200 according to Example 6. In FIG. 19, the vertical axis indicates the intensity, and the horizontal axis indicates the wavelength (units: nm). In the spectrum of this lighting light, the ratio of the area having a wavelength from 400 nm to 500 nm is 7%, the ratio of the area having a wavelength of 500 nm to 600 nm is 29%, the ratio of the area having a wavelength of 600 nm to 700 nm is 57%, and the ratio of the area having a wavelength of 700 nm to 800 nm is 7% with respect to the area having a wavelength of 400 nm to 800 nm.

The maximum value of the spectrum is included in the wavelength range of 600 nm to 700 nm. The maximum value of the spectrum in the wavelength range of 500 nm to 600 nm is 28% of the maximum value of the spectrum in the wavelength range of 600 nm to 700 nm.

### Example 7

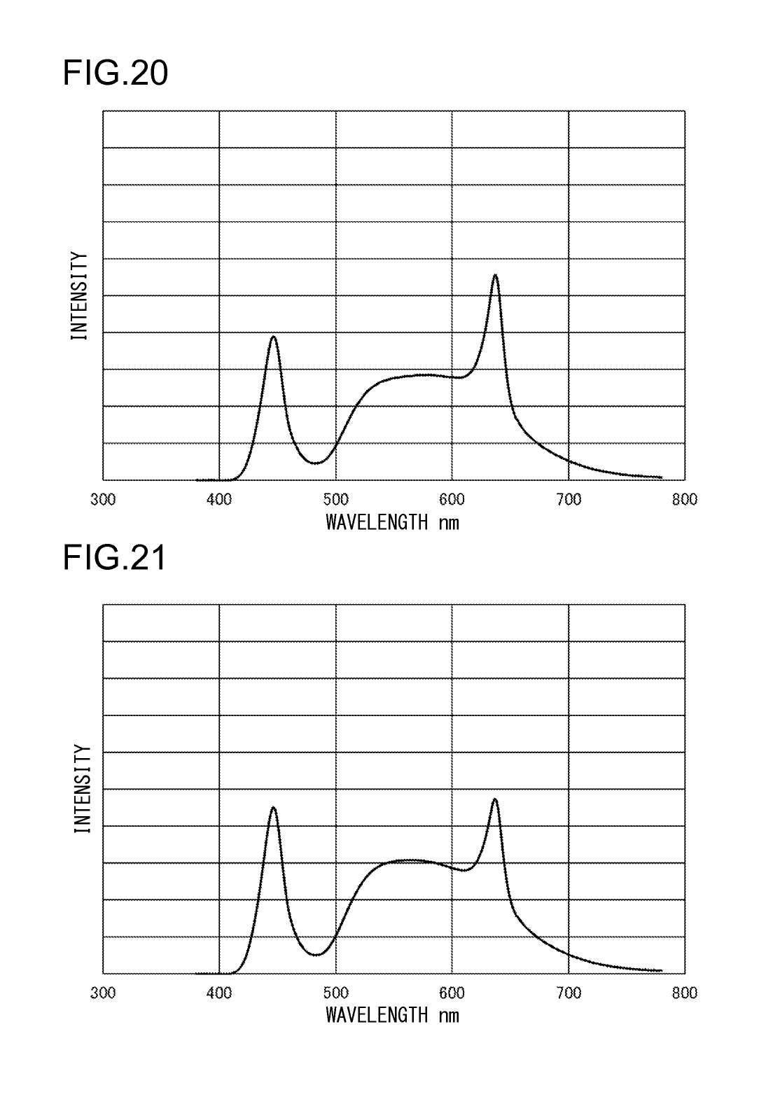

FIG. 20 shows the spectrum of the lighting light of the lighting device 200 according to Example 7. In FIG. 20, the vertical axis indicates the intensity, and the horizontal axis indicates the wavelength (units: nm). In the spectrum of this lighting light, the ratio of the area having a wavelength from 400 nm to 500 nm is 18%, the ratio of the area having a wavelength of 500 nm to 600 nm is 41%, the ratio of the area having a wavelength of 600 nm to 700 nm is 35%, and the ratio of the area having a wavelength of 700 nm to 800 nm is 6% with respect to the area having a wavelength of 400 nm to 800 nm.

The maximum value of the spectrum is included in the wavelength range of 600 nm to 700 nm. The maximum value of the spectrum in the wavelength range of 500 nm to 600 nm is 42% of the maximum value of the spectrum in the wavelength range of 600 nm to 700 nm.

### Example 8

FIG. 21 shows the spectrum of the lighting light of the lighting device 200 according to Example 8. In FIG. 21, the vertical axis indicates the intensity, and the horizontal axis indicates the wavelength (units: nm). In the spectrum of this lighting light, the ratio of the area having a wavelength from 400 nm to 500 nm is 19%, the ratio of the area having a wavelength of 500 nm to 600 nm is 44%, the ratio of the area having a wavelength of 600 nm to 700 nm is 31%, and the ratio of the area having a wavelength of 700 nm to 800 nm is 6% with respect to the area having a wavelength of 400 nm to 800 nm.

The maximum value of the spectrum is included in the wavelength range of 600 nm to 700 nm. The maximum value of the spectrum in the wavelength range of 500 nm to 600 nm is 66% of the maximum value of the spectrum in the wavelength range of 600 nm to 700 nm.

### Comparative Example 9

In the spectrum of the lighting light of the lighting device 200 according to Comparative Example 9 for comparison with Examples 5 through 8, the ratio of the area having a wavelength from 400 nm to 500 nm is 18%, the ratio of the area having a wavelength of 500 nm to 600 nm is 40%, the ratio of the area having a wavelength of 600 nm to 700 nm is 25%, and the ratio of the area having a wavelength of 700 nm to 800 nm is 17% with respect to the area having a wavelength of 400 nm to 800 nm.

The maximum value of the spectrum is included in the wavelength range of 600 nm to 700 nm. The maximum value of the spectrum in the wavelength range of 500 nm to 600 nm is 68% of the maximum value of the spectrum in the wavelength range of 600 nm to 700 nm.

### Comparative Example 10

In the spectrum of the lighting light of the lighting device 200 according to Comparative Example 10, the ratio of the area having a wavelength from 400 nm to 500 nm is 4%, the ratio of the area having a wavelength of 500 nm to 600 nm is 18%, the ratio of the area having a wavelength of 600 nm to 700 nm is 75%, and the ratio of the area having a wavelength of 700 nm to 800 nm is 3% with respect to the area having a wavelength of 400 nm to 800 nm.

The maximum value of the spectrum is included in the wavelength range of 600 nm to 700 nm. The maximum value of the spectrum in the wavelength range of 500 nm to 600 nm is 24% of the maximum value of the spectrum in the wavelength range of 600 nm to 700 nm.

### Comparative Example 11

In the spectrum of the lighting light of the lighting device 200 according to Comparative Example 11, the ratio of the area having a wavelength from 400 nm to 500 nm is 3%, the ratio of the area having a wavelength of 500 nm to 600 nm is 13%, the ratio of the area having a wavelength of 600 nm to 700 nm is 50%, and the ratio of the area having a wavelength of 700 nm to 800 nm is 34% with respect to the area having a wavelength of 400 nm to 800 nm.

The maximum value of the spectrum is included in the wavelength range of 600 nm to 700 nm. The maximum value of the spectrum in the wavelength range of 500 nm to 600 nm is 16% of the maximum value of the spectrum in the wavelength range of 600 nm to 700 nm.

### Comparative Example 12

In the spectrum of the lighting light of the lighting device 200 according to Comparative Example 12, the ratio of the area having a wavelength from 400 nm to 500 nm is 4%, the ratio of the area having a wavelength of 500 nm to 600 nm is 47%, the ratio of the area having a wavelength of 600 nm to 700 nm is 48%, and the ratio of the area having a wavelength of 700 nm to 800 nm is 1% with respect to the area having a wavelength of 400 nm to 800 nm.

The maximum value of the spectrum is included in the wavelength range of 600 nm to 700 nm. The maximum value of the spectrum in the wavelength range of 500 nm to 600 nm is 65% of the maximum value of the spectrum in the wavelength range of 600 nm to 700 nm.

### Comparative Example 13

In the spectrum of the lighting light of the lighting device 200 according to Comparative Example 13, the ratio of the area having a wavelength from 400 nm to 500 nm is 22%, the ratio of the area having a wavelength of 500 nm to 600 nm is 20%, the ratio of the area having a wavelength of 600 nm to 700 nm is 56%, and the ratio of the area having a wavelength of 700 nm to 800 nm is 2% with respect to the area having a wavelength of 400 nm to 800 nm.

The maximum value of the spectrum is included in the wavelength range of 600 nm to 700 nm. The maximum value of the spectrum in the wavelength range of 500 nm to 600 nm is 60% of the maximum value of the spectrum in the wavelength range of 600 nm to 700 nm.

### Comparative Example 14

In the spectrum of the lighting light of the lighting device 200 according to Comparative Example 14, the ratio of the area having a wavelength from 400 nm to 500 nm is 18%, the ratio of the area having a wavelength of 500 nm to 600 nm is 12%, the ratio of the area having a wavelength of 600 nm to 700 nm is 31%, and the ratio of the area having a wavelength of 700 nm to 800 nm is 39% with respect to the area having a wavelength of 400 nm to 800 nm.

The maximum value of the spectrum is included in the wavelength range of 700 nm to 800 nm. The maximum value of the spectrum in the wavelength range of 500 nm to 600 nm is 45% of the maximum value of the spectrum in the wavelength range of 600 nm to 700 nm.

### Comparative Example 15

In the spectrum of the lighting light of the lighting device 200 according to Comparative Example 15, the ratio of the area having a wavelength from 400 nm to 500 nm is 17%, the ratio of the area having a wavelength of 500 nm to 600 nm is 40%, the ratio of the area having a wavelength of 600 nm to 700 nm is 34%, and the ratio of the area having a wavelength of 700 nm to 800 nm is 9% with respect to the area having a wavelength of 400 nm to 800 nm.

The maximum value of the spectrum is included in the wavelength range of 600 nm to 700 nm. The maximum value of the spectrum in the wavelength range of 500 nm to 600 nm is 75% of the maximum value of the spectrum in the wavelength range of 600 nm to 700 nm.

### Comparative Example 16

The color of the lighting light of the lighting device 200 of Comparative Example 16 is incandescent-bulb color, in the spectrum of the lighting light of the lighting device 200 according to Comparative Example 16, the ratio of the area having a wavelength from 400 nm to 500 nm is 13%, the ratio of the area having a wavelength of 500 nm to 600 nm is 42%, the ratio of the area having a wavelength of 600 nm to 700 nm is 41%, and the ratio of the area having a wavelength of 700 nm to 800 nm is 4% with respect to the area having a wavelength of 400 nm to 800 nm.

The maximum value of the spectrum is included in the wavelength range of 600 nm to 700 nm. The maximum value of the spectrum in the wavelength range of 500 nm to 600 nm is 98% of the maximum value of the spectrum in the wavelength range of 600 nm to 700 nm.

The colors “neutral white” and “incandescent-bulb-color” correspond to light source colors specified by the JIS standard (JIS Z 8110).

The experiments described below were performed for comparing neutral white lighting light with Examples 5 through 8 and Comparative Examples 9 through 16 described above. In the neutral white spectrum, the ratio of the area having a wavelength from 400 nm to 500 nm is 24%, the ratio of the area having a wavelength of 500 nm to 600 nm is 47%, the ratio of the area having a wavelength of 600 nm to 700 nm is 24%, and the ratio of the area having a wavelength of 700 nm to 800 nm is 5% with respect to the area having a wavelength of 400 nm to 800 nm.

The maximum value of the neutral white spectrum is included in the wavelength range of 400 nm to 500 nm. The maximum value of the spectrum in the wavelength range of 500 nm to 600 nm is 125% of the maximum value of the spectrum in the wavelength range of 600 nm to 700 nm.

A total of 32 healthy individuals, sixteen male and sixteen female, from age 20 to age 65 were chosen as test subjects. In a second experiment, a test subject for each room was caused to stand by from evening to the morning of the next day, the environment state was made the same for all test subjects, and each lighting light was radiated for a period one hour before retiring until bedtime. The illuminance of the lighting light at a pillow position was equivalent to 35 W (approximately 45 lx). Comparison was made with a case in which neutral white light (having a correlated color temperature of 5000 K) was radiated in the same manner at an illuminance equivalent to 35 W (approximately 85 lx).

In a third experiment, a test subject for each room was caused to stand by in the daytime, the environment state was made the same for all test subjects, and each lighting light was radiated for 30 minutes of work time. The illuminance of the lighting light was equivalent to 100 W (approximately 600 lx) over a desk for performing work. The results were compared with an evaluation in a case in which neutral white light was radiated in the same manner at an illuminance equivalent to 100 W.

The “Uchida-Kraepelin Test (registered trademark)” of Nisseiken, Inc. was used as a work load. The content of the test is a computational work load in which simple one-digit additions are performed for a total of 30 minutes while changing rows every minute.

TABLE 5

| Evaluation | | |
|---|---|---|
| Item | Evaluation Content | Evaluation Method |
| 1 | Comfort | Subjective evaluation |
| 2 | Motivation | Subjective evaluation |
| 3 | Tiredness | Subjective evaluation |
| 4 | Drowsiness | Subjective evaluation |
| 5 | Sense of fulfillment | Subjective evaluation |
| 6 | Relaxation | Subjective evaluation |
| 7 | Feeling of irritation | Subjective evaluation |
| 8 | Feeling of warmth | Subjective evaluation |
| 9 | Subjective depth of sleep | Subjective evaluation |
| 10 | Number of times waking up | Subjective evaluation |
| 11 | Quality of sleep | Subjective evaluation |
| 12 | Feeling refreshed upon rising | Subjective evaluation |
| 13 | Sleep satisfaction | Subjective evaluation |
| 14 | Early-morning waking | Subjective evaluation |
| 15 | Condition of falling asleep | Subjective evaluation |
| 16 | Average activity level | Sleep condition measurement |
| 17 | Sleep onset latency | Sleep condition measurement |
| 18 | Sleep efficiency | Sleep condition measurement |
| 19 | Number of awakenings | Sleep condition measurement |
| 20 | Number of times leaving bed | Sleep condition measurement |
| 21 | Total sleep time | Sleep condition measurement |
| 22 | Middle awakening time | Sleep condition measurement |
| 23 | Autonomic nervous | Pulse wave frequency analysis |
| | system evaluation | |
| 24 | Working capacity | Counting number of trials |
| 25 | Fatigue marker measurement | Blood examination |

Table 5 shows the items evaluated by the second and third experiments. In the second experiment, subjective evaluation before retiring and during sleep, and evaluation by measurement of sleep conditions were performed (evaluation items 1-22). In the third experiment, autonomic nervous system, working capacity, and degree of fatigue were evaluated (evaluation items 23-25).

The Visual Analogue Scale (VAS) for evaluating sensory/emotional intensity was used for the subjective evaluation before retiring. In this evaluation method, the test subject marks a point corresponding to a sensory/emotional strength relating to a question item at the time in question on a single straight line, one end of which represents the worst sensation and the other end represents the best sensation, and by measuring the length from the position of the mark to one end, a subjective sensation is quantified, and a score is evaluated.

The following eight question items were used: “comfort (evaluation item 1),” “motivation (evaluation item 2),” “tiredness (evaluation item 3),” “drowsiness (evaluation item 4),” “sense of fulfillment (evaluation item 5),” “feeling of relaxation (evaluation item 6),” “feeling of irritation (evaluation item 7),” and “feeling of warmth (evaluation item 8).”

The self-administered questionnaire known as the St. Mary's Hospital Sleep Questionnaire for evaluating sleep in the last 24 hours was used for the subjective evaluation during sleep. The following seven question items were used: “subjective depth of sleep (evaluation item 9),” “number of times waking up (evaluation item 10),” “quality of sleep (evaluation item 11),” “feeling refreshed upon rising (evaluation item 12),” “sleep satisfaction (evaluation item 13),” “early-morning waking (evaluation item 14),” and “condition of falling asleep (evaluation item 15).”

A sleep measurement system “NEMURI SCAN (registered trademark)” manufactured by Paramount Bed Co., Ltd. was used to measure sleep state. The sleep measurement system was spread under a bed, and the activity level of each test subject during retiring was measured. The average activity level (evaluation item 16), sleep onset latency (evaluation item 17), sleep efficiency (evaluation item 18), number of awakenings (evaluation item 19), number of times leaving bed (evaluation item 20), total sleep time (evaluation item 21), and middle awakening time (evaluation item 22) of each test subject were calculated from the acquired activity level.

The acceleration plethysmography system “Artett C (registered trademark)” manufactured by U-medica Inc. was used to evaluate the autonomic nervous system (evaluation item 23). An acceleration plethysmogram during, before, and after work was measured by the acceleration plethysmography system, and frequency analysis of the time change data thereof was performed. The autonomic nervous function indicators LF, HF, and LF/HF were thereby calculated, and the state of the autonomic nervous system was evaluated.

Working capacity (evaluation item 24) was evaluated by counting the number of calculations in the 30-minute work load described above. Degree of fatigue (evaluation item 25) was evaluated by blood examination for measuring TGF-beta in blood sampled by drawing blood.

Table 6 shows the results of the second and third experiments for Examples 5 through 8 and Comparative Examples 9 through 16 The results were evaluated by statistically analyzing results for all test subjects and testing for significance between each lighting light and neutral white. A t-test was used as the test method, and cases in which there was a significant difference in improvement for a significance level of 5% are indicated by the symbol “◯.” A tendency toward improvement was evaluated as being present for p-values of less than 10%, and such cases are indicated by the symbol “Δ.” Cases in which there was no significant difference in improvement or tendency toward improvement are indicated by the symbol “x.”

TABLE 6

| Evaluation Item | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 | 25 |
|---|---|---|---|---|---|---|---|---|---|---|---|---|---|---|---|---|---|---|---|---|---|---|---|---|---|
| Example 5 | ∘ | Δ | ∘ | x | ∘ | ∘ | x | ∘ | Δ | Δ | ∘ | ∘ | ∘ | ∘ | ∘ | Δ | ∘ | ∘ | x | x | ∘ | Δ | ∘ | Δ | Δ |
| Example 6 | ∘ | ∘ | ∘ | x | ∘ | ∘ | x | ∘ | x | x | Δ | ∘ | ∘ | Δ | ∘ | x | ∘ | ∘ | x | x | ∘ | x | ∘ | x | Δ |
| Example 7 | ∘ | ∘ | ∘ | x | Δ | ∘ | Δ | x | x | x | x | x | x | x | x | x | x | x | x | x | x | x | ∘ | ∘ | ∘ |
| Example 8 | Δ | Δ | x | x | x | Δ | Δ | x | x | x | x | x | x | x | x | x | x | x | x | x | x | x | Δ | Δ | Δ |
| Comparative | x | x | x | x | x | x | x | x | x | x | x | x | x | x | x | x | x | x | x | x | x | x | x | x | x |
| Example 9 | | | | | | | | | | | | | | | | | | | | | | | | | |
| Comparative | x | x | x | x | x | x | x | x | x | x | x | x | x | x | x | x | x | x | x | x | x | x | x | x | x |
| Example 10 | | | | | | | | | | | | | | | | | | | | | | | | | |
| Comparative | x | x | x | x | x | x | x | x | x | x | x | x | x | x | x | x | x | x | x | x | x | x | x | x | x |
| Example 11 | | | | | | | | | | | | | | | | | | | | | | | | | |
| Comparative | x | x | x | x | x | x | x | x | x | x | x | x | x | x | x | x | x | x | x | x | x | x | x | x | x |
| Example 12 | | | | | | | | | | | | | | | | | | | | | | | | | |
| Comparative | x | x | x | x | x | x | x | x | x | x | x | x | x | x | x | x | x | x | x | x | x | x | x | x | x |
| Example 13 | | | | | | | | | | | | | | | | | | | | | | | | | |
| Comparative | x | x | x | x | x | x | x | x | x | x | x | x | x | x | x | x | x | x | x | x | x | x | x | x | x |
| Example 14 | | | | | | | | | | | | | | | | | | | | | | | | | |
| Comparative | x | x | x | x | x | x | x | x | x | x | x | x | x | x | x | x | x | x | x | x | x | x | x | x | x |
| Example 15 | | | | | | | | | | | | | | | | | | | | | | | | | |
| Comparative | x | x | x | x | x | x | x | ∘ | x | x | x | x | x | x | x | x | x | x | x | x | x | x | x | x | x |
| Example 16 | | | | | | | | | | | | | | | | | | | | | | | | | |

∘: Significant difference is present;
Δ: Tendency is present;
x: No significant difference or tendency is present

According to the results of the second and third experiments, the lighting light of Examples 5 through 8 produced useful results relative to neutral white in the subjective evaluation before retiring or the evaluation during work. Specifically, users can be endowed with a feeling of comfort or relaxation during rest periods or the like, and fatigue and the like during work can be reduced.

There was improvement or a tendency toward improvement in Examples 5 and 6 in items relating to sleep, and sleep efficiency and other factors were improved. There was also improvement or a tendency toward improvement of working capacity in Examples 5, 7, and 8.

In contrast, Comparative Example 9 had a spectrum in which the ratio of the area having a wavelength from 600 nm to 700 nm was less than 30% with respect to the area having a wavelength of 400 nm to 800 nm, and no significant difference or tendency relative to neutral white was observed. Comparative Example 10 had a spectrum in which the ratio of the area having a wavelength from 600 nm to 700 nm was greater than 70% with respect to the area having a wavelength of 400 nm to 800 nm, and no significant difference or tendency relative to neutral white was observed.

Comparative Example 11 had a spectrum in which the ratio of the area having a wavelength from 500 nm to 600 nm was less than 15% with respect to the area having a wavelength of 400 nm to 800 nm, and no significant difference or tendency relative to neutral white was observed. Comparative Example 12 had a spectrum in which the ratio of the area having a wavelength from 500 nm to 600 nm was greater than 45% with respect to the area having a wavelength of 400 nm to 800 nm, and no significant difference or tendency relative to neutral white was observed.

Comparative Example 13 had a spectrum in which the ratio of the area having a wavelength from 400 nm to 500 nm was greater than 10% with respect to the area having a wavelength of 400 nm to 800 nm, and no significant difference or tendency relative to neutral white was observed. In Comparative Example 14, the maximum value of the spectrum was included in the range from 700 nm to 800 nm, and no significant difference or tendency relative to neutral white was observed.

In Comparative Examples 15 and 16, the ratio of the maximum value of the spectrum in the wavelength range from 500 nm to 600 nm with respect to the maximum value of the spectrum in the range from 600 nm to 700 nm was greater than 70%. No significant difference or tendency relative to neutral white was observed in Comparative Example 15. In Comparative Example 16 using incandescent-bulb color, a significant difference was observed in a subjective evaluation (feeling of warmth) relative to neutral white, but no significant difference or tendency was observed in other evaluation items.

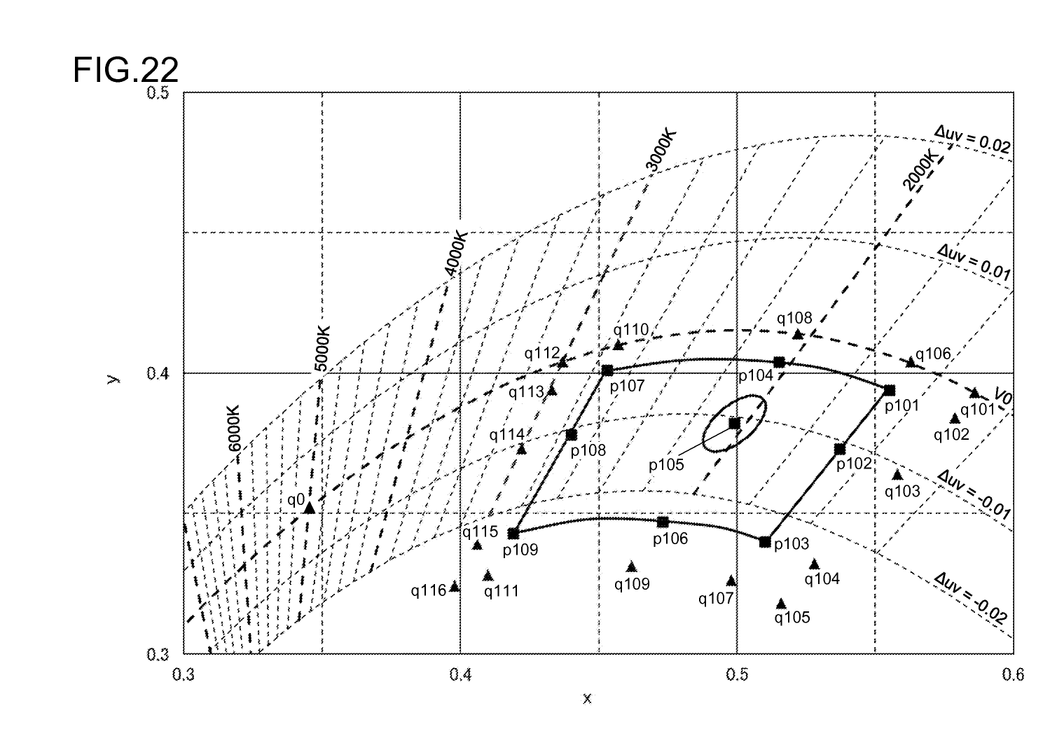

Examples and comparative examples will next be described in which the lighting color is made variable in order to evaluate the lighting light having the lighting color according to the fourth embodiment. FIG. 22 is an enlarged view of the xy chromaticity diagram of FIG. 7. The points for Examples 9, 10, etc., below are indicated in FIG. 22 by the reference symbols p101, p102, etc., and the points for Comparative Examples 17, 18, etc., are indicated by the reference symbols q101, q102, etc.

### Example 9

The lighting device 200 of Example 9 emits lighting light having the lighting color of point A1 (0.555, 0.394) (point p101 in FIG. 22) of the region S101.

### Example 10

The lighting device 200 of Example 10 emits lighting light having the lighting color of a point (0.537, 0.373) (point p102 in FIG. 22) on the isotemperature line W101 of the region S101.

### Example 11

The lighting device 200 of Example 11 emits lighting light having the lighting color of point C1 (0.510, 0.340) (point p103 in FIG. 22) of the region S101.

### Example 12

The lighting device 200 of Example 12 emits lighting light having the lighting color of a point (0.515, 0.404) (point p104 in FIG. 22) on the isanomal V101 of the region S101.

### Example 13

The lighting device 200 of Example 13 emits lighting light having the lighting color of point E1 (0.499, 0.382) (point p105 in FIG. 22) inside the region S101.

### Example 14

The lighting device 200 of Example 14 emits lighting light having the lighting color of a point (0.473, 0.347) (point p106 in FIG. 22) on the isanomal V102 of the region S101.

### Example 15

The lighting device 200 of Example 15 emits lighting light having the lighting color of point D1 (0.453, 0.401) (point p107 in FIG. 22) of the region S101.

### Example 16

The lighting device 200 of Example 16 emits lighting light having the lighting color of a point (0.440, 0.378) (point p108 in FIG. 22) on the isotemperature line W102 of the region S101.

### Example 17

The lighting device 200 of Example 17 emits lighting light having the lighting color of point B1 (0.419, 0.343) (point p109 in FIG. 22) of the region S101.

### Comparative Example 17

The lighting device 200 of Comparative Example 17 for comparison with Examples 9-17 emits lighting light having the lighting color of a point (0.586, 0.393) (point q101 in FIG. 22) closer to the blackbody locus V0 than the isanomal V101 and having a correlated color temperature lower than the isotemperature line W101.

### Comparative Example 18

The lighting device 200 of Comparative Example 18 emits lighting light having the lighting color of a point (0.579, 0.384) (point q102 in FIG. 22) on the isanomal V101 having a correlated color temperature lower than the isotemperature line W101.

### Comparative Example 19

The lighting device 200 of Comparative Example 19 emits lighting light having the lighting color of a point (0.558, 0.364) (point q103 in FIG. 22) having a low correlated color temperature relative to the point in Example 2.

### Comparative Example 20

The lighting device 200 of Comparative Example 20 emits lighting light having the lighting color of a point (0.528, 0.332) (point q104 in FIG. 22) on the isanomal V102 having a correlated color temperature lower than the isotemperature line W101.

### Comparative Example 21

The lighting device 200 of Comparative Example 21 emits lighting light having the lighting color of a point (0.516, 0.318) (point q105 in FIG. 22) farther from the blackbody locus V0 than the isanomal V102 and having a correlated color temperature lower than the isotemperature line W101.

### Comparative Example 22

The lighting device 200 of Comparative Example 22 emits lighting light having the lighting color of a point (0.563, 0.404) (point q106 in FIG. 22) on the isotemperature line W101 closer to the blackbody locus V0 than the isanomal V101.

### Comparative Example 23

The lighting device 200 of Comparative Example 23 emits lighting light having the lighting color of a point (0.498, 0.326) (point q107 in FIG. 22) on the isotemperature line W101 farther from the blackbody locus V0 than the isanomal V102.

### Comparative Example 24

The lighting device 200 of Comparative Example 24 emits lighting light having the lighting color of a point (0.552, 0.414) (point q108 in FIG. 22) closer to the blackbody locus V0 than the point of Example 4.

### Comparative Example 25

The lighting device 200 of Comparative Example 25 emits lighting light having the lighting color of a point (0.462, 0.331) (point q109 in FIG. 22) farther from the blackbody locus V0 than the point of Example 6.

### Comparative Example 26

The lighting device 200 of Comparative Example 26 emits lighting light having the lighting color of a point (0.457, 0.410) (point q110 in FIG. 22) closer to the blackbody locus V0 than the point of Example 7.

### Comparative Example 27

The lighting device 200 of Comparative Example 27 emits lighting light having the lighting color of a point (0.410, 0.328) (point q111 in FIG. 22) farther from the blackbody locus V0 than the point of Example 9.

### Comparative Example 28

The lighting device 200 of Comparative Example 28 emits lighting light having the lighting color of a point (0.437, 0.404) (point q112 in FIG. 22) closer to the blackbody locus V0 than the isanomal V101 and having a correlated color temperature higher than the isotemperature line W102.

### Comparative Example 29

The lighting device 200 of Comparative Example 29 emits lighting light having the lighting color of a point (0.433, 0.394) (point q113 in FIG. 22) having a high correlated color temperature relative to the point in Example 7.

### Comparative Example 30

The lighting device 200 of Comparative Example 30 emits lighting light having the lighting color of a point (0.422, 0.373) (point q114 in FIG. 22) having a high correlated color temperature relative to the point in Example 8.

### Comparative Example 31

The lighting device 200 of Comparative Example 31 emits lighting light having the lighting color of a point (0.406, 0.339) (point q115 in FIG. 22) having a high correlated color temperature relative to the point in Example 9.

### Comparative Example 32

The lighting device 200 of Comparative Example 32 emits lighting light having the lighting color of a point (0.398, 0.324) (point q116 in FIG. 22) farther from the blackbody locus V0 than the isanomal V102 and having a correlated color temperature higher than the isotemperature line W102.

The experiments described below were performed for Examples 9 through 17 and Comparative Examples 17 through 32 described above. In a fourth experiment, a total of 32 healthy individuals, sixteen male and sixteen female, from age 20 to age 65 were chosen as test subjects, and drowsiness, discomfort, and feeling of rest were evaluated. Specifically, the test subjects were divided into two groups, the lighting color was made variable in the same room, and evaluation was performed after the lighting light was irradiated to the test subjects. The results were compared with those of a case in which neutral white light was irradiated to the test subjects in the same manner. The correlated color temperature of the neutral white was approximately 5000 K, and the chromaticity coordinates thereof were (0.345, 0.342) (point q0 in FIG. 22).

The Visual Analogue Scale (VAS) for evaluating sensory/emotional intensity was used as the evaluation method. In this evaluation method, the test subject marks a point corresponding to a sensory/emotional strength relating to a question item at the time in question on a single straight line, one end of which represents the worst sensation and the other end represents the best sensation, and by measuring the length from the position of the mark to one end, a subjective sensation is quantified, and a score is evaluated.

In a fifth experiment, a total of 32 healthy individuals, sixteen male and sixteen female, from age 20 to age 65 were chosen as test subjects, and quality of sleep was evaluated. Specifically, a test subject for each room was caused to stand by, the environment state was made the same for all test subjects, and the sleep state was measured after lighting light of each lighting color was radiated at an illuminance equivalent to 35 W (approximately 45 lx) for a period one hour before retiring until bedtime. Comparison was made with the sleep state in a case in which neutral white light was radiated in the same manner at an illuminance equivalent to 35 W (approximately 85 lx).

A sleep measurement system “NEMURI SCAN (registered trademark)” manufactured by Paramount Bed Co., Ltd. was used to measure sleep state. The sleep measurement system was spread under a bed, the activity level of each test subject during retiring was measured, and the sleep onset latency, sleep efficiency, and total sleep time for each test subject were calculated from the activity level.

Tables 7 and 8 show the results of the fourth and fifth experiments for Examples 9 through 17 and Comparative Examples 17 through 32. The results were evaluated by statistically analyzing results for all test subjects and testing for significance between each lighting color and neutral white. A t-test was used as the test method, and an evaluation of “improved” or “worsened” was made for a significance level of 5%. An evaluation of “improvement tendency” or “worsening tendency” was made in the case of differences for which the p-value was less than 10%.

TABLE 7

| | | Chromaticity | | | | Feeling | Sleep | | |
|---|---|---|---|---|---|---|---|---|---|
| | | coordinates | | | | of | onset | Sleep | |
| | Point | x | y | Drowsiness | Discomfort | rest | latency | efficiency | Sleep time |
| Example 9 | p101, A1 | 0.555 | 0.394 | Improved | Same | Improved | Improved | Improvement | Improvement |
| | | | | | | | | tendency | tendency |
| Example 10 | p102 | 0.537 | 0.373 | Improved | Same | Improved | Improved | Improvement | Improvement |
| | | | | | | | | tendency | tendency |
| Example 11 | p103, C1 | 0.510 | 0.340 | Improved | Same | Improved | Improved | Improvement | Improvement |
| | | | | | | | | tendency | tendency |
| Example 12 | p104 | 0.515 | 0.404 | Improved | Same | Improved | Improved | Improvement | Improvement |
| | | | | | | | | tendency | tendency |
| Example 13 | p105, E1 | 0.499 | 0.382 | Improved | Same | Improved | Improved | Improved | Improved |
| Example 14 | p106 | 0.473 | 0.347 | Improved | Same | Improved | Improved | Improvement | Improvement |
| | | | | | | | | tendency | tendency |
| Example 15 | p107, D1 | 0.453 | 0.401 | Improved | Same | Improved | Improved | Improvement | Improvement |
| | | | | | | | | tendency | tendency |
| Example 16 | p108 | 0.440 | 0.378 | Improved | Same | Improved | Improved | Improvement | Improvement |
| | | | | | | | | tendency | tendency |
| Example 17 | p109, B1 | 0.419 | 0.343 | Improved | Same | Improved | Improved | Improvement | Improvement |
| | | | | | | | | tendency | tendency |

TABLE 8

| | | Chromaticity | | | | | Sleep | | |
|---|---|---|---|---|---|---|---|---|---|
| | | coordinates | | | | Feeling of | onset | Sleep | Sleep |
| | Point | x | y | Drowsiness | Discomfort | rest | latency | efficiency | time |
| Comparative Example 17 | q101 | 0.586 | 0.393 | Same | Same | Same | Same | Same | Same |
| Comparative Example 18 | q102 | 0.579 | 0.384 | Same | Same | Same | Same | Same | Same |
| Comparative Example 19 | q103 | 0.558 | 0.364 | Same | Same | Same | Same | Same | Same |
| Comparative Example 20 | q104 | 0.528 | 0.332 | Same | Same | Same | Same | Same | Same |
| Comparative Example 21 | q105 | 0.516 | 0.318 | Same | Worsening | Same | Same | Same | Same |
| | | | | | tendency | | | | |
| Comparative Example 22 | q106 | 0.563 | 0.404 | Same | Same | Improvement | Same | Same | Same |
| | | | | | | tendency | | | |
| Comparative Example 23 | q107 | 0.498 | 0.326 | Same | Worsening | Same | Same | Same | Same |
| | | | | | tendency | | | | |
| Comparative Example 24 | q108 | 0.522 | 0.414 | Same | Same | Improvement | Same | Same | Same |
| | | | | | | tendency | | | |
| Comparative Example 25 | q109 | 0.462 | 0.331 | Same | Worsening | Same | Same | Same | Same |
| | | | | | tendency | | | | |
| Comparative Example 26 | q110 | 0.457 | 0.410 | Same | Same | Improvement | Same | Same | Same |
| | | | | | | tendency | | | |
| Comparative Example 27 | q111 | 0.410 | 0.328 | Same | Worsening | Same | Same | Same | Same |
| | | | | | tendency | | | | |
| Comparative Example 28 | q112 | 0.437 | 0.404 | Same | Same | Improvement | Same | Same | Same |
| | | | | | | tendency | | | |
| Comparative Example 29 | q113 | 0.433 | 0.394 | Same | Same | Improvement | Same | Same | Same |
| | | | | | | tendency | | | |
| Comparative Example 30 | q114 | 0.422 | 0.373 | Same | Same | Improvement | Same | Same | Same |
| | | | | | | tendency | | | |
| Comparative Example 31 | q115 | 0.406 | 0.339 | Same | Same | Improvement | Same | Same | Same |
| | | | | | | tendency | | | |
| Comparative Example 32 | q116 | 0.398 | 0.324 | Same | Worsening | Same | Same | Same | Same |
| | | | | | tendency | | | | |

According to the results of the fourth and fifth experiments, in the case of lighting colors in the region S101, drowsiness or feeling of rest was improved and sleep onset latency was improved (shortened) relative to neutral white, and sleep efficiency and sleep time were improved or tended to be improved. In the case of lighting colors outside the range of the region S101, drowsiness, sleep onset latency, sleep efficiency, and sleep time were the same relative to neutral white. When the deviation with respect to the blackbody locus V0 was large (Comparative Examples 21, 23, 25, 27, and 32), there was a worsening tendency for discomfort relative to neutral white. When the deviation with respect to the blackbody locus V0 was small (Comparative Examples 22, 24, 26, and 28), feeling of rest tended to be improved relative to neutral white, but drowsiness or sleep efficiency was the same.

Consequently, by providing lighting having a lighting color in the region S101 before retiring, sleep onset latency at bedtime can be shortened, and improved sleep efficiency can be anticipated. Significant improvement in sleep onset latency, sleep efficiency, and sleep time was observed in Example 13 in particular, and markedly improved sleep efficiency can be anticipated. Discomfort can also be eliminated and restfulness brought about by providing lighting having a lighting color in the region S101 during recesses or small social gatherings.

David L. MacAdam's article “Visual Sensitivities to Color Differences in Daylight” in Journal of the Optical Society of America (Vol. 32, No. 5; May 1942 Issue) presents a range of colors that are indistinguishable from the color of a certain point on a chromaticity diagram when the point is selected on the basis of a visual color matching experiment. This range is an ellipse when the standard deviation of variations in discrimination for a specific central color is represented in an xy chromaticity diagram, and is also referred to as a 1-step MacAdam ellipse.

In contrast with the 1-step MacAdam ellipse, the International Electrotechnical Commission (IEC) 5-step MacAdam ellipse and the American National Standards Institute (ANSI) 7-step MacAdam ellipse are recognized industrially as “isochromatic” standards, and commercial products are allowed to be made in accordance with these standards. In a 5-step MacAdam ellipse, the lengths of the short side and the long side of the ellipse are five times that of the short side and the long side, respectively, of a 1-step MacAdam ellipse.

According to the middle part of the website (http://www.lrc.rpi.edu/programs/nlpip/lightinganswers/lightsources/whatisColorCons whatisC.asp), “the International Electrotechnical Commission (IEC) standard (IEC 2002) specifies six, 5-step MacAdam ellipses as color consistency criteria for double-capped fluorescent lamps,” and the “IEC 5-step” MacAdam ellipse is recognized by the International Electrotechnical Commission (IEC) standard (IEC 2002).

“ANSI 7-step” MacAdam ellipses are shown in the FIG. A1 graph of the specifications of SSL products represented on p. 14 of “ANSI_NEMA_ANSLG C78.377-2008” (American National Standard for electric lamps-Specifications for the Chromaticity of Solid State Lighting Products) by the American National Standards Institute.

Therefore, the lighting color of the region S101 may be assumed to belong to the isochromatic range S102 (see FIG. 7) represented by a 5-step MacAdam ellipse centered at the point E1 (0.499, 0.382) (point p105 in FIG. 22) in FIG. 7. The lighting color of the region S101 may also be assumed to belong to the isochromatic range represented by a 1-step MacAdam ellipse centered at the point E1.

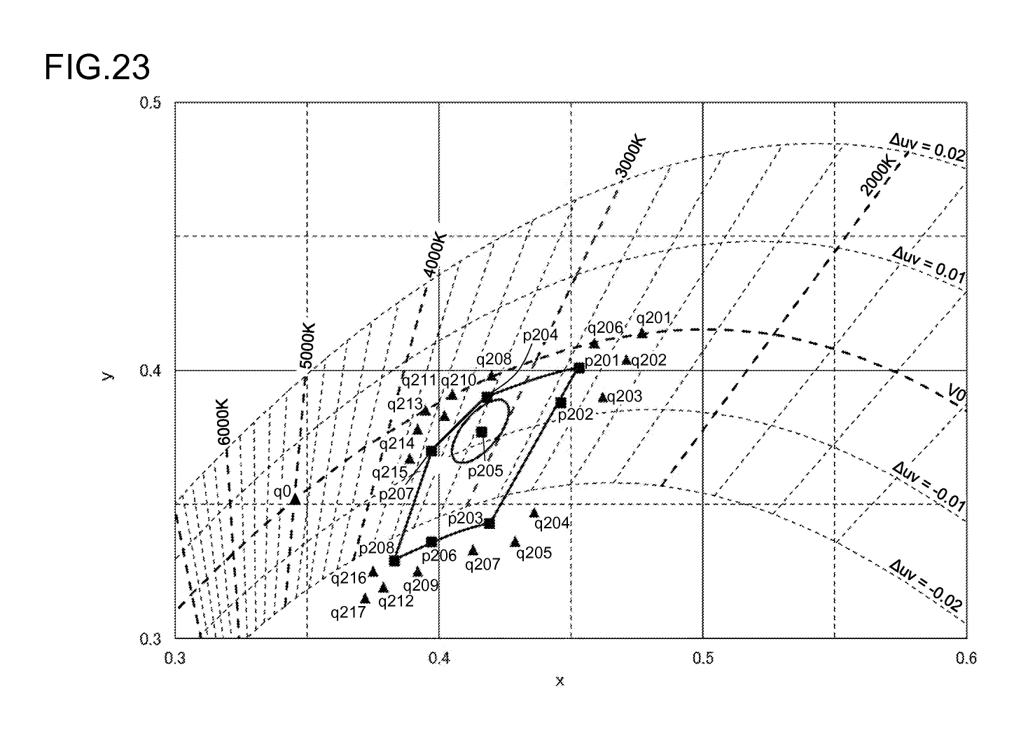

Examples and comparative examples will next be described in which the lighting color is made variable in order to evaluate the lighting light having the lighting color according to the fifth embodiment. FIG. 23 is an enlarged view of the xy chromaticity diagram of FIG. 8. The points for Examples 18, 19, etc., below are indicated in FIG. 23 by the reference symbols p201, p202, etc., and the points for Comparative Examples 33, 34, etc., are indicated by the reference symbols q201, q202, etc.

### Example 18

The lighting device 200 of Example 18 emits lighting light having the lighting color of point D2 (0.453, 0.401) (point p201 in FIG. 23) of the region S201.

### Example 19

The lighting device 200 of Example 19 emits lighting light having the lighting color of a point (0.446, 0.388) (point p202 in FIG. 23) on the isotemperature line W201 of the region S201.

### Example 20

The lighting device 200 of Example 20 emits lighting light having the lighting color of point A2 (0.419, 0.343) (point p203 in FIG. 23) of the region S201.

### Example 21

The lighting device 200 of Example 21 emits lighting light having the lighting color of point B2 (0.418, 0.390) (point p204 in FIG. 23) of the region S201.

### Example 22

The lighting device 200 of Example 22 emits lighting light having the lighting color of point F2 (0.416, 0.377) (point p205 in FIG. 23) inside the region S201.

### Example 23

The lighting device 200 of Example 23 emits lighting light having the lighting color of a point (0.397, 0.336) (point p206 in FIG. 23) on the isanomal V201 of the region S201.

### Example 24

The lighting device 200 of Example 24 emits lighting light having the lighting color of point C2 (0.397, 0.370) (point p207 in FIG. 23) of the region S201.

### Example 25

The lighting device 200 of Example 25 emits lighting light having the lighting color of point E2 (0.383, 0.329) (point p208 in FIG. 23) of the region S201.

### Comparative Example 33

The lighting device 200 of Comparative Example 33 for comparison with Examples 18-25 emits lighting light having the lighting color of a point (0.477, 0.414) (point q201 in FIG. 23) closer to the blackbody locus V0 than the isanomal V202 and having a correlated color temperature lower than the isotemperature line W201.

### Comparative Example 34

The lighting device 200 of Comparative Example 34 emits lighting light having the lighting color of a point (0.471, 0.404) (point q202 in FIG. 23) having a low correlated color temperature relative to the point D2.

### Comparative Example 35

The lighting device 200 of Comparative Example 35 emits lighting light having the lighting color of a point (0.462, 0.390) (point q203 in FIG. 23) having a low correlated color temperature relative to the point of Example 11.

### Comparative Example 36

The lighting device 200 of Comparative Example 36 emits lighting light having the lighting color of a point (0.436, 0.347) (point q204 in FIG. 23) having a low correlated color temperature relative to the point A2.

### Comparative Example 37

The lighting device 200 of Comparative Example 37 emits lighting light having the lighting color of a point (0.429, 0.336) (point q205 in FIG. 23) farther from the blackbody locus V0 than the isanomal V201 and having a correlated color temperature lower than the isotemperature line W201.

### Comparative Example 38

The lighting device 200 of Comparative Example 38 emits lighting light having the lighting color of a point (0.459, 0.410) (point q206 in FIG. 23) on the isotemperature line W201 and closer to the blackbody locus V0 than the isanomal V202.

### Comparative Example 39

The lighting device 200 of Comparative Example 39 emits lighting light having the lighting color of a point (0.413, 0.333) (point q207 in FIG. 23) on the isotemperature line W201 and farther from the blackbody locus V0 than the isanomal V201.

### Comparative Example 40

The lighting device 200 of Comparative Example 40 emits lighting light having the lighting color of a point (0.420, 0.398) (point q208 in FIG. 23) closer to the blackbody locus V0 than the point B2.

### Comparative Example 41

The lighting device 200 of Comparative Example 41 emits lighting light having the lighting color of a point (0.392, 0.325) (point q209 in FIG. 23) farther from the blackbody locus V0 than the point of Example 15.

### Comparative Example 42

The lighting device 200 of Comparative Example 42 emits lighting light having the lighting color of a point (0.405, 0.391) (point q210 in FIG. 23) on the isotemperature line W202 and closer to the blackbody locus V0 than the isanomal V202.

### Comparative Example 43

The lighting device 200 of Comparative Example 43 emits lighting light having the lighting color of the intersection point (0.402, 0.383) (point q211 in FIG. 23) of the isanomal V202 and the isotemperature line W202.

### Comparative Example 44

The lighting device 200 of Comparative Example 44 emits lighting light having the lighting color of a point (0.379, 0.319) (point q212 in FIG. 23) on the isotemperature line W202 and farther from the blackbody locus V0 than the isanomal V201.

### Comparative Example 45

The lighting device 200 of Comparative Example 45 emits lighting light having the lighting color of a point (0.395, 0.385) (point q213 in FIG. 23) closer to the blackbody locus V0 than the isanomal V202 and having a correlated color temperature higher than the isotemperature line W202.

### Comparative Example 46

The lighting device 200 of Comparative Example 46 emits lighting light having the lighting color of a point (0.392, 0.378) (point q214 in FIG. 23) on the isanomal V202 and having a correlated color temperature higher than the isotemperature line W202.

### Comparative Example 47

The lighting device 200 of Comparative Example 47 emits lighting light having the lighting color of a point (0.389, 0.367) (point q215 in FIG. 23) having a correlated color temperature higher than the point C2.

### Comparative Example 48

The lighting device 200 of Comparative Example 48 emits lighting light having the lighting color of a point (0.375, 0.325) (point q216 in FIG. 23) on the isanomal V201 and having a correlated color temperature higher than the point E2.

### Comparative Example 49

The lighting device 200 of Comparative Example 49 emits lighting light having the lighting color of a point (0.372, 0.315) (point q217 in FIG. 23) farther from the blackbody locus V0 than the isanomal V201 and having a correlated color temperature higher than the isotemperature line W202.

The experiment described below was performed for Examples 18 through 25 and Comparative Examples 33 through 49 described above. In a sixth experiment, working capacity was evaluated in a total of 32 healthy individuals, sixteen male and sixteen female, from age 20 to age 65 as test subjects. Specifically, a test subject for each room was caused to stand by, the environment state was made the same for all test subjects, and subjective evaluation and working capacity evaluation were performed after lighting light of each lighting color was radiated for 30 minutes of work time. The experiment was performed at an illuminance equivalent to 85 W (approximately 500 lx) and an illuminance equivalent to 100 W (approximately 600 lx) for each lighting color. The results for each lighting color were compared with an evaluation in a case in which neutral white light was radiated at an illuminance equivalent to 85 W (approximately 600 lx).

The question item “motivation” was provided as a subjective evaluation relating to work, and subjective evaluation after 30 minutes of work was made using the Visual Analogue Scale (VAS). In this evaluation method, the test subject marks a point corresponding to a sensory/emotional strength relating to a question item at the time in question on a single straight line, one end of which represents the worst sensation and the other end represents the best sensation, and by measuring the length from the position of the mark to one end, a subjective sensation is quantified, and a score is evaluated. The “Uchida-Kraepelin Test (registered trademark)” of Nisseiken, Inc. was used as a work load. The content of the test is a computational work load in which simple one-digit additions are performed for a total of 30 minutes while changing rows every minute. Working capacity was measured by totaling the number of calculations in the 30 minutes.

Tables 9 and 10 show the results of the sixth experiment for Examples 18 through 25 and Comparative Examples 33 through 49. The results were evaluated by statistically analyzing results for all test subjects and testing for significance between each lighting color and neutral white. A t-test was used as the test method, and an evaluation of “improved” or “worsened” was made for a significance level of 5%. An evaluation of “improvement tendency” or “worsening tendency” was made in the case of differences for which the p-value was less than 10%.

TABLE 9

| | | Chromaticity | | | | | |
|---|---|---|---|---|---|---|---|
| | | coordinates | | Motivation | | Working capacity | |
| | Point | x | y | 85 W | 100 W | 85 W | 100 W |
| Example | p201, | 0.453 | 0.401 | Same | Improved | Same | Improvement |
| 18 | D2 | | | | | | tendency |
| Example | p202 | 0.446 | 0.388 | Same | Improved | Same | Improvement |
| 19 | | | | | | | tendency |
| Example | p203, | 0.419 | 0.343 | Same | Improved | Same | Improvement |
| 20 | A2 | | | | | | tendency |
| Example | p204, | 0.418 | 0.390 | Same | Improved | Same | Improvement |
| 21 | B2 | | | | | | tendency |
| Example | p205, | 0.416 | 0.377 | Same | Improved | Same | Improved |
| 22 | F2 | | | | | | |
| Example | p206 | 0.397 | 0.336 | Same | Improved | Same | Improvement |
| 23 | | | | | | | tendency |
| Example | p207, | 0.397 | 0.370 | Same | Improved | Same | Improvement |
| 24 | C2 | | | | | | tendency |
| Example | p208, | 0.383 | 0.329 | Same | Improved | Same | Improvement |
| 25 | E2 | | | | | | tendency |

TABLE 10

| | | Chromaticity | | | | Working | |
|---|---|---|---|---|---|---|---|
| | | coordinates | | Motivation | | capacity | |
| | Point | x | y | 85 W | 100 W | 85 W | 100 W |
| Comparative | q201 | 0.477 | 0.414 | Same | Same | Same | Same |
| Example 33 | | | | | | | |
| Comparative | q202 | 0.471 | 0.404 | Same | Same | Same | Same |
| Example 34 | | | | | | | |
| Comparative | q203 | 0.462 | 0.390 | Same | Same | Same | Same |
| Example 35 | | | | | | | |
| Comparative | q204 | 0.436 | 0.347 | Same | Same | Same | Same |
| Example 36 | | | | | | | |
| Comparative | q205 | 0.429 | 0.336 | Same | Same | Same | Same |
| Example 37 | | | | | | | |
| Comparative | q206 | 0.459 | 0.410 | Same | Same | Same | Same |
| Example 38 | | | | | | | |
| Comparative | q207 | 0.413 | 0.333 | Same | Same | Same | Same |
| Example 39 | | | | | | | |
| Comparative | q208 | 0.420 | 0.398 | Same | Same | Same | Same |
| Example 40 | | | | | | | |
| Comparative | q209 | 0.392 | 0.325 | Same | Same | Same | Same |
| Example 41 | | | | | | | |
| Comparative | q210 | 0.405 | 0.391 | Same | Same | Same | Same |
| Example 42 | | | | | | | |
| Comparative | q211 | 0.402 | 0.383 | Same | Same | Same | Same |
| Example 43 | | | | | | | |
| Comparative | q212 | 0.379 | 0.319 | Same | Same | Same | Same |
| Example 44 | | | | | | | |
| Comparative | q213 | 0.395 | 0.385 | Same | Same | Same | Same |
| Example 45 | | | | | | | |
| Comparative | q214 | 0.392 | 0.378 | Same | Same | Same | Same |
| Example 46 | | | | | | | |
| Comparative | q215 | 0.389 | 0.367 | Same | Same | Same | Same |
| Example 47 | | | | | | | |
| Comparative | q216 | 0.375 | 0.325 | Same | Same | Same | Same |
| Example 48 | | | | | | | |
| Comparative | q217 | 0.372 | 0.315 | Same | Same | Same | Same |
| Example 49 | | | | | | | |

According to the results of the sixth experiment, motivation or working capacity was the same as that of neutral white when the lighting color in the region S201 was equivalent to 85 W, i.e., when the light energy outputs from the light source and for neutral white were the same. At an illuminance equivalent to 100 W for the lighting color in the region S201, i.e., when the neutral white and the illuminance over the desk were the same, motivation or working capacity was improved or tended to be improved relative to neutral white.

When the lighting color was outside the range of the region S201, motivation or working capacity was not improved relative to neutral white for illuminance equivalent to 85 W and 100 W. In general, when the illuminance over the desk is considered more as a reference than the light energy output from the light source in setting the lighting conditions during work (see JIS-Z-8516, for example), i.e., by providing lighting using the lighting color of the region S201 during work, improved motivation for work and improved working capacity can be anticipated.

Since significant improvement in working capacity was observed in Example 22 in particular, marked improvement in working capacity can be anticipated. Regarding the subjective evaluation of motivation, it is generally known that motivation decreases as fatigue increases, and in the current experiment, the improvement in motivation is considered to be due to suppression of arousal of the sympathetic nervous system by the work load, and reduction of tiredness during work.

Using the MacAdam color matching standard, the lighting color of the region S201 may be assumed to belong to the isochromatic range S202 (see FIG. 8) represented by a 5-step MacAdam ellipse centered at the point F2 (0.416, 0.377) (point p205 in FIG. 23) in FIG. 8, the same as in the fourth embodiment. The lighting color of the region S201 may also be assumed to belong to the isochromatic range represented by a 1-step MacAdam ellipse centered at the point F2.

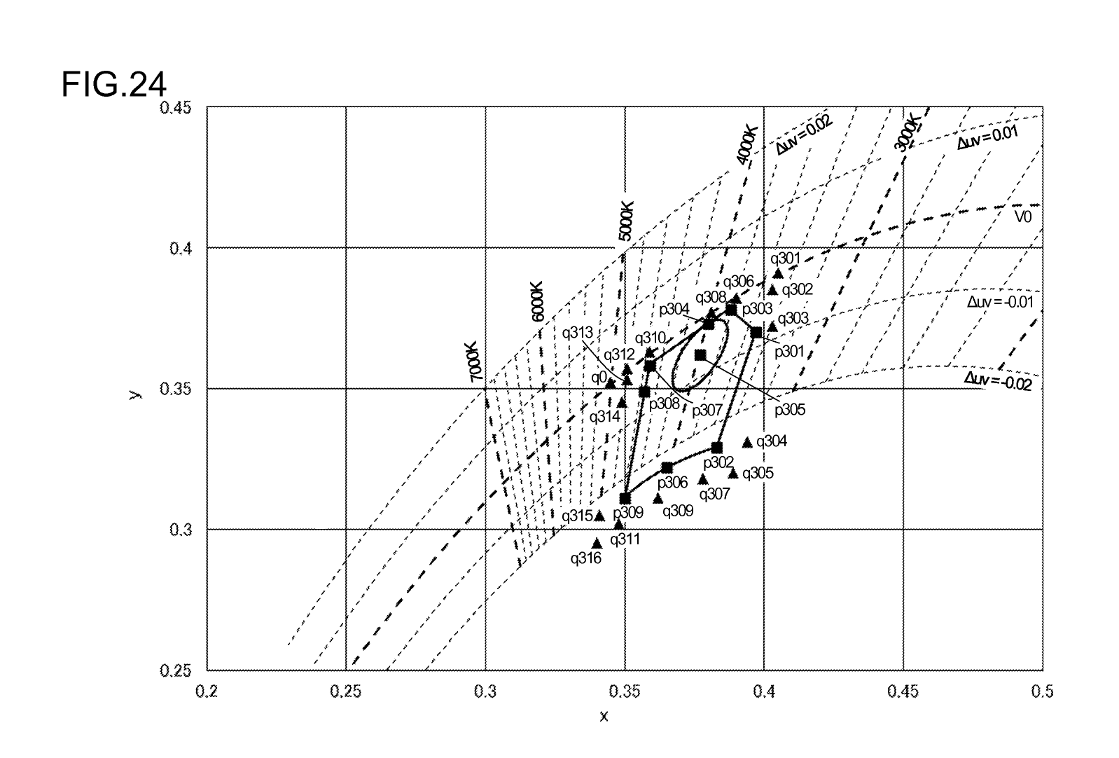

Examples and comparative examples will next be described in which the lighting color is made variable in order to evaluate the lighting light having the lighting color according to the sixth embodiment. FIG. 24 is an enlarged view of the xy chromaticity diagram of FIG. 9. The points for Examples 26, 27, etc., below are indicated in FIG. 24 by the reference symbols p301, p302, etc., and the points for Comparative Examples 50, 51, etc., are indicated by the reference symbols q301, q302, etc.

### Example 26

The lighting device 200 of Example 26 emits lighting light having the lighting color of point B3 (0.397, 0.370) (point p301 in FIG. 24) of the region S301.

### Example 27

The lighting device 200 of Example 27 emits lighting light having the lighting color of point D3 (0.383, 0.329) (point p302 in FIG. 24) of the region S301.

### Example 28

The lighting device 200 of Example 28 emits lighting light having the lighting color of point C3 (0.388, 0.378) (point p303 in FIG. 24) of the region S301.

### Example 29

The lighting device 200 of Example 29 emits lighting light having the lighting color of a point (0.380, 0.373) (point p304 in FIG. 24) on the isanomal V302 of the region S301.

### Example 30

The lighting device 200 of Example 30 emits lighting light having the lighting color of point F3 (0.377, 0.362) (point p305 in FIG. 24) inside the region S301.

### Example 31

The lighting device 200 of Example 31 emits lighting light having the lighting color of a point (0.365, 0.322) (point p306 in FIG. 24) on the isanomal V301 of the region S301.

### Example 32

The lighting device 200 of Example 32 emits lighting light having the lighting color of point E3 (0.359, 0.358) (point p307 in FIG. 24) of the region S301.

### Example 33

The lighting device 200 of Example 33 emits lighting light having the lighting color of a point (0.357, 0.349) (point p308 in FIG. 24) on the isotemperature line W301 of the region S301.

### Example 34

The lighting device 200 of Example 34 emits lighting light having the lighting color of point A3 (0.350, 0.311) (point p309 in FIG. 24) of the region S301.

### Comparative Example 50

The lighting device 200 of Comparative Example 50 for comparison with Examples 26-34 emits lighting light having the lighting color of a point (0.405, 0.391) (point q301 in FIG. 24) close to the blackbody locus V0 and having a low correlated color temperature relative to the point of Example 20.

### Comparative Example 51

The lighting device 200 of Comparative Example 51 emits lighting light having the lighting color of a point (0.403, 0.385) (point q302 in FIG. 24) having an equal deviation from the blackbody locus V0 and a low correlated color temperature relative to the point of Example 20.

### Comparative Example 52

The lighting device 200 of Comparative Example 52 emits lighting light having the lighting color of a point (0.403, 0.372) (point q303 in FIG. 24) having a low correlated color temperature relative to the point of Example 18.

### Comparative Example 53

The lighting device 200 of Comparative Example 53 emits lighting light having the lighting color of a point (0.394, 0.331) (point q304 in FIG. 24) having a low correlated color temperature relative to the point of Example 19.

### Comparative Example 54

The lighting device 200 of Comparative Example 54 emits lighting light having the lighting color of a point (0.389, 0.320) (point q305 in FIG. 24) farther from the blackbody locus V0 than the isanomal V301 and having a correlated color temperature lower than the isotemperature line W302.

### Comparative Example 55

The lighting device 200 of Comparative Example 55 emits lighting light having the lighting color of a point (0.390, 0.382) (point q306 in FIG. 24) closer to the blackbody locus V0 than the point of Example 20.

### Comparative Example 56

The lighting device 200 of Comparative Example 56 emits lighting light having the lighting color of a point (0.378, 0.318) (point q307 in FIG. 24) farther from the blackbody locus V0 than the point of Example 19.

### Comparative Example 57

The lighting device 200 of Comparative Example 57 emits lighting light having the lighting color of a point (0.381, 0.377) (point q308 in FIG. 24) closer to the blackbody locus V0 than the point of Example 21.

### Comparative Example 58

The lighting device 200 of Comparative Example 58 emits lighting light having the lighting color of a point (0.362, 0.311) (point q309 in FIG. 24) farther from the blackbody locus V0 than the point of Example 23.

### Comparative Example 59

The lighting device 200 of Comparative Example 59 emits lighting light having the lighting color of a point (0.359, 0.363) (point q310 in FIG. 24) closer to the blackbody locus V0 than the point of Example 24.

### Comparative Example 60

The lighting device 200 of Comparative Example 60 emits lighting light having the lighting color of a point (0.348, 0.302) (point q311 in FIG. 24) farther from the blackbody locus V0 than the point of Example 26.

### Comparative Example 61

The lighting device 200 of Comparative Example 61 emits lighting light having the lighting color of a point (0.351, 0.357) (point q312 in FIG. 24) closer to the blackbody locus V0 than the isanomal V302 and having a correlated color temperature higher than the isotemperature line W301.

### Comparative Example 62

The lighting device 200 of Comparative Example 62 emits lighting light having the lighting color of a point (0.351, 0.353) (point q313 in FIG. 24) having a high correlated color temperature relative to the point of Example 24.

### Comparative Example 63

The lighting device 200 of Comparative Example 63 emits lighting light having the lighting color of a point (0.349, 0.345) (point q314 in FIG. 24) having a high correlated color temperature relative to the point of Example 25.

### Comparative Example 64

The lighting device 200 of Comparative Example 64 emits lighting light having the lighting color of a point (0.341, 0.305) (point q315 in FIG. 24) having a high correlated color temperature relative to the point of Example 26.

### Comparative Example 65

The lighting device 200 of Comparative Example 65 emits lighting light having the lighting color of a point (0.340, 0.295) (point q316 in FIG. 24) farther from the blackbody locus V0 than the isanomal V301 and having a correlated color temperature higher than the isotemperature line W301.

The experiments described below were performed for Examples 26 through 34 and Comparative Examples 50 through 65 described above. In a seventh experiment, feeling of unease and color preference were evaluated in a total of 32 healthy individuals, sixteen male and sixteen female, as test subjects. Specifically, the test subjects were divided into two groups, the lighting color was made variable in the same room, and evaluation was performed after the lighting light was irradiated to the test subjects. The results were compared with those of a case in which neutral white light was irradiated to the test subjects in the same manner. The correlated color temperature of the neutral white was approximately 5000 K, the deviation from the blackbody locus V0 was zero, and the chromaticity coordinates thereof were (0.345, 0.342) (point q0 in FIG. 24).

The Visual Analogue Scale (VAS) for evaluating sensory/emotional intensity was used as the evaluation method. In this evaluation method, the test subject marks a point corresponding to a sensory/emotional strength relating to a question item at the time in question on a single straight line, one end of which represents the worst sensation and the other end represents the best sensation, and by measuring the length from the position of the mark to one end, a subjective sensation is quantified, and a score is evaluated.

In an eighth experiment, a total of 32 healthy individuals, sixteen male and sixteen female, were selected as test subjects, and the moods of the test subjects from the lighting environment were evaluated.

An evaluation according to an amylase measured value was used as the evaluation method. Stress in the body promotes excitation of the sympathetic nervous system via the hypothalamus of the sympathetic nervous system. This excitation activates various digestive enzymes, as well as amylase, for promoting decomposition of toxins in the digestive tract as a self-defense reaction in the body to stress from outside the body. By collecting salivary amylase, it is possible to determine the degree of stress that has been experienced. A salivary amylase monitor CM-2.1 manufactured by Nipro Corporation, for example, or other commercially available stress measurement instrument can be used to measure amylase. A stress-free state can be determined from an amylase measured value of 30 KU/L or less, and a stressed state can be determined from an amylase measured value of 45 KU/L or greater.

Evaluation by amylase measured value was performed by a combination of two additional experimental methods. These methods, referred to as amylase experiments (1) and (2), are described below.

In the experimental method for the amylase experiment (1), the test subjects were divided into two groups and first placed in a stressed state by being caused to perform the Kraepelin test (calculation work load) for 30 minutes in the same room under neutral white irradiation, and amylase was then measured. Amylase was then measured after irradiation with lighting light of any of the lighting colors for 30 minutes, and amylase was then measured again after returning to neutral white lighting.

In the experimental method for the amylase experiment (2), the test subjects were divided into two groups and first placed in a stress-free state by irradiation with neutral white light in the same room, and amylase was measured. Amylase was then measured after irradiation with lighting light of any of the lighting colors for 30 minutes, and amylase was then measured again after returning to neutral white lighting.

Tables 11 and 12 show the results of the seventh and eighth experiments for Examples 26 through 34 and Comparative Examples 50 through 65. The results were evaluated by statistically analyzing results for all test subjects and testing for significance between each lighting color and neutral white. A t-test was used as the test method, and an evaluation of “improved (alleviated)” or “worsened” was made for a significance level of 5%. An evaluation of “improvement tendency” or “worsening tendency” was made in the case of differences for which the p-value was less than 10%.

TABLE 11

| | | Chromaticity | | Feeling | | | |
|---|---|---|---|---|---|---|---|
| | | coordinates | | of | Color | Amylase experiment | |
| | Point | x | y | unease | preference | (1) | (2) |
| Example 26 | p301, B3 | 0.397 | 0.370 | Same | Improvement | Alleviated | Same |
| | | | | | tendency | | |
| Example 27 | p302, D3 | 0.383 | 0.329 | Same | Improvement | Alleviated | Same |
| | | | | | tendency | | |
| Example 28 | p303, C3 | 0.388 | 0.378 | Same | Improvement | Alleviated | Same |
| | | | | | tendency | | |
| Example 29 | p304 | 0.380 | 0.373 | Same | Improvement | Alleviated | Same |
| | | | | | tendency | | |
| Example 30 | p305, F3 | 0.377 | 0.362 | Same | Improved | Alleviated | Same |
| Example 31 | p306 | 0.365 | 0.322 | Same | Improvement | Alleviated | Same |
| | | | | | tendency | | |
| Example 32 | p307, E3 | 0.359 | 0.358 | Same | Improvement | Alleviated | Same |
| | | | | | tendency | | |
| Example 33 | p308 | 0.357 | 0.349 | Same | Improvement | Alleviated | Same |
| | | | | | tendency | | |
| Example 34 | p309, A3 | 0.350 | 0.311 | Same | Improvement | Alleviated | Same |
| | | | | | tendency | | |

TABLE 12

| | | Chromaticity | | | | | |
|---|---|---|---|---|---|---|---|
| | | coordinates | | Feeling of | | Amylase experiment | |
| | Point | x | y | unease | Color preference | (1) | (2) |
| Comparative | q301 | 0.405 | 0.391 | Same | Same | Same | Same |
| Example 50 | | | | | | | |
| Comparative | q302 | 0.403 | 0.385 | Same | Same | Same | Same |
| Example 51 | | | | | | | |
| Comparative | q303 | 0.403 | 0.372 | Same | Same | Same | Same |
| Example 52 | | | | | | | |
| Comparative | q304 | 0.394 | 0.331 | Same | Same | Same | Same |
| Example 53 | | | | | | | |
| Comparative | q305 | 0.389 | 0.320 | Worsened | Worsening | Same | Same |
| Example 54 | | | | | tendency | | |
| Comparative | q306 | 0.390 | 0.382 | Same | Same | Same | Same |
| Example 55 | | | | | | | |
| Comparative | q307 | 0.378 | 0.318 | Worsened | Worsening | Same | Same |
| Example 56 | | | | | tendency | | |
| Comparative | q308 | 0.381 | 0.377 | Same | Same | Same | Same |
| Example 57 | | | | | | | |
| Comparative | q309 | 0.362 | 0.311 | Worsened | Worsening | Same | Same |
| Example 58 | | | | | tendency | | |
| Comparative | q310 | 0.359 | 0.363 | Same | Same | Same | Same |
| Example 59 | | | | | | | |
| Comparative | q311 | 0.348 | 0.302 | Worsened | Worsening | Same | Same |
| Example 60 | | | | | tendency | | |
| Comparative | q312 | 0.351 | 0.357 | Same | Same | Same | Same |
| Example 61 | | | | | | | |
| Comparative | q313 | 0.351 | 0.353 | Same | Same | Same | Same |
| Example 62 | | | | | | | |
| Comparative | q314 | 0.349 | 0.345 | Same | Same | Same | Same |
| Example 63 | | | | | | | |
| Comparative | q315 | 0.341 | 0.305 | Same | Same | Same | Same |
| Example 64 | | | | | | | |
| Comparative | q316 | 0.340 | 0.295 | Worsened | Worsening | Same | Same |
| Example 65 | | | | | tendency | | |

According to the results of the seventh and eighth experiments, in the case of lighting colors in the region S301, feeling of unease was absent, color preference tended to be improved, and stress was reduced relative to neutral white. In the case of the lighting color of Example 30 in particular, color preference was improved relative to neutral white. In the case of lighting colors outside the range of the region S301, feeling of unease and color preference were the same, tended to be worse, or were worse, and stress was the same relative to neutral white. When the deviation with respect to the blackbody locus V0 was large (Comparative Examples 54, 56, 58, 60, and 65), there was a worsening tendency for feeling of unease, and color preference was worsened relative to neutral white.

Consequently, when a person feeling stressed spends time in a room lit with a lighting color in the region S301, the person is favorably disposed toward the lighting color, and stress can be alleviated.

Using the MacAdam color matching standard, the lighting color of the region S301 may be assumed to belong to the isochromatic range S302 (see FIG. 9) represented by a 5-step MacAdam ellipse centered at the point F3 (0.377, 0.362) (point p305 in FIG. 24) in FIG. 9, the same as in the fourth embodiment. The lighting color of the region S301 may also be assumed to belong to the isochromatic range represented by a 1-step MacAdam ellipse centered at the point F3.

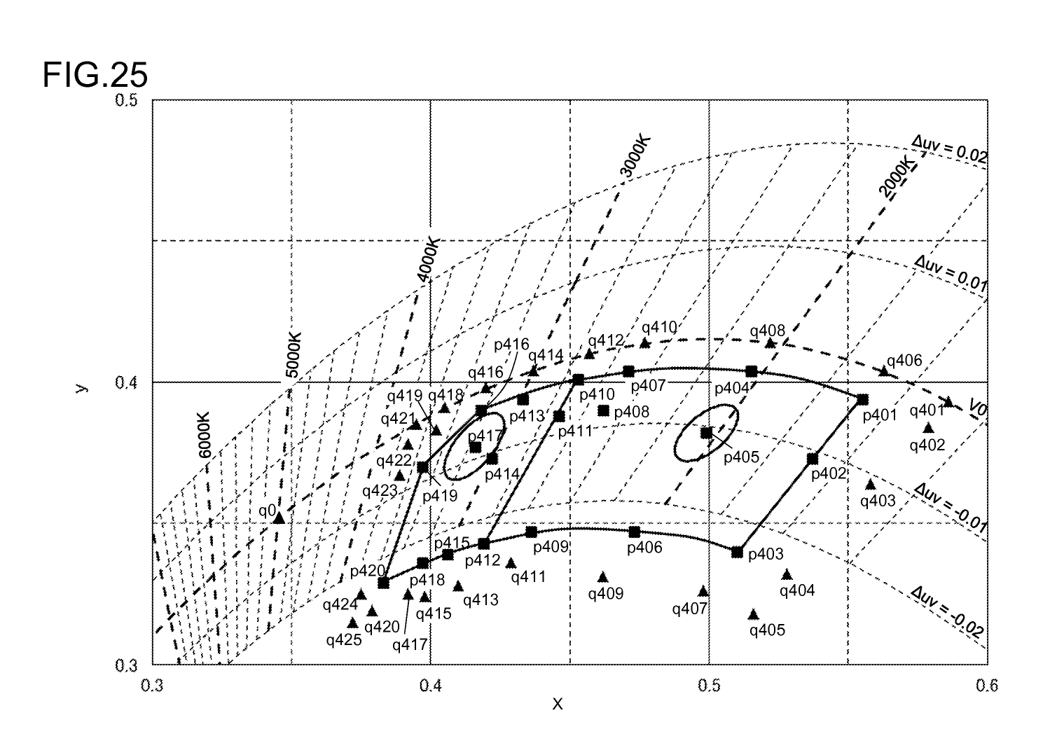

Examples and comparative examples will next be described in which the lighting color is made variable in order to evaluate the lighting light having the lighting colors according to the seventh through ninth embodiments. FIG. 25 is an enlarged view of the xy chromaticity diagram of FIG. 10. The points for Examples 35, 36, etc., below are indicated in FIG. 25 by the reference symbols p401, p402, etc., and the points for Comparative Examples 66, 67, etc., are indicated by the reference symbols q401, q402, etc.

### Example 35

The lighting device 200 of Example 35 emits lighting light having the lighting color of point A4 (0.555, 0.394) (point p401 in FIG. 25) of the region S401.

### Example 36

The lighting device 200 of Example 36 emits lighting light having the lighting color of a point (0.537, 0.373) (point p402 in FIG. 25) on the isotemperature line W401 of the region S401.

### Example 37

The lighting device 200 of Example 37 emits lighting light having the lighting color of point E4 (0.510, 0.340) (point p403 in FIG. 25) of the region S401.

### Example 38

The lighting device 200 of Example 38 emits lighting light having the lighting color of a point (0.515, 0.404) (point p404 in FIG. 25) on the isanomal V401 of the region S401.

### Example 39

The lighting device 200 of Example 39 emits lighting light having the lighting color of point J4 (0.499, 0.382) (point p405 in FIG. 25) inside the region S401.

### Example 40

The lighting device 200 of Example 40 emits lighting light having the lighting color of a point (0.473, 0.347) (point p406 in FIG. 25) on the isanomal V402 of the region S401.

### Example 41

The lighting device 200 of Example 41 emits lighting light having the lighting color of a point (0.471, 0.404) (point p407 in FIG. 25) on the isanomal V401 of the region S401.

### Example 42

The lighting device 200 of Example 42 emits lighting light having the lighting color of a point (0.462, 0.390) (point p408 in FIG. 25) inside the region S401.

### Example 43

The lighting device 200 of Example 43 emits lighting light having the lighting color of a point (0.436, 0.347) (point p409 in FIG. 25) on the isanomal V402 of the region S401.

### Example 44

The lighting device 200 of Example 44 emits lighting light having the lighting color of point F4 (0.453, 0.401) (point p410 in FIG. 25) at the boundary of a first region S401 and a second region S402.

### Example 45

The lighting device 200 of Example 45 emits lighting light having the lighting color of a point (0.446, 0.388) (point p411 in FIG. 25) on the isotemperature line W402 at the boundary of a first region S401 and a second region S402.

### Example 46

The lighting device 200 of Example 46 emits lighting light having the lighting color of point B4 (0.419, 0.343) (point p412 in FIG. 25) at the boundary of the first region S401 and the second region S402.

### Example 47

The lighting device 200 of Example 47 emits lighting light having the lighting color of a point (0.433, 0.394) (point p413 in FIG. 25) on the isanomal V401 of the second region S402.

### Example 48

The lighting device 200 of Example 48 emits lighting light having the lighting color of a point (0.422, 0.373) (point p414 in FIG. 25) inside the second region S402.

### Example 49

The lighting device 200 of Example 49 emits lighting light having the lighting color of a point (0.406, 0.339) (point p415 in FIG. 25) on the isanomal V402 of the second region S402.

### Example 50

The lighting device 200 of Example 50 emits lighting light having the lighting color of point C4 (0.418, 0.390) (point p416 in FIG. 25) of the second region S402.

### Example 51

The lighting device 200 of Example 51 emits lighting light having the lighting color of point K4 (0.416, 0.377) (point p417 in FIG. 25) inside the second region S402.

### Example 52

The lighting device 200 of Example 52 emits lighting light having the lighting color of a point (0.397, 0.336) (point p418 in FIG. 25) on the isanomal V402 of the second region S402.

### Example 53

The lighting device 200 of Example 53 emits lighting light having the lighting color of point D4 (0.397, 0.370) (point p419 in FIG. 25) of the second region S402.

### Example 54

The lighting device 200 of Example 54 emits lighting light having the lighting color of point G4 (0.383, 0.329) (point p420 in FIG. 25) of the second region S402.

### Comparative Example 66

The lighting device 200 of Comparative Example 66 for comparison with Examples 35-54 emits lighting light having the lighting color of a point (0.586, 0.393) (point q401 in FIG. 25) closer to the blackbody locus V0 than the isanomal V401 and having a correlated color temperature lower than the isotemperature line W401.

### Comparative Example 67

The lighting device 200 of Comparative Example 67 emits lighting light having the lighting color of a point (0.579, 0.384) (point q402 in FIG. 25) on the isanomal V401 and having a correlated color temperature lower than the isotemperature line W401.

### Comparative Example 68

The lighting device 200 of Comparative Example 68 emits lighting light having the lighting color of a point (0.558, 0.364) (point q403 in FIG. 25) having a low correlated color temperature relative to the point of Example 28.

### Comparative Example 69

The lighting device 200 of Comparative Example 69 emits lighting light having the lighting color of a point (0.528, 0.332) (point q404 in FIG. 25) on the isanomal V402 and having a correlated color temperature lower than the isotemperature line W401.

### Comparative Example 70

The lighting device 200 of Comparative Example 70 emits lighting light having the lighting color of a point (0.516, 0.318) (point q405 in FIG. 25) farther from the blackbody locus V0 than the isanomal V402 and having a correlated color temperature lower than the isotemperature line W401.

### Comparative Example 71

The lighting device 200 of Comparative Example 71 emits lighting light having the lighting color of a point (0.563, 0.404) (point q406 in FIG. 25) on the isotemperature line W401 and closer to the blackbody locus V0 than the isanomal V401.

### Comparative Example 72

The lighting device 200 of Comparative Example 72 emits lighting light having the lighting color of a point (0.498, 0.326) (point q407 in FIG. 25) on the isotemperature line W401 and farther from the blackbody locus V0 than the isanomal V402.

### Comparative Example 73

The lighting device 200 of Comparative Example 73 emits lighting light having the lighting color of a point (0.552, 0.414) (point q408 in FIG. 25) closer to the blackbody locus V0 than the point of Example 30.

### Comparative Example 74

The lighting device 200 of Comparative Example 74 emits lighting light having the lighting color of a point (0.462, 0.331) (point q409 in FIG. 25) farther from the blackbody locus V0 than the point of Example 32.

### Comparative Example 75

The lighting device 200 of Comparative Example 75 emits lighting light having the lighting color of a point (0.477, 0.414) (point q410 in FIG. 25) closer to the blackbody locus V0 than the point of Example 33.

### Comparative Example 76

The lighting device 200 of Comparative Example 76 emits lighting light having the lighting color of a point (0.429, 0.336) (point q411 in FIG. 25) farther from the blackbody locus V0 than the point of Example 35.

### Comparative Example 77

The lighting device 200 of Comparative Example 77 emits lighting light having the lighting color of a point (0.457, 0.410) (point q412 in FIG. 25) on the isotemperature line W402 and closer to the blackbody locus V0 than the isanomal V401.

### Comparative Example 78

The lighting device 200 of Comparative Example 78 emits lighting light having the lighting color of a point (0.410, 0.328) (point q413 in FIG. 25) on the isotemperature line W402 and farther from the blackbody locus V0 than the isanomal V402.

### Comparative Example 79

The lighting device 200 of Comparative Example 79 emits lighting light having the lighting color of a point (0.437, 0.404) (point q414 in FIG. 25) closer to the blackbody locus V0 than the point of Example 39.

### Comparative Example 80

The lighting device 200 of Comparative Example 80 emits lighting light having the lighting color of a point (0.398, 0.324) (point q415 in FIG. 25) farther from the blackbody locus V0 than the point of Example 41.

### Comparative Example 81

The lighting device 200 of Comparative Example 81 emits lighting light having the lighting color of a point (0.420, 0.398) (point q416 in FIG. 25) closer to the blackbody locus V0 than the point C4.

### Comparative Example 82

The lighting device 200 of Comparative Example 82 emits lighting light having the lighting color of a point (0.392, 0.325) (point q417 in FIG. 25) farther from the blackbody locus V0 than the point of Example 44.

### Comparative Example 83

The lighting device 200 of Comparative Example 83 emits lighting light having the lighting color of a point (0.405, 0.391) (point q418 in FIG. 25) on the isotemperature line W403 and closer to the blackbody locus V0 than the isanomal V401.

### Comparative Example 84

The lighting device 200 of Comparative Example 84 emits lighting light having the lighting color of the intersection point (0.402, 0.383) (point q419 in FIG. 25) of the isanomal V401 and the isotemperature line W403.

### Comparative Example 85

The lighting device 200 of Comparative Example 85 emits lighting light having the lighting color of a point (0.379, 0.319) (point q420 in FIG. 25) on the isotemperature line W403 and farther from the blackbody locus V0 than the isanomal V402.

### Comparative Example 86

The lighting device 200 of Comparative Example 86 emits lighting light having the lighting color of a point (0.395, 0.385) (point q421 in FIG. 25) closer to the blackbody locus V0 than the isanomal V401 and having a correlated color temperature higher than the isotemperature line W403.

### Comparative Example 87

The lighting device 200 of Comparative Example 87 emits lighting light having the lighting color of a point (0.392, 0.378) (point q422 in FIG. 25) on the isanomal V401 and having a correlated color temperature higher than the isotemperature line W403.

### Comparative Example 88

The lighting device 200 of Comparative Example 88 emits lighting light having the lighting color of a point (0.389, 0.367) (point q423 in FIG. 25) having a correlated color temperature higher than the point D4.

### Comparative Example 89

The lighting device 200 of Comparative Example 89 emits lighting light having the lighting color of a point (0.375, 0.325) (point q424 in FIG. 25) on the isanomal V402 and having a correlated color temperature higher than the point G4.

### Comparative Example 90

The lighting device 200 of Comparative Example 90 emits lighting light having the lighting color of a point (0.372, 0.315) (point q425 in FIG. 25) farther from the blackbody locus V0 than the isanomal V402 and having a correlated color temperature higher than the isotemperature line W403.

The experiments described below were performed for Examples 35 through 54 and Comparative Examples 66 through 90 described above. In a ninth experiment, a total of 32 healthy individuals, sixteen male and sixteen female, from age 20 to age 65 were chosen as test subjects, and drowsiness, discomfort, and feeling of rest were evaluated. Specifically, the test subjects were divided into two groups, the lighting color was made variable in the same room, and evaluation was performed after the lighting light was irradiated to the test subjects. The results were compared with those of a case in which neutral white light was irradiated to the test subjects in the same manner. The correlated color temperature of the neutral white was approximately 5000 K, and the chromaticity coordinates thereof were (0.345, 0.342) (point q0 in FIG. 25).

The Visual Analogue Scale (VAS) for evaluating sensory/emotional intensity was used as the evaluation method. In this evaluation method, the test subject marks a point corresponding to a sensory/emotional strength relating to a question item at the time in question on a single straight line, one end of which represents the worst sensation and the other end represents the best sensation, and by measuring the length from the position of the mark to one end, a subjective sensation is quantified, and a score is evaluated.

In a tenth experiment, a total of 32 healthy individuals, sixteen male and sixteen female, from age 20 to age 65 were chosen as test subjects, and quality of sleep was evaluated. Specifically, a test subject for each room was caused to stand by, the environment state was made the same for all test subjects, and the sleep state was measured after lighting light of each lighting color was radiated at an illuminance equivalent to 35 W (approximately 45 lx) for a period one hour before retiring until bedtime. Comparison was made with the sleep state in a case in which neutral white light was radiated in the same manner at an illuminance equivalent to 35 W (approximately 85 lx).

A sleep measurement system “NEMURI SCAN (registered trademark)” manufactured by Paramount Bed Co., Ltd. was used to measure sleep state. The sleep measurement system was spread under a bed, the activity level of each test subject during retiring was measured, and the sleep onset latency, sleep efficiency, and total sleep time for each test subject were calculated from the activity level.

In an eleventh experiment, working capacity was evaluated in a total of 32 healthy individuals, sixteen male and sixteen female, from age 20 to age 65 as test subjects. Specifically, a test subject for each room was caused to stand by, the environment state was made the same for all test subjects, and subjective evaluation and working capacity evaluation were performed after lighting light of each lighting color was radiated for 30 minutes of work time. The experiment was performed at an illuminance equivalent to 85 W (approximately 500 lx) and an illuminance equivalent to 100 W (approximately 600 lx) for each lighting color. The results for each lighting color were compared with an evaluation in a case in which neutral white light was radiated at an illuminance equivalent to 85 W (approximately 650 lx).

The question item “motivation” was provided as a subjective evaluation relating to work, and subjective evaluation after 30 minutes of work was made using the aforementioned Visual Analogue Scale (VAS). The “Uchida-Kraepelin Test (registered trademark)” of Nisseiken, Inc. was used as a work load. The content of the test is a computational work load in which simple one-digit additions are performed for a total of 30 minutes while changing rows every minute. Working capacity was measured by totaling the number of calculations in the 30 minutes.

Tables 13 and 14 show the results of the ninth through eleventh experiments for Examples 35 through 54 and Comparative Examples 66 through 90. The results were evaluated by statistically analyzing results for all test subjects and testing for significance between each lighting color and neutral white. A t-test was used as the test method, and an evaluation of “improved” or “worsened” was made for a significance level of 5%. An evaluation of “improvement tendency” or “worsening tendency” was made in the case of differences for which the p-value was less than 10%.

TABLE 13

| | | | Chromaticity | | | | | Sleep |
|---|---|---|---|---|---|---|---|---|
| | | | coordinates | | | | Feeling of | onset |
| | Region | Point | x | y | Drowsiness | Discomfort | latency | latency |
| Example 35 | S401 | p401, A4 | 0.555 | 0.394 | Improved | Same | Improved | Improved |
| Example 36 | S401 | p402 | 0.537 | 0.373 | Improved | Same | Improved | Improved |
| Example 37 | S401 | p403, E4 | 0.510 | 0.340 | Improved | Same | Improved | Improved |
| Example 38 | S401 | p404 | 0.515 | 0.404 | Improved | Same | Improved | Improved |
| Example 39 | S401 | p405, J4 | 0.499 | 0.382 | Improved | Same | Improved | Improved |
| Example 40 | S401 | p406 | 0.473 | 0.347 | Improved | Same | Improved | Improved |
| Example 41 | S401 | p407 | 0.471 | 0.404 | | | | |
| Example 42 | S401 | p408 | 0.462 | 0.390 | | | | |
| Example 43 | S401 | p409 | 0.436 | 0.347 | | | | |
| Example 44 | S401, S402 | p410, F4 | 0.453 | 0.401 | Improved | Same | Improved | Improved |
| Example 45 | S401, S402 | p411 | 0.446 | 0.388 | Improved | Same | Improved | Improved |
| Example 46 | S401, S402 | p412, B4 | 0.419 | 0.343 | Improved | Same | Improved | Improved |
| Example 47 | S402 | p413 | 0.433 | 0.394 | Same | Same | Improvement | Same |
| | | | | | | | tendency | |
| Example 48 | S402 | p414 | 0.422 | 0.373 | Same | Same | Improvement | Same |
| | | | | | | | tendency | |
| Example 49 | S402 | p415 | 0.406 | 0.339 | Same | Same | Improvement | Same |
| | | | | | | | tendency | |
| Example 50 | S402 | p416, C4 | 0.418 | 0.390 | | | | |
| Example 51 | S402 | p417, K4 | 0.416 | 0.377 | | | | |
| Example 52 | S402 | p418 | 0.397 | 0.336 | | | | |
| Example 53 | S402 | p419, D4 | 0.397 | 0.370 | | | | |
| Example 54 | S402 | p420, G4 | 0.383 | 0.329 | | | | |

| | Sleep | | Motivation | | Working capacity | |
|---|---|---|---|---|---|---|
| | efficiency | Sleep time | 85 W | 100 W | 85 W | 100 W |
| Example 35 | Improvement | Improvement | | | | |
| | tendency | tendency | | | | |
| Example 36 | Improvement | Improvement | | | | |
| | tendency | tendency | | | | |
| Example 37 | Improvement | Improvement | | | | |
| | tendency | tendency | | | | |
| Example 38 | Improvement | Improvement | | | | |
| | tendency | tendency | | | | |
| Example 39 | Improved | Improved | | | | |
| Example 40 | Improvement | Improvement | | | | |
| | tendency | tendency | | | | |
| Example 41 | | | Same | Same | Same | Same |
| Example 42 | | | Same | Same | Same | Same |
| Example 43 | | | Same | Same | Same | Same |
| Example 44 | Improvement | Improvement | Same | Improved | Same | Improvement |
| | tendency | tendency | | | | tendency |
| Example 45 | Improvement | Improvement | Same | Improved | Same | Improvement |
| | tendency | tendency | | | | tendency |
| Example 46 | Improvement | Improvement | Same | Improved | Same | Improvement |
| | tendency | tendency | | | | tendency |
| Example 47 | Same | Same | | | | |
| Example 48 | Same | Same | | | | |
| Example 49 | Same | Same | | | | |
| Example 50 | | | Same | Improved | Same | Improvement |
| | | | | | | tendency |
| Example 51 | | | Same | Improved | Same | Improved |
| Example 52 | | | Same | Improved | Same | Improvement |
| | | | | | | tendency |
| Example 53 | | | Same | Improved | Same | Improvement |
| | | | | | | tendency |
| Example 54 | | | Same | Improved | Same | Improvement |
| | | | | | | tendency |

TABLE 14

| | | | Chromaticity | | | | | Sleep | | | | | Working | |
|---|---|---|---|---|---|---|---|---|---|---|---|---|---|---|
| | | | coordinates | | | | Feeling of | onset | Sleep | Sleep | Motivation | | capacity | |
| | Region | Point | x | y | Drowsiness | Discomfort | rest | latency | efficiency | time | 85 W | 100 W | 85 W | 100 W |
| Comparative | | q401 | 0.586 | 0.393 | Same | Same | Same | Same | Same | Same | | | | |
| Example 66 | | | | | | | | | | | | | | |
| Comparative | | q402 | 0.579 | 0.384 | Same | Same | Same | Same | Same | Same | | | | |
| Example 67 | | | | | | | | | | | | | | |
| Comparative | | q403 | 0.558 | 0.364 | Same | Same | Same | Same | Same | Same | | | | |
| Example 68 | | | | | | | | | | | | | | |
| Comparative | | q404 | 0.528 | 0.332 | Same | Same | Same | Same | Same | Same | | | | |
| Example 69 | | | | | | | | | | | | | | |
| Comparative | | q405 | 0.516 | 0.318 | Same | Worsening | Same | Same | Same | Same | | | | |
| Example 70 | | | | | | tendency | | | | | | | | |
| Comparative | | q406 | 0.563 | 0.404 | Same | Same | Improvement | Same | Same | Same | | | | |
| Example 71 | | | | | | | tendency | | | | | | | |
| Comparative | | q407 | 0.498 | 0.326 | Same | Worsening | Same | Same | Same | Same | | | | |
| Example 72 | | | | | | tendency | | | | | | | | |
| Comparative | | q408 | 0.522 | 0.414 | Same | Same | Improvement | Same | Same | Same | | | | |
| Example 73 | | | | | | | tendency | | | | | | | |
| Comparative | | q409 | 0.462 | 0.331 | Same | Worsening | Same | Same | Same | Same | | | | |
| Example 74 | | | | | | tendency | | | | | | | | |
| Comparative | | q410 | 0.477 | 0.414 | | | | | | | Same | Same | Same | Same |
| Example 75 | | | | | | | | | | | | | | |
| Comparative | | q411 | 0.429 | 0.336 | | | | | | | Same | Same | Same | Same |
| Example 76 | | | | | | | | | | | | | | |
| Comparative | | q412 | 0.457 | 0.410 | Same | Same | Improvement | Same | Same | Same | | | | |
| Example 77 | | | | | | | tendency | | | | | | | |
| Comparative | | q413 | 0.410 | 0.328 | Same | Worsening | Same | Same | Same | Same | | | | |
| Example 78 | | | | | | tendency | | | | | | | | |
| Comparative | | q414 | 0.437 | 0.404 | Same | Same | Improvement | Same | Same | Same | | | | |
| Example 79 | | | | | | | tendency | | | | | | | |
| Comparative | | q415 | 0.398 | 0.324 | Same | Worsening | Same | Same | Same | Same | | | | |
| Example 80 | | | | | | tendency | | | | | | | | |
| Comparative | | q416 | 0.420 | 0.398 | | | | | | | Same | Same | Same | Same |
| Example 81 | | | | | | | | | | | | | | |
| Comparative | | q417 | 0.392 | 0.325 | | | | | | | Same | Same | Same | Same |
| Example 82 | | | | | | | | | | | | | | |
| Comparative | | q418 | 0.405 | 0.391 | | | | | | | Same | Same | Same | Same |
| Example 83 | | | | | | | | | | | | | | |
| Comparative | | q419 | 0.402 | 0.383 | | | | | | | Same | Same | Same | Same |
| Example 84 | | | | | | | | | | | | | | |
| Comparative | | q420 | 0.379 | 0.319 | | | | | | | Same | Same | Same | Same |
| Example 85 | | | | | | | | | | | | | | |
| Comparative | | q421 | 0.395 | 0.385 | | | | | | | Same | Same | Same | Same |
| Example 86 | | | | | | | | | | | | | | |
| Comparative | | q422 | 0.392 | 0.378 | | | | | | | Same | Same | Same | Same |
| Example 87 | | | | | | | | | | | | | | |
| Comparative | | q423 | 0.389 | 0.367 | | | | | | | Same | Same | Same | Same |
| Example 88 | | | | | | | | | | | | | | |
| Comparative | | q424 | 0.375 | 0.325 | | | | | | | Same | Same | Same | Same |
| Example 89 | | | | | | | | | | | | | | |
| Comparative | | q425 | 0.372 | 0.315 | | | | | | | Same | Same | Same | Same |
| Example 90 | | | | | | | | | | | | | | |

According to the results of the ninth and tenth experiments, in the case of lighting colors in the first region S401, drowsiness or feeling of rest was improved and sleep onset latency was improved (shortened) relative to neutral white, and sleep efficiency and sleep time were improved or tended to be improved. In the case of lighting colors outside the range of the first region S401, drowsiness, sleep onset latency, sleep efficiency, and sleep time were the same relative to neutral white. When the deviation with respect to the blackbody locus V0 was large (Comparative Examples 70, 72, 74, 78, and 80), there was a worsening tendency for discomfort relative to neutral white. When the deviation with respect to the blackbody locus V0 was small (Comparative Examples 71, 73, 77, and 79), feeling of rest tended to be improved relative to neutral white, but drowsiness or sleep efficiency was the same.

Consequently, by providing lighting having a lighting color in the first region S401 before retiring, sleep onset latency at bedtime can be shortened, and improved sleep efficiency can be anticipated. Significant improvement in sleep onset latency, sleep efficiency, and sleep time was observed in Example 39 in particular, and markedly improved sleep efficiency can be anticipated. Discomfort can also be eliminated and restfulness brought about by providing lighting having a lighting color in the first region S401 during recesses or small social gatherings.

According to the results of the eleventh experiment, motivation or working capacity was the same as that of neutral white when the lighting color in the second region S402 was equivalent to 85 W, i.e., when the light energy outputs from the light source and for neutral white were the same. At an illuminance equivalent to 100 W for the lighting color in the second region S402, i.e., when the neutral white and the illuminance over the desk were the same, motivation or working capacity was improved or tended to be improved relative to neutral white.

When the lighting color was outside the range of the second region S402, motivation or working capacity was not improved relative to neutral white for illuminance equivalent to 85 W and 100 W. In general, the illuminance over the desk is considered more as a reference than the light energy output from the light source in setting the lighting conditions during work (see JIS-Z-8516, for example). Taking this into consideration, by providing lighting using the lighting color of the second region S402 during work, improved motivation for work and improved working capacity can be anticipated.

Since significant improvement in working capacity was observed in Example 51 in particular, marked improvement in working capacity can be anticipated. Regarding the subjective evaluation of motivation, it is generally known that motivation decreases as fatigue increases. Therefore, the improvement in motivation in the current experiment is considered to be due to suppression of arousal of the sympathetic nervous system by the work load, and reduction of tiredness during work.

Using the MacAdam color matching standard, the lighting color of the first region S401 may be assumed to belong to the isochromatic range S410 (see FIG. 10) represented by a 5-step MacAdam ellipse centered at the point J4 (0.499, 0.382) (point p405 in FIG. 25) in FIG. 10, the same as in the fourth embodiment. The lighting color of the first region S401 may also be assumed to belong to the isochromatic range represented by a 1-step MacAdam ellipse centered at the point J4.

The lighting color of the second region S402 may be assumed to belong to the isochromatic range S420 (see FIG. 10) represented by a 5-step MacAdam ellipse centered at the point K4 (0.416, 0.377) (point p417 in FIG. 25) in FIG. 10. The lighting color of the second region S402 may also be assumed to belong to the isochromatic range represented by a 1-step MacAdam ellipse centered at the point K4.

Embodiments of the present invention are described above, but the scope of the present invention is not limited by these embodiments, and various modifications may be made to the implementation of the present invention within a range that does not depart from the intent of the invention.

### INDUSTRIAL APPLICABILITY

The present invention can be used in a lighting fixture, light bulb, or other lighting device for lighting the inside of a living room.

### LIST OF REFERENCE SIGNS

1 body
2 light source substrate
3 reflecting plate
4 frame
5 lighting control unit
6 LED elements
6a white LED elements
6b incandescent-bulb-color LED elements
6c red LED elements
10 power source circuit
11 CPU
12 memory
13 PWM control circuit
14 control power source supply circuit
32 base
33 support member
34 control substrate
35 heat sink
35a mounting surface
35c heat-radiating sheet
37 LED module
38 module fixing part
39 transmitting cover
50 remote controller
51 display unit
52 operating unit
53 light-on key
54 light-off key
55 cross key
56 first lighting mode key
57 second lighting mode key
58 variable key
100, 200 lighting device

1. A lighting device for lighting by emitting lighting light by light emission of an LED element, wherein said lighting device is characterized in that: the area of a spectrum of the lighting light having a wavelength of 600 nm to 700 nm is 30% to 70%, and the area having a wavelength of 400 nm to 500 nm is 20% or less with respect to the area having a wavelength of 400 nm to 800 nm;
the spectrum of the lighting light has a maximum value between 600 nm and 700 nm; and
the value of the spectrum at 550 nm is 50% or less of the maximum value.

2. A lighting device for lighting by emitting lighting light by light emission of an LED element, wherein said lighting device is characterized in that: the area of a spectrum of the lighting light having a wavelength of 600 nm to 700 nm is 30% to 70%, and the area having a wavelength of 400 nm to 500 nm is 20% or less with respect to the area having a wavelength of 400 nm to 800 nm;
the spectrum of the lighting light has a maximum value between 600 nm and 700 nm; and
the maximum value of the spectrum from 500 nm to 600 nm is 70% or less of the maximum value.

3. The lighting device according to claim 1, characterized in that the area of the spectrum of the lighting light from 500 nm to 600 nm is 15% to 45% of the area of the spectrum of the lighting light from 400 nm to 800 nm.

4. The lighting device according to claim 1, characterized in that a plurality of lighting lights having different spectra can be selected and emitted.

5. The lighting device according to claim 1, characterized in having a plurality of said LED element, each said LED element emitting a different color of light.

6. The lighting device according to claim 5, characterized in comprising said LED element for emitting light having an incandescent-bulb color, said LED element for emitting red light, and said LED element for emitting white light.

7. The lighting device according to claim 1, characterized in comprising a phosphor for converting emitted light of said LED elements to a different wavelength.

8. The lighting device according to claim 7, characterized in comprising said LED element for emitting blue light, said phosphor for converting blue light to incandescent-bulb-color light, said phosphor for converting blue light to red light, and said phosphor for converting blue light to yellow light.

9-20. (canceled)
